(19) United States
(12) Patent Application Publication
(10) Pub. No.: US 2007/0102362 A1
(43) Pub. Date: May 10, 2007

(54) Chip

(76) Inventors: Kazuhiro Iida, TOKYO (JP); Hisao Kawaura, Tokyo (JP); Toru Sano, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/569,835

(22) PCT Filed: Sep. 1, 2004
(86) PCT No.: PCT/JP04/12661

§ 371 Date: Feb. 28, 2006

(30) Foreign Application Priority Data
Sep. 1, 2003 (JP) 2003-309422

(51) Int. Cl. B01D 15/08

(52) U.S. Cl. 210/656

(57) ABSTRACT

In a chip (215), an inlet (217), a main channel (221), a separation region (218), and dispensing channels (222) are formed on a substrate (216). It is structured such that a plurality of the dispensing channels (222) are communicated with the main channel (221), and detection reservoirs (223) are communicated with the respective dispensing channels (222).

### TECHNICAL FIELD

The present invention relates to a chip on which separation and analysis of a sample are possible.

### BACKGROUND ART

In recent years, micro chemical analysis (p-TAS) in which chemical operations such as pretreatment/reaction/separation/detection, or the like of a sample are carried out on a microchip has been rapidly developed. In accordance with micro chemical analysis, a sample to be used is sufficient in a minute quantity thereof, and the environmental burden is little, which enables a high-sensitive analysis. A microchip used for such an analysis has been conventionally a single device that one function of separation, analysis, and the like is provided on one chip (for example, in Patent Document 1).

However, on a chip having only the single function, after predetermined processings are carried out on the chip, it is necessary to extract a sample to be provided to another device in order to carry out the following processings. For example, when a separation of a sample is carried out by using a chip having only a separation function, the separated sample is extracted, and an analysis and the like are carried out by using a large-scale external device or the like. Therefore, the operations are complicated. Further, in a case of a minute quantity of sample, in some cases, a loss at the time of moving the sample has been caused, or it has been difficult to detect the sample with sufficient sensitivity.

Therefore, the development of a complex chip having multifunction has been required. However, conventionally, it has been difficult to provide a plurality of functions on one chip, and to continuously process a sample.

[Patent Document] Japanese Laid-open patent publication NO. 2000-262871

### DISCLOSURE OF THE INVENTION

The present invention has been achieved in consideration of the above-described circumstances, and an object of the present invention is to provide a technology of realizing separations and analyses, which have been conventionally carried out by using a plurality of devices, on one chip. Further, another object of the present invention is to provide a technology that a minute quantity of sample is separated by a simple operation, and those are analyzed with a high accuracy or high sensitivity.

According to the present invention, there is provided a chip including:

a substrate;

a sample introduction unit provided on the substrate;

a channel communicated with the sample introduction unit;

a separation unit which includes a part of the channel, and separates components in a liquid sample introduced in the sample introduction unit;

a pretreatment unit which is provided at upstream of the separation unit, and which applies predetermined pretreatment to the liquid sample introduced in the sample introduction unit; and

an analysis unit which analyzes the components separated at the separation unit.

In the specification, “chip” means a substrate to which a function of carrying out predetermined operations with respect to an introduced sample is provided. A chip in the present invention may be structured, for example, such that a channel groove is provided on the surface of a substrate, and a liquid sample is made to flow in the channel groove. The liquid sample may be made to move in the channel groove by utilizing a capillary phenomenon or the like, or may be made to move by applying an external force such as an electric field, a pressure, or the like. The liquid sample introduced from the sample introduction unit sequentially moves in the pretreatment unit, the separation unit, and the analysis unit.

In the chip in the present invention, the sample introduction unit, the separation unit, and the analysis unit are provided as indispensable members on the substrate. In the separation unit, separation of contents in a liquid sample is carried out. Further, in the analysis unit, analysis of the components separated at the separation unit is carried out. Therefore, respective operations of the separation and analysis of the sample can be continuously carried out on the one chip. Existing chips are structured per unit operation, and it is necessary to move separated samples to analytical instruments. However, in accordance with the structure of the present invention, there is no need to move samples, which is simple. Further, because loss of samples by movement is not caused, even if the sample is in a minute quantity, the sample may be certainly separated, and may be analyzed with high sensitivity.

In the chip relating to the present invention, the separation unit and the analysis unit may be made to be in a mode in which the functions thereof are carried out due to external forces being applied. However, the separation unit and the analysis unit are preferably structured such that separation of predetermined components and analysis of separated components are sequentially executed automatically in accordance with a flow of a liquid sample. Such a structure may be realized by utilizing a capillary phenomenon or the like as a driving force for moving a liquid sample.

Further, in the chip of the present invention, a pretreatment unit which applies predetermined pretreatment to the liquid sample introduced into the sample introduction unit is further provided at upstream of the separation unit. In accordance therewith, it is possible to apply predetermined pretreatment to a sample in advance of separation. Therefore, in the structure in which the separation unit and the analysis unit are merely connected to one another, even with respect to a sample whose separation efficiency and analytical sensitivity are low, the sample may be certainly separated in the separation unit, and predetermined analysis on the separated components may be carried out.

In the chip of the present invention, the pretreatment unit includes a pretreatment reservoir, and a switch which is provided at downstream of the pretreatment reservoir, and which controls to supply the liquid sample from the pretreatment unit to the separation unit, and the switch may have a damming portion which dams up liquid in the pretreatment reservoir, and a trigger channel which is communicated with the channel at the damming portion or downstream side thereof, and which introduces the liquid to the damming portion. In accordance with this structure, because the switch is provided at downstream of a reservoir, the switch is closed up to a predetermined timing. During the closure of the switch, the sample can be held in the reservoir, which may prevent the liquid in the reservoir from moving to the separation unit. Accordingly, pretreatment may be certainly carried out during a desired period. Further, due to the switch being opened in a predetermined timing after pretreatment, the liquid in the reservoir may be rapidly moved to the separation unit.

In the above-described structure, the switch has the trigger channel communicated with the damming portion. Therefore, provided that a length and a cross-sectional shape of the trigger channel are adjusted, a timing in which a liquid flowing in the trigger channel reaches the damming portion may be adjusted. Therefore, without providing an external control device, it is possible to execute opening of the channel with high controllability in a desired timing by introducing the liquid from the trigger channel. Therefore, the liquid sample may be introduced to the separation unit in a predetermined timing. Note that the liquid flowing in the trigger channel may be some of the liquid sample, or may be another liquid.

In the chip of the present invention, the liquid sample may include insoluble components, and the pretreatment reservoir may have solubilizing substance solubilizing the insoluble components. Provided that such a structure is used, when a liquid sample moves to the pretreatment unit, the liquid sample and the solubilizing substance are mixed together due to the solubilizing substance contacting the liquid sample, and the insoluble components may be certainly solubilized.

In the chip of the present invention, a mixing unit which is communicated with the separation unit and the analysis unit, and which homogenizes a concentration of the components in the liquid including the components separated in the separation unit may be provided.

Further, according to the present invention, there is provided a chip including:

a substrate;

a sample introduction unit which is provided on the substrate;

a channel which is communicated with the sample introduction unit;

a separation unit which includes a part of the channel, and which separates components in a liquid sample introduced in the sample introduction unit;

a mixing unit which is communicated with the separation unit and an analysis unit, and which homogenizes a concentration of the components in the liquid including the components separated at the separation unit; and

the analysis unit which analyzes the components in the liquid including the components homogenized in the mixing unit.

In this structure, the liquid sample introduced from the sample introduction unit sequentially moves in the analysis unit, the mixing unit, and the analysis unit. In the structure in which a plurality of functions of separation and analysis are realized on one chip, and a liquid sample separated in the separation unit is automatically introduced into the analysis unit, it is an important technical problem that a sample to be separated is introduced into the analysis unit in the form of being suitable for analysis. The above-described structure having the mixing unit is to solve such a problem, and the concentration of components serving as objects to be analyzed in separated samples is homogenized, and a stable result of analysis can be obtained.

Such a mixing unit is preferably structured so as to automatically execute a mixing operation, without an external force being applied, in accordance with a flow of a liquid sample. Such a structure can be realized by utilizing a capillary phenomenon or countercurrent of the liquid sample in the channel.

In the chip of the present invention, the mixing unit may have a structure in which one region of the channel and other regions are communicated with one another via micro channels. In accordance therewith, a variation in the component concentration in a liquid sample in the channel can be effectively reduced with a simple structure.

In the chip of the present invention, the mixing unit may include a switch which is provided at the channel, and which controls to supply the liquid sample from the mixing unit to the analysis unit, and the switch may have a damming portion which dams up liquid in the channel, and a trigger channel which is communicated with the channel at the damming portion or an area downstream thereof, and which introduces the liquid to the damming portion. In accordance therewith, the trigger channel can be designed so as to retain the liquid sample in upstream of the damming portion until the component concentration of the liquid sample is made constant. Therefore, the component concentration of the liquid sample can be certainly homogenized. Further, because the damming portion can be opened in a predetermined timing, homogenization of the component concentration can be carried out in the chip without providing an external control device.

In the chip of the present invention, the mixing unit has a movement control unit which controls a timing in which the liquid sample moves to the analysis unit, and the movement control unit may be structured so as to introduce the liquid sample to the analysis unit after retaining the liquid sample for a predetermined time. By providing the movement control unit, the liquid sample can be retained for a predetermined time at the side of upstream of the analysis unit. Therefore, homogenization of the component concentration can be more certainly carried out. Further, the liquid sample in which the component concentration has been homogenized can be moved to the analysis unit in a predetermined timing.

In the chip of the present invention, the movement control unit may include a switch which controls to supply the liquid sample from the mixing unit to the analysis unit, and the switch may have a damming portion which dams up liquid in the channel, and a trigger channel which is communicated with the channel at the damming portion or an area downstream thereof, and which introduces the liquid to the damming portion. In accordance therewith, the liquid sample can be retained for a predetermined time at the upstream side of the analysis unit. Therefore, the movement of the liquid sample from the mixing unit to the analysis unit can be more certainly controlled.

In the chip of the present invention, the trigger channel may include a time-lag channel which delays a timing in which the liquid sample moves to the analysis unit by retaining the liquid sample. In accordance therewith, the liquid sample can be retained at the upstream side of the analysis unit while making the liquid sample detour to the inside of the time-lag channel so as to move in the channel. A timing in which the liquid sample is made to move to the analysis unit can be adjusted by adjusting a length or a thickness of the time-lag channel.

In the chip of the present invention, a time-lag reservoir which delays a timing in which the liquid sample moves to the analysis unit by retaining the liquid sample may be provided at the trigger channel. In accordance therewith, the liquid sample can be retained in the time-lag reservoir. Therefore, the liquid sample can be retained at the upstream side of the analysis unit.

In the chip of the present invention, a reaction unit which makes the components separated at the separation unit cause a predetermined reaction.

Further, according to the present invention, there is provided a chip including:

a substrate;

a sample introduction unit provided on the substrate;

a channel communicated with the sample introduction unit;

a separation unit which includes a part of the channel, and which separates components in a liquid sample introduced in the sample introduction unit;

a reaction unit which makes the components separated at the separation unit cause a predetermined reaction; and

an analysis unit which analyzes the components separated at the separation unit.

In this structure, the liquid sample introduced from the sample introduction unit sequentially moves in the separation unit, the reaction unit, and the analysis unit. In the structure in which a plurality of functions of separation and analysis are realized on one chip, and a liquid sample separated at the separation unit is automatically introduced into the analysis unit, further, it is an important technical problem that detection sensitivity of the components is improved by utilizing a reaction specific to the components of the separated sample. The above-described structure having the reaction unit is to solve such a problem, and even when it is difficult to directly analyze a separated sample by analyzing after components separated at the separation unit are provided for a predetermined reaction, a sample suitable for analysis at the analysis unit can be prepared so as to be associated with a predetermined reaction at the reaction unit. Further, types of analyses which may be realized on the chip can be increased.

In the chip of the present invention, the reaction unit may include a reaction reservoir and a switch which is provided at the downstream of the reaction reservoir, and the switch may have a damming portion which dams up liquid in the reaction reservoir, and a trigger channel which is communicated with the channel at the damming portion or an area downstream thereof, and which introduces the liquid to the damming portion. In accordance therewith, the liquid sample can be controlled not to move to the analysis unit while carrying out a reaction in the reaction unit. Further, because the liquid in the trigger channel reaches the damming portion after a predetermine time passes, and the liquid switch is opened, without providing an external device relating to the control of a reaction time and the control of a movement of the sample to the analysis unit after the reaction, it is possible to control those by the functions of the chip itself.

In the chip of the present invention, a reacting substance affecting the components in the liquid sample may be provided in the reaction reservoir. Provided that such a structure is used, because the reacting substance is mixed with the liquid sample which has reached the inside of the reservoir, the liquid sample may be certainly associated with the reaction. Further, in the chip of the present invention, a reacting substance affecting predetermined components in the liquid sample may be provided in the reaction reservoir. In accordance therewith, a state more suitable for analysis can be obtained by making the predetermined components be associated with a reaction before an analysis of the components in the liquid sample.

In the chip of the present invention, a seal covering the surface of the substrate may be provided. In accordance therewith, an unused chip may be prevented from being polluted. In this structure, the seal may cover the entire surface of the substrate. This may more certainly prevent an unused chip from being polluted.

In the chip of the present invention, an inert gas may be filled in a space formed by the substrate and the seal. Further, in the chip of the present invention, a pressure in the space formed by the substrate and the seal may be reduced. In accordance therewith, deterioration in hydrophilic property on the surface of the substrate, which is associated with preservation, may be favorably suppressed. Therefore, the liquid sample can be certainly made to move in the channel by a capillary phenomenon.

In the chip of the present invention, the surface of the substrate may be made of a hydrophilic resin. In accordance therewith, the sample introduced in the sample introduction unit can be certainly introduced in the channel by a capillary phenomenon, which can make the sample move in the channel. Further, the components in the liquid sample can be restrained from being nonspecifically adsorbed to the surface of the substrate. Therefore, separation and analysis of the liquid sample can be more certainly carried out.

In the chip of the present invention, the separation unit may include a switch which moves the liquid sample introduced in the sample introduction unit to the channel in a predetermined timing. In accordance therewith, a timing in which separation of the sample is started may be controlled by the structure of the chip itself.

In the chip of the present invention, the separation unit may have a plurality of columnar bodies provided in the channel. In accordance therewith, components in the liquid sample may be certainly separated based on the shapes and the sizes thereof.

In the chip of the present invention, the separation unit may have a plurality of concave portions provided in the channel. In accordance therewith, separation of the components in the liquid sample can be favorably carried out.

In the chip of the present invention, the surface of the channel structuring the separation unit has a plurality of first regions disposed so as to be spaced, and a second region occupying the surface of the separation unit other than the first regions, one of the first regions and the second region may be a hydrophobic region, and the other one may be a hydrophilic region.

As such a structure, concretely, one of

(i) a structure in which the first regions are hydrophobic regions and the second region is a hydrophilic region, and

(ii) a structure in which the first regions are hydrophilic regions and the second region is a hydrophobic region may be adopted. Note that a hydrophilic region in the present invention means a region whose hydrophilic property is higher than that of a hydrophobic region. An extent of hydrophilic property can be grasped by, for example, measuring water contact angle.

Hereinafter, the principle of separation of a sample in the present invention will be described by using a case of the above-described (i) as an example. In this case, a sample serving as an object to be separated is introduced so as to be dissolved or dispersed in a relatively high hydrophilic solvent. Such a solvent is distributed to only the hydrophilic region (the second region) so as to avoid the surface of the hydrophobic regions (the first regions) in the separation unit. Accordingly, gap portions among the hydrophobic regions are made to be routes through which the sample serving as an object to be separated passes, and as a result, a time required for passing in the separation unit is determined based on a relationship between an interval among the hydrophobic regions and a size of the sample. Therefore, separation of the sample is carried out in accordance with a size thereof.

Further, in the present invention, not only separation according to a size, but also separation according to a polar character of the sample is carried out. Namely, a plurality of types of samples having different extents of hydrophilic property/hydrophobic property can be separated. In the example of the above-described (i), a sample with a high hydrophobic property is easily trapped in a hydrophobic region, which makes a flowing-out time relatively longer, and a sample with a high hydrophilic property is hard to be trapped, which makes a flowing-out time relatively shorter. In this way, in the present invention, separation including not only a size of a sample, but also a polar character is carried out, separation of multicomponent which is difficult to be separated conventionally can be realized.

In the case of the present invention, differently from a system in which separation is carried out by structures serving as obstacles, the separation unit provided on the surface of the channel serves as separation means. For example, it is necessary to high-precisely control the sizes of fine pore in a case of film separation which is conventionally used. However, it is not necessarily easy to stably manufacture a film having fine pores of a desired size and shape. In contrast thereto, in the present invention, the separation unit can be formed by surface processing of the channel, and because a desired separation performance can be obtained by controlling the intervals among the first regions, an appropriate structure for a separation purpose can be realized with relative ease.

In the chip of the present invention, the separation unit may have sample adsorbing particles which develop the liquid sample in accordance with a specific property. Development means that a sample is distributed to sample separation regions in accordance with a property of the sample. The separation unit in which sample adsorbing particles are adhered to the substrate can be easily formed by a method which is simpler than that in the case of applying microfabrication into the channel. Further, for example, the sample can be developed in accordance with an affinity between a developing solution for developing the sample and the sample. Further, it is possible to develop the sample in accordance with a polar character. Therefore, the sample can be certainly separated. Further, according to the present invention, separation may be started in a state in which the sample is dried to some extent. Therefore, it is possible to make a bandwidth of the sample thinner.

In the chip of the present invention, it may be structured such that a bank unit is provided along a traveling direction of the channel so as to divide the channel on the bottom face of the channel structuring the separation unit, and a height of the bank unit is lower than a depth of the channel. In accordance therewith, it may be structured such that two channels are communicated with one another via an gap formed between the bank unit and the bottom face of the channel. Therefore, only components which may pass through the gap can be certainly separated to be provided for analysis.

In the chip of the present invention, it may be structured such that a cover for covering the separation unit is provided, and on a plane at the substrate side among the planes of the cover, a bank unit is provided so as to divide the channel along the traveling direction of the channel, and a height of the bank unit is lower than a depth of the channel. Such a structure may be easily prepared as compared with a structure in which columnar bodies are provided in the channel. Therefore, a chip with excellent analytical sensitivity can be stably manufactured by a simple method.

In the chip of the present invention, the bank unit may be a resin film formed on the plane at the substrate side of the cover. In accordance therewith, the separation unit may be more easily prepared. Further, separation of the components in the sample can be certainly carried out.

In the chip of the present invention, the separation unit may include a first channel forming a part of the channel, a second channel through which a liquid including specific components separated from the liquid sample passing through the channel passes, and a separation channel which makes the first channel and the second channel be communicated with one another, and through which only specific components are made to pass. In this manner, predetermined components in the liquid sample flowing in the first channel can be selectively moved to the second channel. Therefore, separation of components in the sample can be certainly carried out.

For example, it may be structured such that, along the traveling direction of the first channel and the second channel, a bank unit for dividing those is provided, and a height of the bank unit is lower than depths of the first channel and the second channel. In accordance therewith, it may be structured such that the first channel and the second channel are separated by the bank unit, and are communicated with one another via a gap at which the bank unit is not formed. Therefore, only components which can pass through the gap can be selectively moved from the first channel to the second channel.

In the chip of the present invention, the separation unit may include a first channel forming a part of the channel, a second channel through which a liquid including specific components separated from the fluid passing through the channel passes, and a plurality of separation channels which make the first channel and the second channel be communicated with one another, and through which only the specific components are made to pass. Due to the plurality of separation channels being provided, only predetermined components in the liquid sample flowing in the first channel can be more certainly moved to the second channel. Therefore, separation of components in the sample can be more certainly carried out.

In the chip of the present invention, the analysis unit may have a plurality of reservoirs into which the components are sorted. In accordance therewith, the separated liquid samples can be dispensed into the plurality of reservoirs, and a plurality of components included in a same sample can be analyzed by measuring the light transmittances of these reservoirs, or the like.

In the chip of the present invention, air holes may be provided at the reservoirs or in the vicinity of the reservoirs of the channel communicated with the reservoirs. In accordance therewith, the separated liquid sample can be certainly introduced to the reservoirs.

In the chip of the present invention, the surface at the periphery of the air holes may be made hydrophobic. In accordance therewith, leakage of the liquid sample from the air holes may be further suppressed. Therefore, a given quantity of liquid sample can be certainly dispensed to the reservoirs.

In the chip of the present invention, the analysis unit may have a detection unit which detects the components. Provided that such a structure is used, it is possible to carry out analysis of separated samples by using the structure of the chip itself without using an external detection device.

In the chip of the present invention, a covering member which covers the detection unit may be further provided, and the covering member and a micro lens may be integrally formed. In accordance therewith, a result of detection reaction in the detection unit can be easily recognized visually with eyes.

In the chip of the present invention, it may be structure such that a waste reservoir communicated with the channel at downstream side of the analysis unit is provided, and the liquid in the channel moves toward a downstream of the channel accompanying a movement of the liquid to the waste reservoir. In accordance therewith, even after some of the liquid reaches the waste reservoir, the liquid in the channel can be certainly moved toward downstream. Therefore, separation and analysis of the sample can be more certainly carried out by utilizing a capillary phenomenon without using an external device.

In the chip of the present invention, a liquid retaining portion may be provided at the waste reservoir. In accordance therewith, the liquid in the channel can be more certainly moved to the waste reservoir.

In the chip of the present invention, air holes may be provided at the waste reservoir or in the vicinity of the waste reservoir of the channel communicated with the waste reservoir. In accordance therewith, the separated liquid samples can be certainly introduced to the reservoirs.

In the chip of the present invention, the surface at the periphery of the air holes may be made hydrophobic. In accordance therewith, the liquid sample discharged to the waste reservoirs may not leak out of the air holes.

In the chip of the present invention, the channel has a branched portion, and the branched portion may be communicated with a plurality of the reservoirs. In accordance therewith, the component concentration in the liquid dispensed to the respective analysis units can be homogenized.

In the chip of the present invention, it may be structured such that the liquid sample moves in the channel by a capillary phenomenon. In accordance therewith, after the sample is introduced to the sample introduction unit, it is possible to separate and analyze the sample by the structure of the chip itself without using an external driving device.

In the chip of the present invention, it may be structured such that the separation unit has particles condensating by being specifically adsorbed to predetermined components in the liquid sample. In accordance therewith, predetermined components in the liquid sample can be more certainly separated.

In the chip of the present invention, it may be structured such that the separation unit includes a particle retaining reservoir retaining the particles, and a switch which controls movement of the particles from the particle retaining reservoir to the channel, and the switch has a damming portion which dams up the particles in the particle retaining reservoir, and a trigger channel which is communicated with the channel at the damming portion or downstream side thereof, and which introduces the particles to the damming portion. In accordance therewith, predetermined components in the liquid sample can be more certainly separated.

In the chip of the present invention, the analysis unit may be structured so as to have a channel for analysis communicated with the separation unit, and a window unit which is provided above the channel for analysis of the substrate, and through which a condensated state of the particles is detected. In accordance therewith, predetermined components separated at the separation unit may be more certainly analyzed with a simple structure.

As described above, in accordance with the present invention, separation and analysis which have been carried out conventionally by using a plurality of devices may be realized on one chip. Further, in accordance with the present invention, a minute quantity of sample may be separated by simple operations, and may be analyzed with a high accuracy or with high sensitivity.

### BRIEF DESCRIPTION OF THE DRAWINGS

The object described above, and the other objects, features, and advantages will become further apparent from the preferred embodiments which will be described hereinafter, and the accompanying following drawings.

FIG. 1 is a diagram showing basic functional blocks of a chip relating to an embodiment.

FIG. 2 is a diagram showing a structure of the chip having the functions of FIG. 1.

FIG. 3 is a cross-sectional view taken along A-A′ of FIG. 2.

FIG. 4 is a cross-sectional view taken along B-B′ of FIG. 2.

FIG. 5 is a diagram showing a structure of a detection unit of the chip relating to an embodiment.

FIG. 6 is a diagram showing a structure of a detection unit of the chip relating to an embodiment.

FIG. 7 is a diagram showing basic functional blocks of a chip relating to an embodiment.

FIG. 8 is a diagram showing a structure of the chip having the functions of FIG. 7.

FIG. 9 is a diagram showing a structure of a measurement unit of the chip relating to an embodiment.

FIG. 10 is a diagram showing a structure of the measurement unit of the chip relating to an embodiment.

FIG. 11 is a diagram showing a structure of a measuring device relating to an embodiment.

FIG. 12 is a diagram showing a state in which the chip relating to the embodiment is inserted into the measuring device according to FIG. 11.

FIG. 13 is a diagram showing a structure of the measuring device relating to an embodiment.

FIG. 14 is a diagram showing a structure of the chip relating to an embodiment.

FIG. 15 is a cross-sectional view taken along D-D′ of FIG. 14.

FIG. 16 is a diagram showing functional blocks of a chip relating to an embodiment.

FIG. 17 is a diagram showing functional blocks of a chip relating to an embodiment.

FIG. 18 is a diagram showing a structure of the chip relating to an embodiment.

FIG. 19 is a diagram showing a structure of a mixing unit of the chip relating to an embodiment.

FIG. 20 is a diagram showing a structure of a mixing unit of the chip relating to an embodiment.

FIG. 21 is a top view in which a liquid switch portion of FIG. 19 is enlarged.

FIG. 22 is a top view of a damming portion in the liquid switch of FIG. 19.

FIG. 23 is a diagram showing a structure of a trigger channel relating to an embodiment.

FIG. 24 is a diagram showing functional blocks of a chip relating to an embodiment.

FIG. 25 is a diagram showing functional blocks of a chip relating to an embodiment.

FIG. 26 is a diagram showing a structure of the chip relating to an embodiment.

FIG. 27 is a diagram showing functional blocks of a chip relating to an embodiment.

FIG. 28 is a diagram showing functional blocks of a chip relating to an embodiment.

FIG. 29 is a diagram showing a structure of the chip relating to an embodiment.

FIG. 30 is a diagram showing functional blocks of a chip relating to an embodiment.

FIG. 31 is a diagram showing functional blocks of a chip relating to an embodiment.

FIG. 32 is a diagram showing a structure of the chip relating to an embodiment.

FIG. 33 is a diagram showing functional blocks of a chip relating to an embodiment.

FIG. 34 is a diagram showing functional blocks of a chip relating to an embodiment.

FIG. 35 is a diagram showing structures of separation units of the chips relating to an embodiment.

FIG. 36 is a diagram showing a structure of the chip relating to an embodiment.

FIG. 37 is an enlarged view of a liquid switch for forming band of FIG. 36.

FIG. 38 shows a structure in detail of a separation region in FIG. 36.

FIG. 39 is a cross-sectional view of the separation region in FIG. 36.

FIG. 40 is a diagram for explanation of a separation system of the separation unit of the chip relating to an embodiment.

FIG. 41 is a diagram showing a structure of a nano-structure provided at the separation unit of the chip relating to an embodiment.

FIG. 42 is a diagram for explanation of a method of forming the nano-structure shown in FIG. 41.

FIG. 43 is a diagram for explanation of the method of forming the nano-structure shown in FIG. 41.

FIG. 44 is a diagram for explanation of the method of forming the nano-structure shown in FIG. 41.

FIG. 45 is a diagram showing a method of forming a separation region of the chip relating to an embodiment.

FIG. 46 is a diagram showing the method of forming the separation region of the chip relating to an embodiment.

FIG. 47 is a diagram showing the method of forming the separation region of the chip relating to an embodiment.

FIG. 48 is a diagram showing the method of forming the separation region of the chip relating to an embodiment.

FIG. 49 is a diagram showing the method of forming the separation region of the chip relating to an embodiment.

FIG. 50 is a diagram showing the method of forming the separation region of the chip relating to an embodiment.

FIG. 51 is a diagram for explanation the structure of the separation region of the chip relating to an embodiment.

FIG. 52 is a diagram showing the method of forming the separation region of the chip relating to an embodiment.

FIG. 53 is a diagram showing the method of forming the separation region of the chip relating to an embodiment.

FIG. 54 is a diagram for explanation of the structure of the separation region of the chip relating to an embodiment.

FIG. 55 is a diagram for explanation of the structure of the separation region of the chip relating to an embodiment.

FIG. 56 is a diagram for explanation of the structure of the separation region of the chip relating to an embodiment.

FIG. 57 is a diagram for explanation of the structure of the separation region of the chip relating to an embodiment.

FIG. 58 is a diagram for explanation of the structure of the separation region of the chip relating to an embodiment.

FIG. 59 is a diagram for explanation of the structure of the separation region of the chip relating to the embodiment.

FIG. 60 is a diagram for explanation of the structure of the separation region of the chip relating to an embodiment.

FIG. 61 is a diagram for explanation of the structure of the separation region of the chip relating to an embodiment.

FIG. 62 is a diagram for explanation of the structure of the separation region of the chip relating to an embodiment.

FIG. 63 is a diagram for explanation of the structure of the separation region of the chip relating to an embodiment.

FIG. 64 is a diagram for explanation of the structure of the separation region of the chip relating to an embodiment.

FIG. 65 is a diagram for explanation of the structure of the separation region of the chip relating to an embodiment.

FIG. 66 is a diagram for explanation of the structure of the separation region of the chip relating to an embodiment.

FIG. 67 is a diagram for explanation of the structure of the separation region of the chip relating to an embodiment.

FIG. 68 is a diagram for explanation of the structure of the separation region of the chip relating to an embodiment.

FIG. 69 is a diagram for explanation of the structure of the separation region of the chip relating to an embodiment.

FIG. 70 is a diagram for explanation of the structure of the separation region of the chip relating to an embodiment.

FIG. 71 is a diagram for explanation of the structure of the separation region of the chip relating to an embodiment.

FIG. 72 is a diagram for explanation of a method of forming the separation region of the chip relating to an embodiment.

FIG. 73 is a diagram for explanation of the structure of the separation region of the chip relating to an embodiment.

FIG. 74 is a diagram for explanation of the method of forming the separation region of the chip relating to an embodiment.

FIG. 75 is a diagram for explanation of the method of forming the separation region of the chip relating to an embodiment.

FIG. 76 is a diagram for explanation of the structure of the separation region of the chip relating to an embodiment.

FIG. 77 is a diagram for explanation of the structure of the separation region of the chip relating to an embodiment.

FIG. 78 is a diagram for explanation of a separation system of the chip relating to an embodiment.

FIG. 79 is a diagram for explanation of a separation system of the chip relating to an embodiment.

FIG. 80 is a diagram showing a method of forming the separation region of the chip relating to an embodiment.

FIG. 81 is a diagram showing a method of forming the separation region of the chip relating to an embodiment.

FIG. 82 is a diagram showing a method of forming the separation region of the chip relating to an embodiment.

FIG. 83 is a diagram showing a structure of the separation region of the chip relating to an embodiment.

FIG. 84 is a diagram showing a structure of a sample introduction unit of the chip relating to an embodiment.

FIG. 85 is a diagram for explanation of the structure of the separation region of the chip relating to an embodiment.

FIG. 86 is a diagram for explanation of a separation method using the separation region of FIG. 85.

FIG. 87 is a diagram showing a structure of the separation unit of the chip relating to an embodiment.

FIG. 88 is an enlarged top view of the separation region of FIG. 87.

FIG. 89 is a diagram showing a structure of a dispensing channels of the chip relating to an embodiment.

FIG. 90 is a diagram showing a structure of a reaction unit of the chip relating to an embodiment.

FIG. 91 is a diagram showing a structure of a channel of the chip relating to an embodiment.

FIG. 92 is a cross-sectional view of FIG. 91.

FIG. 93 is a diagram showing a structure of a control unit of the chip relating to an embodiment.

FIG. 94 is a diagram showing a structure of a sample introduction unit of the chip relating to an embodiment.

FIG. 95 is a diagram for explanation of the structure of the sample introduction unit of the chip relating to an embodiment.

FIG. 96 is a diagram for explanation of the structure of the sample introduction unit of the chip relating to an embodiment.

FIG. 97 is a diagram showing a structure of a buffer inlet of the chip relating to an embodiment.

FIG. 98 is a diagram showing a structure of a sample collection unit of the chip relating to an embodiment.

FIG. 99 is a diagram showing a structure of a detection unit of the chip relating to an embodiment.

FIG. 100 is a diagram showing a structure of the detection unit of the chip relating to an embodiment.

FIG. 101 is a diagram showing a structure of a chip relating to an embodiment.

FIG. 102 is a diagram for explanation of a structure of a separation region of the chip relating to an embodiment.

FIG. 103 is a diagram for explanation of the structure of the separation region of the chip relating to an embodiment.

FIG. 104 is a diagram showing a structure of the chip relating to an embodiment.

FIG. 105 is a diagram showing structures of the separation unit of the chip relating to the embodiment.

FIG. 106 is a diagram showing structures of the separation unit of the chip relating to an embodiment.

FIG. 107 is a diagram showing functional blocks of the chip relating to an embodiment.

FIG. 108 is a diagram showing functional blocks of the chip relating to an embodiment.

### BEST MODE FOR CARRYING OUT THE INVENTION

Hereinafter, embodiments of the present invention will be described with reference to the drawings. Note that, in all the drawings, common structural elements are denoted by the same reference numerals, and explanations thereof will not be appropriately described.

First, in first and second embodiments, a basic structure of a chip in which separation and analysis of a sample are carried out will be described. A chip which will be described in the following embodiments includes a sample introduction unit, a separation unit, and an analysis unit, as the basic structure. In the analysis unit, analysis of components in a separated sample is carried out. The analysis unit may be a detection unit in which it is possible to detect with eyes, for example, as a result that detection reaction of predetermined components is carried out. Further, the analysis unit may be a measurement unit in which sample components to be provided for measurement using an external device are stored. The first embodiment is a structure in which the analysis unit is a detection unit, and the second embodiment is a structure in which the analysis unit is a measurement unit.

### First Embodiment

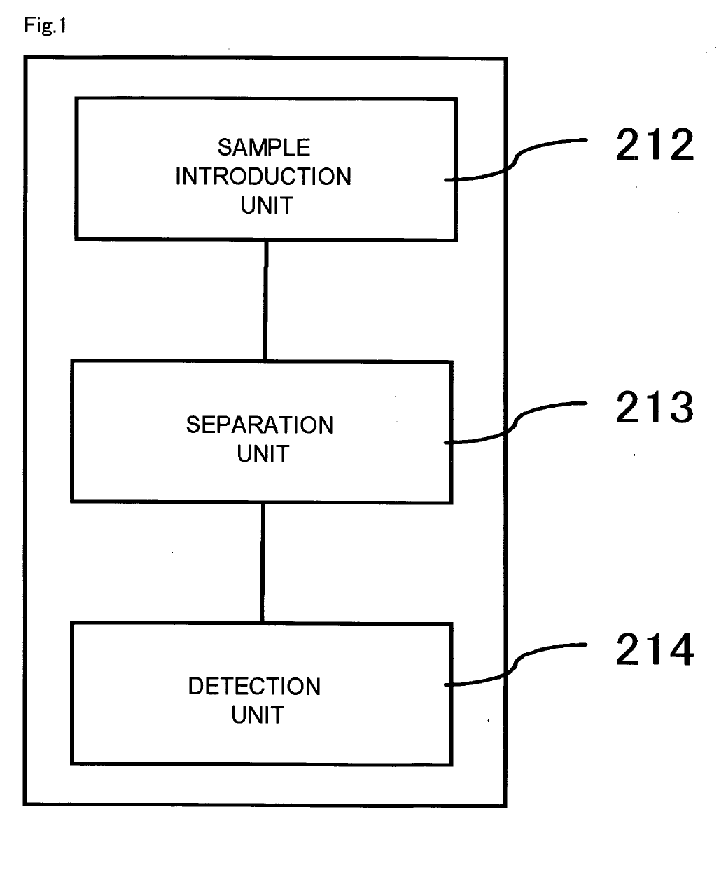

FIG. 1 is a functional block diagram showing basic functions of a chip relating to the present embodiment. A chip 211 of FIG. 1 is a chip on which separation and analysis of a sample can be carried out, and includes a sample introduction unit 212, a separation unit 213, and a detection unit 214 serving as an analysis unit. In the chip 211, those can be formed on a surface of a substrate structured from, for example, silicon, glass, quartz, various types of plastic materials, or an elastic material such as rubber or the like. For example, a groove portion is provided on the surface of the substrate, and this is sealed by a surface member, and in a space surrounded by those, members carrying out the functions shown in FIG. 1, and channels through which those are communicated with one another can be formed. Further, a plurality of substrates are stacked on and attached each other, which may be the chip 211. For example, grooves are respectively formed on two substrates, and the two substrates may be made to abut against one another to join together such that the positions of these grooves correspond to one another. This forms a tubular channel.

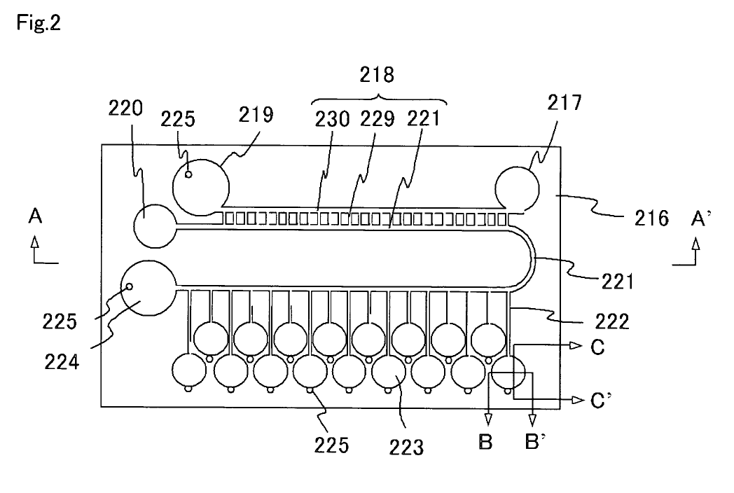

FIG. 2 is a diagram showing one example of the structure of the chip 211 having the functions of FIG. 1. In a chip 215 of FIG. 2, an inlet 217, an separation region 218, a waste reservoir 219, a buffer inlet 220, a main channel 221, dispensing channels 222, detection reservoirs 223, and a reservoir 224 are provided on a substrate 216.

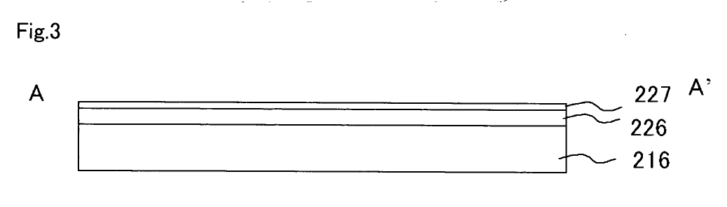

Further, FIG. 3 is a cross-sectional view taken along A-A′ of FIG. 2. Note that, in FIG. 3, the constructional members such as the main channel 221 and the like are not shown, and only a stacked structure of the substrate 216, a cover 226, and a seal 227 is shown. In the chip 215, the cover 226 is provided above the substrate 216. Air holes 225 communicated with the waste reservoir 219, the reservoir 224, and the respective detection reservoirs 223 are provided in the cover 226. Further, the top face of the cover 226 is sealed with the seal 227.

A size of the substrate 216 can be made to be, for example, about 3 to 5 cm×2 to 3 cm. Further, a thickness of the substrate 216 can be made to be, for example, about 0.5 mm to 1 cm. A material of the cover 226 can be, for example, a material used for the substrate 216. Note that it is preferable for the surface of the substrate 216 and the bottom face of the cover 226, i.e., the plane to be joined together with the substrate 216 to be hydrophilic. Due to the surfaces being made to be hydrophilic, a sample can be introduced into the chip 215 by using a capillary phenomenon, and can be moved. Because it is possible to introduce or move a sample without providing an external driving device such as a pump, electrodes, or the like, a convenient device structure can be made.

The main channel 221 and the dispensing channels 222 can be made such that, for example, the widths are about 100 μm, and the depths are about 20 μm. Further, the inlet 217 is a cylindrical reservoir whose φ is about 3 mm, and can be formed by penetrating the same size hole through in the cover 226 as well.

The detection reservoirs 223 are reservoirs which are cylindrical forms whose φ are about 100 μm to 2 mm, or which are rectangular parallelepipeds of about 100 μm to 2 mm square, and can be obtained by forming the air holes 225 at corresponding positions of the cover. The depths of the detection reservoirs 223 can be made to be, for example, about 100 μm to 2 mm. Further, the depths of the detection reservoirs 223 may be at the same level as those of the dispensing channels 222, or may be made slightly shallower than the thickness of the substrate 216. In accordance therewith, because an optical path length is increased in the depth direction, the detection sensitivity can be improved. Further, the surfaces of the detection reservoirs 223 are preferably hydrophilic. Due to the surfaces of the detection reservoirs 223 being made hydrophilic, separated samples can be certainly introduced therein.

The air holes 225 may be not necessarily provided directly above the detection reservoirs 223 as long as those are communicated with the detection reservoirs 223 in the vicinity of the detection reservoirs 223. The air holes 225 can be made to be in sizes of, for example, about φ 50 μm to 1 mm. In accordance therewith, liquid can be certainly introduced into the detection reservoirs 223. Further, the surface of the periphery of the air holes 225 is preferably made hydrophobic. Due to the surface of the air holes 225 being made hydrophobic, liquid dispensed in the detection reservoirs 223 can be prevented from being leaked out of the air holes 225. Therefore, a specific quantity of liquid can be sorted into the detection reservoirs 223. Further, a loss of the sample can be prevented.

The upper parts of the air holes 225 may be sealed with a sealing unit which can be peeled off. In accordance therewith, the sealing unit is peeled away at a predetermined timing at the time of using the chip 215, and the air holes 225 can be exposed.

The waste reservoir 219 is a cylindrical reservoir with φ of about 5 mm, and is obtained by forming the air hole 225 at a corresponding position of the cover. In the structure of the air hole 225 in the vicinity of the waste reservoir 219, the surface of the periphery thereof is preferably made hydrophobic in the same way as those of the air holes 225 in the vicinity of the detection reservoirs 223. The air hole 225 may be not necessarily provided directly above the waste reservoir 219 as long as this is communicated with the waste reservoir 219 in the vicinity of the waste reservoir 219. The air hole 225 can be made to be in a size of, for example about φ 50 μm to 2 mm. Further, this may be made larger than the air holes 225 in the vicinity of the detection reservoirs 223.

The air hole 225 may be sealed so as to be attachable and detachable by a rubber type adhesive or the like. In accordance therewith, the air hole 225 can be exposed at the time of using the chip 215, and can be sealed again after use. Therefore, the chip 215 can be safely discarded after use.

It is preferable for the surface of the waste reservoir 219 to be hydrophilic. Due to the surface of the waste reservoir 219 being made hydrophilic, the liquid in the main channel 221 can be certainly made to move toward the waste reservoir 219 by a capillary effect. Further, even after some of the liquid reaches the waste reservoir 219, it is possible to retain a driving force which moves the liquid in the main channel 221 toward downstream by a capillary effect.

A water-absorbing material may be filled in the waste reservoir 219. In accordance therewith, the liquid can be more certainly moved toward downstream. As the water-absorbing material, for example, a water-absorbing polymer can be used. Further, the surface area of the waste reservoir 219 can be increased by a method of providing many columnar bodies on the surface of the waste reservoir 219, or the like. In this case as well, a movement of liquid toward the waste reservoir 219 side can be promoted.

It suffices for the seal 227 to be formed so as to be able to be peeled off at the time of using the chip 215. For example, it may be structured such that an emulsion type adhesive such as vinyl acetate or the like is applied to the surface of a thin-film of various types of plastic materials. Further, an adhesive of the epoxy type or the silicone type may be used.

A predetermined sample is introduced into the inlet 217 corresponding to the sample introduction unit 212, and serves as a reservoir in the chip 215.

At the time of using the chip 215, first, the seal 227 is peeled off. By peeling off the seal 227, the inlet 217 and the air holes 225 are opened, and are exposed to the air. Next, a sample is added to the opened inlet 217. The added sample is introduced into the separation region 218 by a capillary phenomenon. Note that, in a case of the structure in which the upper portion of the air holes 225 are sealed with the sealing unit, after the seal 227 is peeled off, the upper portions of the air holes 225 can be opened by peeling off the sealing unit in a desired timing.

The separation region 218 has a channel 230, the main channel 221, and a plurality of micro channels 229 which make those be communicated with one another, and is structured so as to be in a filter form. The waste reservoir 219 discharging unnecessary sample is provided so as to be communicated with the channel 230. Further, the buffer inlet 220 is formed so as to be communicated with the main channel 221. Not that, in the chip 215, the structure of the separation region 218 is not limited to the structure of FIG. 2, and for example, it may be a structure which will be described in an embodiment to be mentioned later, or the like.

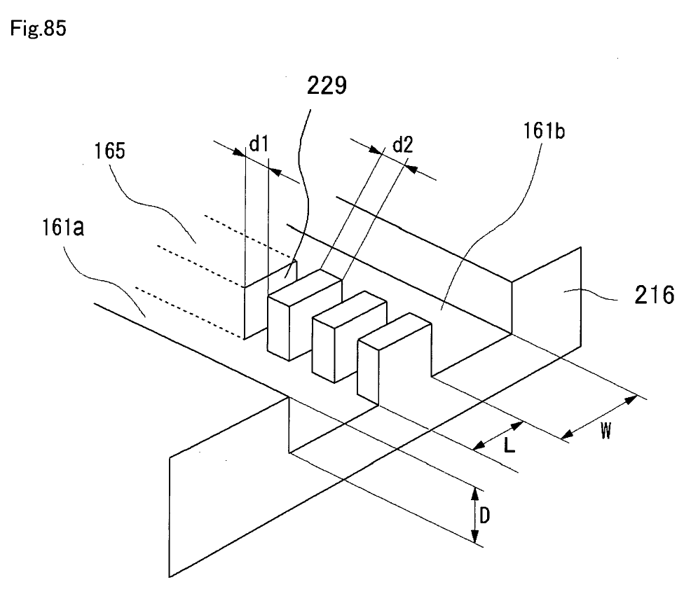

FIG. 85 is a diagram for explanation of the structure of the separation region 218. In FIG. 85, a channel groove 161a and a channel groove 161b (the widths are W and the depths are D in the both) are formed on the substrate 216, and a partition wall 165 is provided therebetween. Here, one of the 161a and 161b is made to be the main channel 221, and the other one is made to be the channel 230. Separation channels are regularly formed at the partition wall 165. The term “separation channels” here is a structure corresponding to the micro channels 229. The separation channels are perpendicular to the channel groove 161a and the channel groove 161b, and the separation channels whose widths are d1 are regularly formed at predetermined intervals d2. The respective dimensions shown in the drawing are set to appropriate values in accordance with a sample to be separated or the like. However, for example, preferred values are selected from a range as follows.

W: 10 μm to 1000 μm

L: 10 μm to 1000 μm

D: 50 nm to 1000 μm

d1: 10 nm to 1 μm

d2: 10 nm to 1 μm

Among those, because a value of L corresponding to a length of a separation channel directly affects a separation property, it is important to precisely design in accordance with a separation purpose. For example, in separation of macromolecules, the conformation of the molecules is changed during passing through the separation channels, which causes enthalpy changes. Accordingly, a total quantity of enthalpy changes associated with the passing of the molecules varies in accordance with a length of a separation channel, which changes the separation property. In the present invention, because the channels are structured by the grooves, those can be prepared by etching or molding processing, and the shapes and the sizes can be precisely controlled. As a result, a separation device with a desired separation property can be stably manufactured. Note that the channel groove 161a, the channel groove 161b, and the separation channels can be formed by various methods. However, when values of d1 and d2 are set 100 nm or less, it is preferable from the standpoint of micro fabrication performance to use dry etching in which electron exposure technologies are combined.

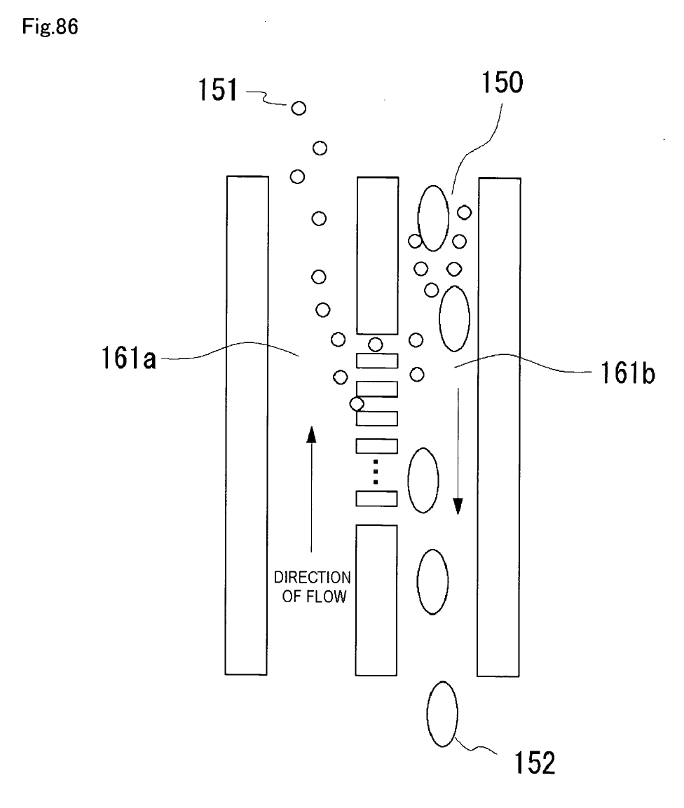

A separation method using the separation region 218 of the structure shown in FIG. 85 will be described with reference to FIG. 86. FIG. 86 is a pattern diagram showing a schematic structure when this separation device is viewed from the top. First, as the preparatory for carrying out separation of a sample, buffer solution serving as a carrier is filled in the respective channel grooves. In FIG. 86, a sample concentrate solution including a mixture 150 flows downward in the drawing in the channel groove 161b. Then, small molecules 151 in the mixture pass through the separation channels provided at the partition wall shown in the center of the drawing, and go into the adjacent channel groove 161a. A solvent which does not initiate a reaction to components subjected to separation flows upward in the drawing in the channel groove 161a. Accordingly, the small molecules 151 which have gone into the channel groove 161a are carried in a direction upward in the drawing so as to keep up the stream. On the other hand, because large molecules 152 in the channel groove 161b cannot pass through the separation channels, the large molecules 152 flow directly through the channel groove 161b to be recovered at the tail end of the channel. As described above, the small molecules 151 and the large molecules 152 are separated from each other.

In FIG. 85, the directions of the flows of the channel groove 161a and the channel groove 161b are made opposite to one another. The both may be made to be a same direction as well. However, when the both are made opposite to one another, the separation efficiency is improved. For example, when the direction of the flow of the channel groove 161a is turned downward in the drawing, the concentration of the small molecules 151 is made higher as it goes in the traveling direction of the flow. Accordingly, a concentration difference between the large molecules 152 in the channel groove 161a and the channel groove 161b is made smaller as it goes in the traveling direction of the flow, and the both are made equal concentration at some point. In the region from this point on, a movement of the large molecules 152 from the channel groove 161b to the channel groove 161a is hard to bring about, and those cannot be separated. In contrast thereto, when the both are made to be directions opposite to one another as in the present embodiment, because a concentration difference between the large molecules 152 in the channel groove 161a and the channel groove 161b is kept, even when the separation channels are formed overall a given long region, high separative power can be ensured.

Further, in the above description, the structure having the partition wall at which the plurality of micro channels 229 serving as separation channels are formed has been shown. However, the separation region 218 may be the following structure.

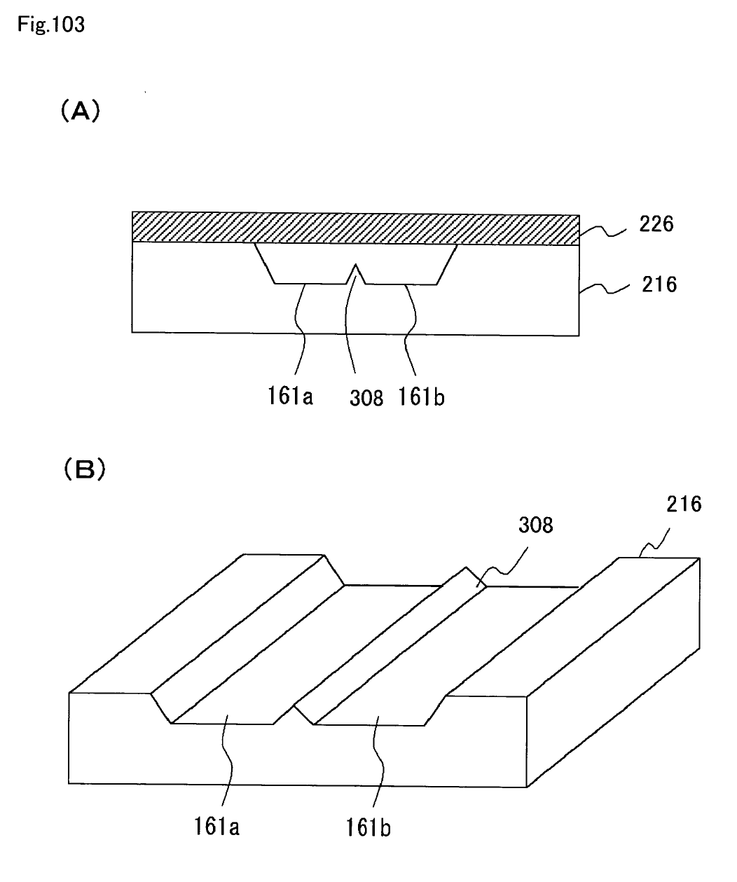

FIG. 103 is a diagram showing a structure of the separation region 218, and split diagrams (A) and (B) are respectively a cross-sectional view and a perspective view. As shown in FIG. 103(A), two of the channel grooves 161a and 161b are provided in the substrate 216, and a partition wall 308 is provided so as to divide those. The cover 226 is disposed on the substrate 166. For convenience, the cover 226 is not shown in FIG. 103(B). Note that the partition wall 308 corresponds to the bank unit described above.

As is clear from FIG. 103(A), because a space is ensured between the partition wall 308 and the cover 226, the channel groove 161a and the channel groove 161b are communicated with one another via this space. This space corresponds to the separation channels provided at the partition wall 165 of the separation region 218 described above. Accordingly, for example, due to a sample including substances subjected to separation being made to flow into the channel groove 161a, and due to a buffer solution being made to flow into the channel groove 161b, the separation operation can be executed.

Note that, in this case, as the cover 226, it is preferable to select one formed from a hydrophobic material such as polydimethylsiloxane, polycarbonate, or the like. In accordance therewith, a sample or a buffer solution can be introduced into the respective channel grooves without being made to go into the other channel groove, and at the stage in which the sample or the like is filled in the both channel grooves, mixture of the sample and the buffer solution in the both channel grooves can be brought about via the above-described space. Such an effect can be obtained by executing the operation in a state in which the cover 226 is not attached thereto. At this time, it can be thought of that the air itself functions as a hydrophobic substance in the same way as the cover 226.

Further, in a state in which the cover 226 formed from a hydrophilic resin material such as polyethylene terephthalate or the like is attached thereto, for example, when a sample is made to flow into the channel groove 161a, the sample goes into the other channel groove 161b. At the time of this infiltration, because only components smaller than the space formed between the cover 226 and the partition wall 308 are leached out, separation of the components in the sample is achieved.

In accordance with this structure, by providing the partition wall 308, because the channel groove 161a and the channel groove 161b are connected so as to have a broader area as compared with the partition wall 165 having the micro channels 229, the separation efficiency can be improved. Further, because it is hard for even elongated materials to clog up, and those easily move between the channels, this structure can be favorably used for separation of a sample including such substances.

The channel groove 161a, the channel groove 161b, and the partition wall 165 are obtained by, for example, carrying out wet etching processing onto a (100) Si substrate. When the (100) Si substrate is used, in a direction perpendicular to or parallel to <001> direction, etching proceeds so as to make a trapezoid as illustrated. Therefore, the height of the partition wall 165 can be adjusted by adjusting the etching time.

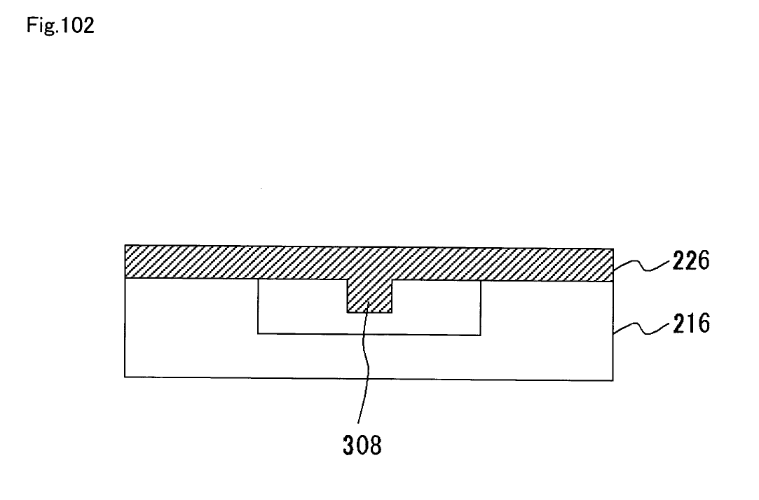

Further, as shown in FIG. 102, the partition wall 308 can be provided on the cover 226. The cover 226 having the partition wall 308 can be easily obtained by carrying out injection molding of a resin such as polystyrene or the like. Further, it suffices to merely provide one channel in the substrate 216 by etching or the like. Accordingly, because the separation region 218 is obtained by a simple process as described above, it is suitable for large-scale production.

In the separation device of the present embodiment, separation can be carried out, for example, due to introduction and diffusion by a capillary phenomenon of a sample concentration solution. Further, it is possible to separate by utilizing an osmotic pressure difference of molecules.

To be back to FIG. 2, the sample introduced in the inlet 217 is introduced into the channel 230 by a capillary phenomenon. When the sample is filled in the channel 230, a predetermined buffer is introduced into the buffer inlet 220. The buffer is used as a developing solvent for separation for the components in the sample. The buffer introduced in the buffer inlet 220 is introduced into the main channel 221 by a capillary phenomenon to move in a direction opposite to the traveling direction of the sample in the channel 230.

Here, because the widths or the depths of the micro channels 229 which make the channel 230 and the main channel 221 be communicated with one another are smaller than that of the channel 230, only components having a predetermined size or shape among the sample components in the channel 230 can pass through the micro channels 229 to move to the main channel 221. Further, components which cannot pass through the micro channels 229 are discharged to the waste reservoir 219. In this way, the components in the sample can be separated in accordance with sizes or shapes in the moving phase. Note that the micro channels 229 may be structured so as to form small holes in the partition wall partitioning the channel 230 and the main channel 221.

For example, rough separation, purificating of the sample can be carried out by using the separation region 218. As a case of rough separation, solid components, cells, or the like in the sample can be removed. Further, in a case of a liquid sample, for example, separation of low-molecular-weight components and high-molecular-weight components, or the like are possible.

The sample components in the main channel 221 are introduced from the dispensing channels 222 communicated with the main channel 221 to the detection reservoirs 223, and are dispensed therein. Here, the detection reservoirs 223 correspond to the detection unit 214 of FIG. 1. A predetermined number of the dispensing channels 222 and the detection reservoirs 223 can be provided on the substrate 216. In the chip 215 of FIG. 2, a plurality of the dispensing channels 222 sequentially diverge from the main channel 221, and because the dispensing channels 222 are thinner channels than the main channel 221, the sample components are sequentially introduced into the detection reservoirs 223 communicated with the dispensing channels 222 at the upstream side by a capillary phenomenon. Further, unrequited samples after the sample components are introduced into all the detection reservoirs 223 are discharged to the reservoir 224.

Provided that such a structure is used, because introduction and a movement of the sample to the chip 215 can be automatically caused by utilizing a capillary phenomenon, it is possible to separate and analyze the sample by a structure of the chip itself without using an external driving device. Note that, as needed, the chip 215 may be connected to an external device having a pump, electrodes, or the like.

Further, in the present embodiment and the following embodiments, a reagent may be introduced into the portion having the buffer inlet 220 and the other reservoirs in advance before using the chip, or may be injected at a desired timing as needed at the time of using the chip.

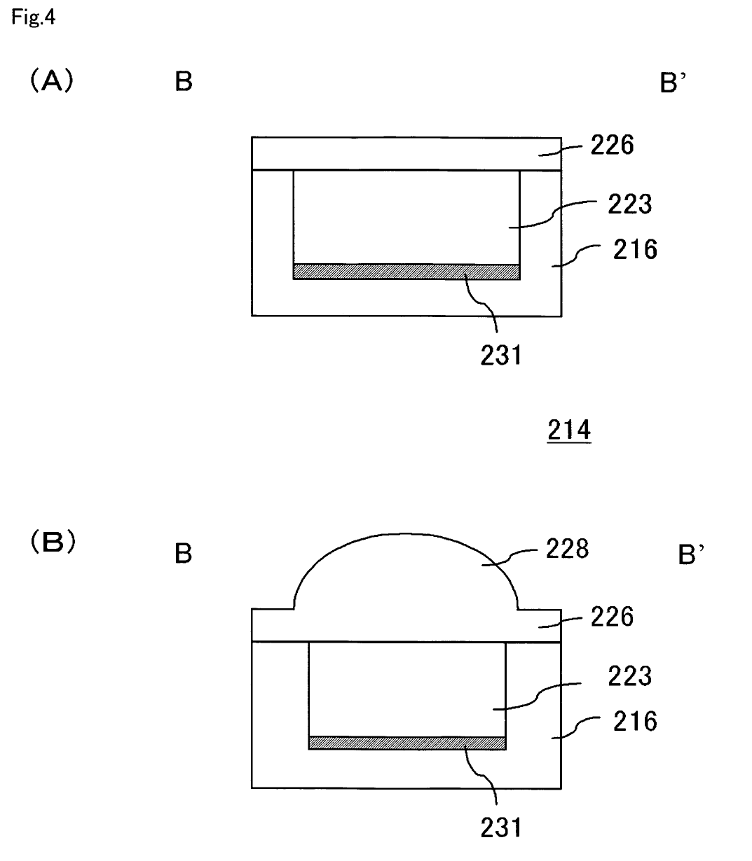

FIG. 4(A) and FIG. 4(B) are cross-sectional views taken along B-B′ of FIG. 2, and diagrams showing structural examples of the detection unit 214 having the detection reservoir 223 as a main structural element. In FIG. 4(A) and FIG. 4(B), the detection reservoirs 223 have a detecting reagent 231 at the bottom faces thereof. The detecting reagent 231 may be a substance or a reagent which, for example, colors, emits light, discolors, decolors, or quenches by being interacted with specific components included in a sample. When the sample separated in the separation region 218 reaches the detection reservoir 223, the detecting reagent 231 is dissolved or dispersed in the moving phase, and a predetermined detection reaction is carried out in the detection reservoir 223. Note that, with respect to the chip 215 having a plurality of the detection reservoirs 223, the detecting reagent 231 is not introduced into one of these detection reservoirs 223, and the one detection reservoir 223 can be used as a reservoir for reference.

In the structure of FIG. 4(A), it is structured such that coloring due to a detection reaction, or the like is observed with eyes through the cover 226. Further, in FIG. 4(B), because a micro lens 228 is formed on the cover 226, a state in the detection reservoir 223 can be enlarged and observed. Accordingly, coloring, light-emission, discoloring, decoloring, or quenching in the detection reservoir 223 can be visually recognized more in detail. Moreover, even when the detection reservoir 223 is extremely small, the coloring, light-emission, discoloring, decoloring, or quenching can be visually recognized. Accordingly, a sample to be provided for analysis can be made in a small quantity.

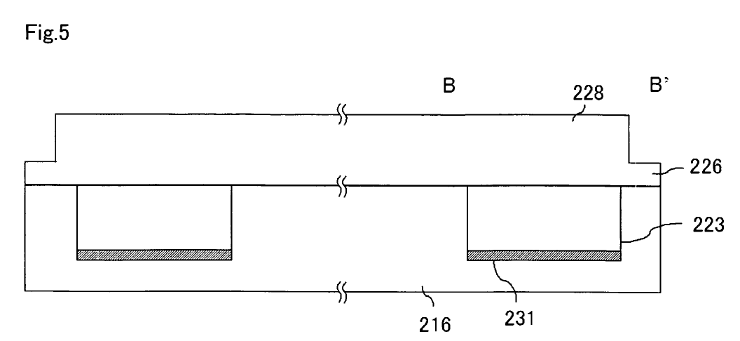

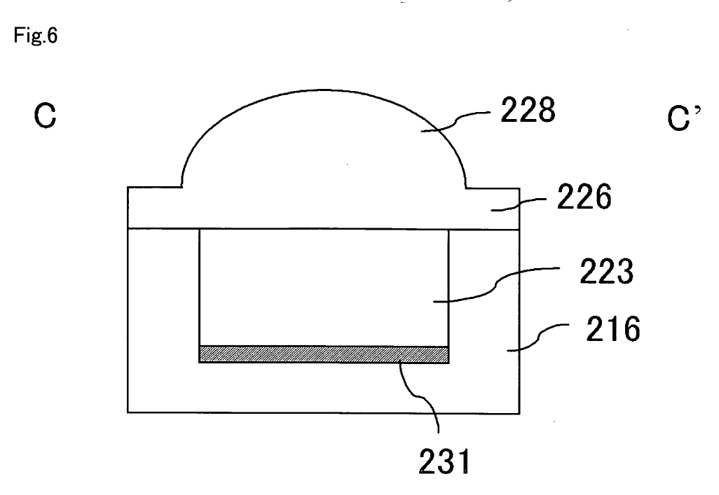

Further, FIG. 5 and FIG. 6 are diagrams showing another structure of the detection unit 214. FIG. 5 is a cross-sectional view taken along B-B′ of FIG. 2, and FIG. 6 is a cross-sectional view taken along C-C′ of FIG. 2. As shown in FIG. 5 and FIG. 6, the micro lens 228 may be formed overall the plurality of detection reservoirs 223. In this case, the micro lens 228 can be, for example, semicylinder shape. In accordance therewith, the structure of the cover 226 can be further simplified.

Manufacture of the chip 215 of FIG. 2 is carried out, for example, as follows. Grooves are formed in the substrate 216, and those are made to be the main channel 221, the channel 230, and the dispensing channels 222. Further, the inlet 217, the detection unit 113, and the detection unit 115 which are communicated with the main channel 221 are formed. Those formations can be carried out, when a plastic material is used as the substrate 216, by a method suitable for a type of the material of the substrate 216, such as etching, press-molding using a metal mold such as emboss molding or the like, injection molding, formation by photo-curing, or the like. The width of the main channel 221 is appropriately set in accordance with a separation purpose. For example, when extraction of high-molecular-weight components (DNA, RNA, protein, sugar chain) among liquid fractional components of cells (cytoplasm) is carried out, the width of the main channel 221 is 5 μm to 1000 μm. Further, the sample inlet 217 and the air holes 225 are formed in the cover 226.

The obtained substrate 216 and cover 226 are joined together. Moreover, the top face of the cover 226 is sealed with the seal 227. In this way, the chip 215 is obtained.

Further, when the substrate 216 and the cover 226 are plastic materials, for example, those can be joined together by heat-sealing. In this case, in a state of heating up to a temperature close to a glass-transition temperature of the resins structuring the substrate 216 and the cover 226, after those are made to touch one another and join together by pressure, the temperature is lowered up to the room temperature, and thereafter, the pressure may be released.

Further, fusion welding using a solvent may be carried out. In this case, after a solvent dissolving the substrate 216 and the cover 226 is sprayed extreme-thinly onto the surfaces thereof, those can be made to abut to join together.

Further, ultrasonic vibration may be applied to those in a state in which the substrate 216 and the cover 226 are made to abut against one another, and the surfaces of the substrate 216 and the cover 226 may be melted and bonded by the energy.

Further, the adhesion may be carried out by using an adhesive selected in accordance with types of the substrate 216 and the cover 226. When an adhesive is used, it is necessary to prevent the micro spaces in the main channel 221 or the like from being buried. Then, for example, an adhesive can be applied or spread out extreme-thinly onto only the cover 226. Further, the cover 226 may be adhered by applying or spreading out an adhesive onto only portions other than the micro structures of the substrate 216 by using a mask.

Further, when the substrate 216 and the cover 226 are, for example, glass, quartz, or silicon substrates in which the surfaces are oxidized, those can be fusion-welded by, for example, a solvent. Concretely, after a hydrofluoric solution is extreme-thinly sprayed onto the surface of the substrate 216 or the cover 226, those can be adhered to one another by heating in a state in which those are made to contact each other by pressure. Further, an adhesive such as an SOG (Silicon Oxide Gel) or the like may be used. When an SOG is used, after the SOG is applied and spread out onto the surface of the substrate 216 or the cover 226, and those may be made to abut against one another, and may be heated at about 200° C. in an oven. The SOG are made to be glass by heating, and those can be certainly adhered to each other.

Further, when the substrate 216 and the cover 226 are rubber, a cross linking agent can be used as an adhesive. An adhesive is applied to the surface of the substrate 216 or the cover 226, and a cross linking reaction is caused in a state in which those are made to abuted on one another, which makes those join together.

Further, in order to prevent molecules such as DNA, protein, or the like from being adhered to the wall surface of the main channel 221 or the channel 230, it is preferable to apply coating onto the channel wall. In accordance therewith, the chip 215 can exert a satisfactory separative power. As a coating material, for example, a substance having a structure similar to that of phospholipids structuring a cell membrane can be quoted. Further, by carrying out coating onto the channel walls with a water-shedding resin such as a fluorinated resin or the like, or a hydrophilic material such as bovine serum albumin or the like, molecules such as DNA or the like can be prevented from being adhered thereto. Further, by coating with hydrophilic macromolecules or the like such as an MPC (2-methacryloyloxyethylphosphorylcholine) polymer or the like, the surface of the substrate 216 can be structured from a hydrophilic resin. Further, the surface of the substrate 216 may be coated with a hydrophilic silane coupling agent.

When the surface of the substrate 216 is made to be hydrophilic by using an MPC polymer, concretely, LIPIDURE® (manufactured by NOF CORPORATION) or the like can be used. When LIPIDURE® is used, for example, this is dissolved in a buffer solution such as a TBE (Tris-Borate EDTA) buffer so as to be 0.5 wt %, and this solution is filled in the main channel 221 or the channel 230, and is left for a several minutes, which enables coating onto the channel walls.

Further, due to the surface of the substrate 216 including the channel walls being made hydrophilic, a sample can be certainly introduced into the inlet 217 by utilizing a capillary phenomenon. Further, the sample introduced in the inlet 217 can be more certainly introduced into the channel 230 to move in the channel 230 and the main channel 221 by a capillary phenomenon. As a method of making the surface of the substrate 216 hydrophilic, it is effective to form a hydrophilic film such as a silicon oxide film or the like on the surface of the channel 230. By forming the hydrophilic film, a buffer solution is smoothly introduced without providing an external force in particular.

Further, due to at least the surface of the substrate 216 being structured from a hydrophilic high polymer material such as PHEMA (polyhydroxyethylmethacrylate) or the like, the capillary effect is promoted. Moreover, nonspecific adsorption of the sample components to the surface of the substrate 216 can be suppressed. Therefore, even when the sample is in a slight quantity, separation and detection, or measurement can be certainly carried out. Further, the surface of the substrate 216 is structured from titanium oxide, and irradiation of ultraviolet rays is carried out onto the surface thereof, which can make the surface of the substrate 216 hydrophilic. Further, ashing may be carried out onto the surface of the substrate 216 by oxygen plasma.

Further, when the surface of the cover 226 is sealed with the seal 227, at the time of sealing the surface of the joined body of the substrate 216 and the cover 226 with the seal 227, it may be sealed after an inert gas such as nitrogen or the like is filled in the opening portion. In accordance therewith, it is possible for the surface of the substrate 216 to be not exposed to the air until immediately before the chip 215 is used. Therefore, deterioration in the hydrophilic property of the surface due to the chip 215 being exposed to the air can be suppressed. Therefore, introduction and movement of the sample by a capillary phenomenon can be certainly carried out. Note that, an inert gas is not filled, and the surface of the joined body may be sealed with the seal 227 under reduced pressure. Further, the chip 215 sealed with the seal 227 can be housed in an exterior body to be stored. At this time, it is preferable to fill an inert gas in the exterior body, or to house the chip 215 in the exterior body under reduced pressure.

Further, in FIG. 3, the chip 215 to which the seal 227 is provided has been exemplified. However, the chip in the present embodiment and the following embodiments may have a structure in which the seal 227 is not provided. Due to the structure in which the seal 227 is not provided, the structure of the chip can be simplified. Further, by providing the seal 227, the opening portions such as the inlet 217, the air holes 225, and the like can be prevented from being exposed to the air. Therefore, handling at the time of carrying or the like can be further simplified. Further, it is possible to prevent dust from entering into the chip. Further, when the detecting reagent 231 is retained in the detection reservoir 223, the detecting reagent 231 can be prevented from changing in quality.

As described above, by using the chip 211 relating to the present embodiment, predetermined components in a sample are separated, and moreover, it is possible to carry out detection thereof.

For example, when color reaction is carried out in the detection reservoir 223, it is possible to judge the presence or absence of specific components in the sample, or to measure the concentration thereof by carrying out the colorimetry thereof. In this case, it is preferable for the substrate 216 to be formed by a transparent material. In accordance therewith, more precise detection can be carried out. As the transparent material, concretely, quartz, cyclic polyolefin, PMMA (polymethyl methacrylate), PET (polyethylene terephthalate), or the like can be used.

As detection using the chip 211, for example, a blood sugar level monitoring is quoted. In this case, when blood is introduced as a sample into the inlet 217, the blood cells are separated through the separation region 218. Plasma components diluted by a buffer introduced into the buffer inlet 220 are dispensed into the detection reservoirs 223. Provided that NAD (β-nicotinamide adenine dinucleotide, oxidized form), ATP (adenosine triphosphate disodium), hexokinase, glucose-6-phosphate dehydrogenase, or magnesium acetate is used as the detecting reagent 231, blood sugar level can be easily judged based on an extent of coloring in the detection reservoir 223.

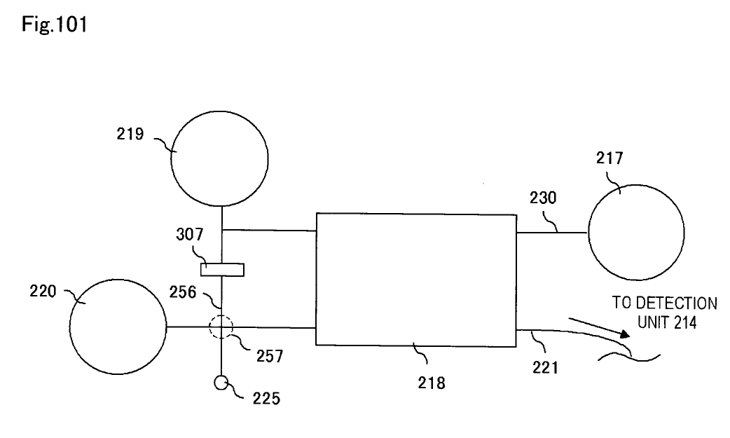

Note that, in the chip 215 of FIG. 2, it may be structured such that the waste reservoir 219 is communicated with the buffer inlet 220 via the trigger channel 256. FIG. 101 is a diagram schematically showing such a structure. In FIG. 101, a filter 307 is provided in the trigger channel connecting the waste reservoir 219 and the buffer inlet 220. By providing the filter 307, it is possible to prevent components which cannot pass through the separation region 218 among the components in the channel 230, from going into downstream side of the trigger channel 256.

Further, a liquid switch 257 is formed at the cross point of the main channel 221 and the trigger channel 256. By providing the liquid switch 257, it can be structured such that the liquid switch 257 is opened at a point in time the liquid sample introduced in the inlet 217 reaches the liquid switch 257 via the channel 230 and the trigger channel 256, and the buffer introduced in advance in the buffer inlet 220 moves in the main channel 221. Note that the concrete structure of the liquid switch 257 will be described later in a third embodiment.

In accordance with this structure, due to a predetermined buffer being introduced in advance into the buffer inlet 220, it is possible to make the processings on and after introduction of the sample into the inlet 217 by a capillary force automatically progress by the structure of the chip 215 itself. Therefore, separation and detection of the components in the sample can be more efficiently carried out.

### Second Embodiment

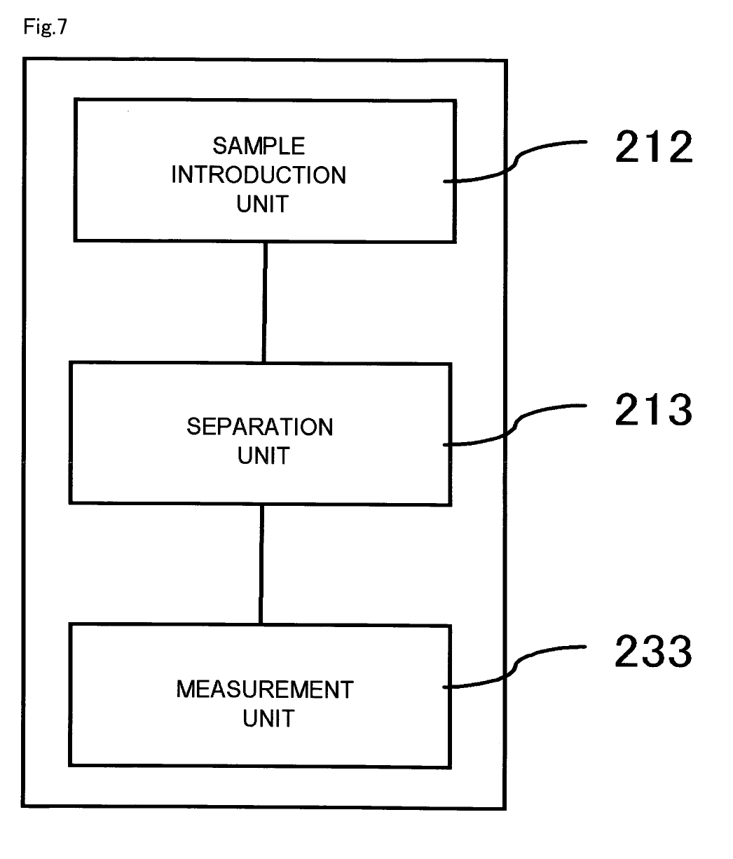

FIG. 7 is a functional block diagram showing one example of a basic structure of a chip relating to the present invention. A chip 232 is different in the point that a measurement unit 233 is provided as an analysis unit in place of the detection unit 214 in the chip 211 described in the first embodiment. The measurement unit 233 is a region in which sample components to be provided for measurement using an external device are reserved.

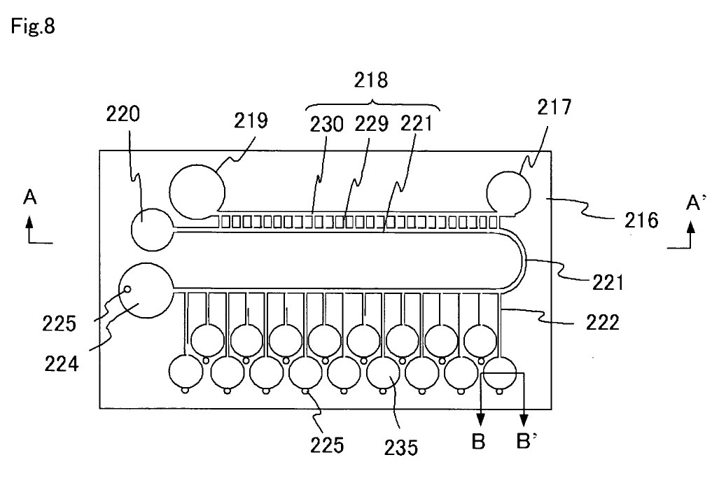

FIG. 8 is a diagram showing one example of a structure of a chip 234 having the functions in FIG. 7. The basic structure of the chip 234 is the same as that of the chip 215 (FIG. 2) described in the first embodiment. However, there is a difference in the point that sorting units 235 are provided in place of the detection reservoirs 223. The sorting units 235 are reservoirs into which sample components separated at the separation region 218 are sorted.

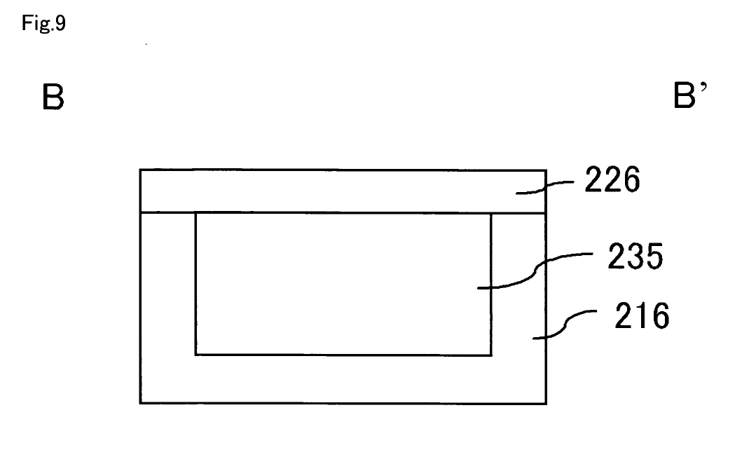

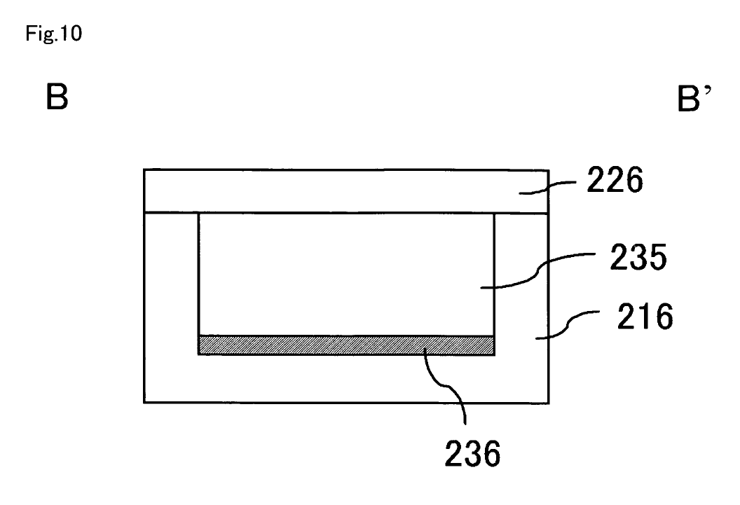

FIG. 9 and FIG. 10 are diagrams illustrating the structure of the measurement unit 233 having the sorting unit 235 serving as a main component. The sorting unit 235 may be formed, as shown in FIG. 9, from only a reservoir into which a sample is reserved. Or, as shown in FIG. 10, a measuring reagent 236 may be provided. As a measuring reagent, for example, a substance which can be used as the detecting reagent 231 in the chip 215 described in the first embodiment can be used. By using a measuring reagent, it is possible to certainly carry out analysis on specific components in a sample by utilizing coloring reaction or the like. Concretely, it is possible to measure a transmitted light intensity in a range of wavelength of about 280 to 850 nm.

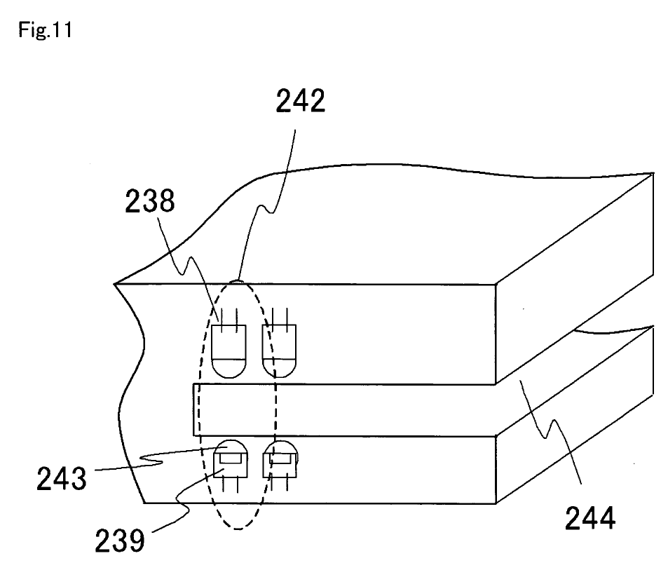

FIG. 11 is a diagram schematically showing a structure of a measuring device 237 carrying out optical measurement of the sample components of the sorting unit 235 by inserting the chip 234. The measuring device 237 has an insertion unit 244 into which the chip 234 is inserted, measurement units 242 which irradiate light onto the sorting units 235 of the chip 232 inserted in the insertion unit 244, and measure optical properties. The measurement unit 242 includes light sources 238, condenser units 243, and light-sensitive units 239.

A size of the measurement unit 242 is designed so as to correspond to a size of the sorting unit 235. For example, in the chip 234, the depth of the sorting unit 235 can be made to be about 100 μm to 2 mm, and an interval between the sorting units 235 can be made to be about 100 μm to 2 mm. At this time, the sizes of the light source 238, the condenser unit 243, and the light-sensitive unit 239 are designed so as to correspond thereto.

The light source 238 may be, for example, an LED, a laser diode, a semiconductor laser, or the like. Because a type of the light source is different in accordance with a measuring wavelength, it is appropriately selected in accordance with a wavelength of coloring or the like caused by the measuring reagent 236. As the condenser unit 243, for example, a SELFOC lens can be used by being processed in a predetermined shape and size. The light-sensitive unit 239 may be, for example, a phototransistor, a photocell, or the like.

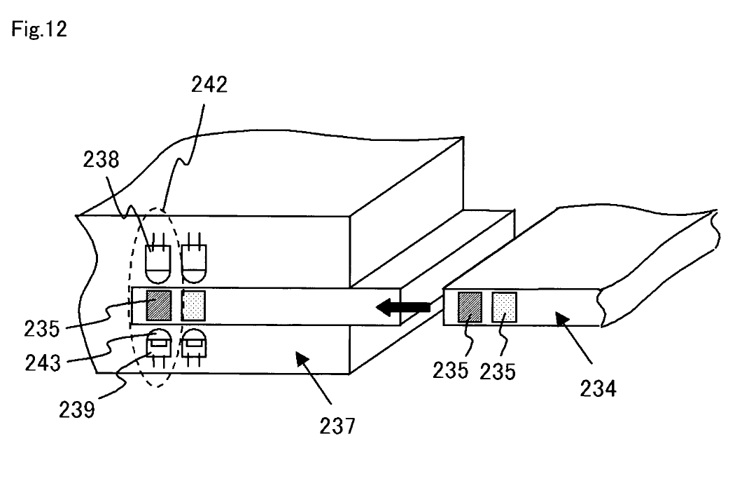

FIG. 12 is a diagram showing a state in which the chip 234 is inserted into the measuring device 237 of FIG. 11. When the chip 234 is inserted into the insertion unit 244 of the measuring device 237, the sorting units 235 are inserted into the positions corresponding to the measurement units 242. Therefore, provided that the measurement units 242 corresponding to the number of the sorting units 235 formed in the chip 234 are provided, optical measurements can be carried out at one time with respect to the respective sorting units 235. Therefore, measurement for a short time is possible. Further, the measuring device 237 may be structured so as to have one measurement unit 242, and to sequentially carry out optical measurements with respect to a plurality of the sorting units 235 by sliding the chip 232 in the insertion unit 244.

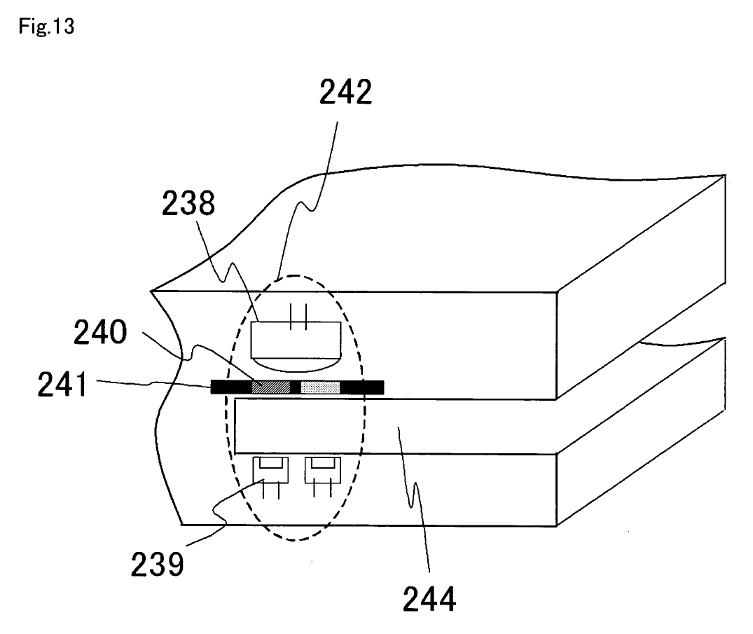

Further, FIG. 13 is a diagram showing another structure of the measuring device 237. The basic structure of the measuring device 237 of FIG. 13 is the same as that of the device of FIG. 11. However, there is a difference in the point that one light source 238 is provided, and an optical filter 240 and a shading plate 241 are provided. Note that, in FIG. 13, it is structured such that the condenser units 243 are not provided. However, it may be structured such that the condenser units 243 are provided.

By providing the optical filter 240, only a light within a range of a predetermined wavelength among the outgoing light from the light source 238 can be irradiated onto the sorting unit 235. Therefore, even when the light source 238 in which a wavelength distribution of outgoing light is broad, such as a lamp light source, is used, it is possible to carry out a spectrum with the optical filter 240 corresponding to the measuring wavelength, and to measure those. Further, because the optical filter 240 is supported with the shading plate 241, an outgoing light from the light source 238 can be prevented from being leaked to another measurement unit 242.

As the optical filter 240, a material known as an optical filter can be used by being processed in a predetermined size.

Note that, in the measuring device 237 shown in FIG. 11 or FIG. 13, it may be structured such that the light source 238 is not provided, and a light from an exterior light source is introduced by an optical fiber or the like, and is irradiated onto a position into which the sorting unit 235 is inserted. Further, the above description has been carried out such that a transmittance in the sorting unit 235 is measured. However, the measurement unit 242 may be structured so as to measure an absorbance or a scattering intensity.

Further, the structure of the chip 232 and the structure of the measuring device 237 are not limited to those described above, and may be made to be various structures.

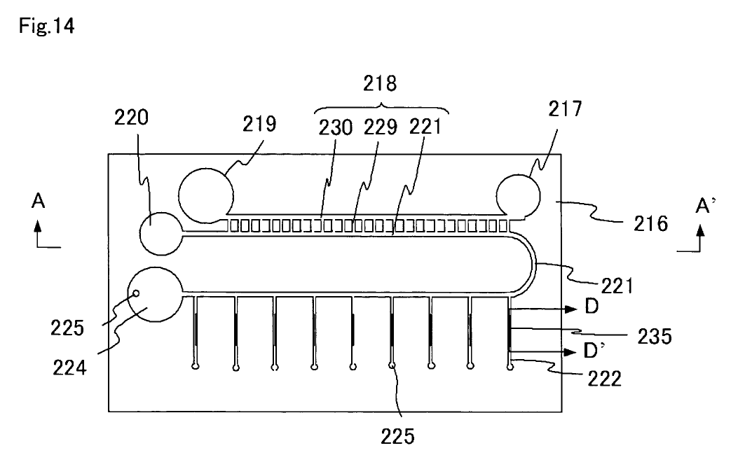

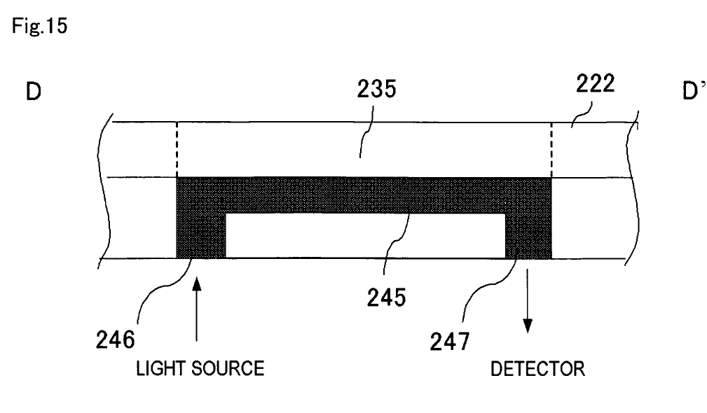

For example, as shown in FIG. 14, the sorting units 235 may be provided on the dispersing channels 222, and optical waveguides 245 may be formed at the lower portions of the sorting units 235. Here, the optical waveguides 245 can be formed from silica material or organic polymer material. The optical waveguide 245 is structured such that the refractive index is higher than that of the peripheral material. In this case, a light is introduced from the bottom face of the chip into the optical waveguide 245, and in the same way, the light is taken out of the bottom face of the chip. FIG. 15 is a cross-sectional view taken along D-D′ of FIG. 14. As shown in FIG. 15, one end of the optical waveguide 245 is connected to a floodlighting optical waveguide 246, and the other end thereof is connected to a light receiving optical waveguide 247. The floodlighting optical waveguide 246 and the light receiving optical waveguide 247 are provided so as to be elongated in the normal line direction of the horizontal surface of the substrate 216, and are provided from the optical waveguide 245 to the surface of the substrate 216.

In this case, for example, the light source 238 which introduces a light into the floodlighting optical waveguide 246 of the chip, and the light-sensitive unit 239 for receiving light from the light receiving optical waveguide 247 may be provided on the bottom face or the like of the measuring device 237. Provided that such a structure is used, due to the plane on which the floodlighting optical waveguide 246 and the light receiving optical waveguide 247 of the chip are exposed being made to contact the bottom face or the like of the measuring device 237, the dispensing channels 222 themselves can be used as the sorting units 235 for measurement, and it is possible to carry out introduction of light into the sorting units 235, and detection of light from the sorting units 235.

Further, in the chip shown in FIG. 14 and FIG. 15, it may be structured such that the optical waveguide 245 is not provided. At this time, due to the floodlighting optical waveguide 246 and the light receiving optical waveguide 247 being provided, an outgoing light from the light source 238 is introduced into the sorting unit 235 via the floodlighting optical waveguide 246, and an outgoing light from the sorting unit 235 can be received at the light-sensitive unit 239 via the light receiving optical waveguide 247. With respect to this structure as well, it is possible to carry out optical measurements of predetermined components in the liquid sorted in the sorting units 235. Further, because the optical waveguide 245 is not provided, the structure of the chip can be simplified.

In the present embodiment, by using the chip 232 having the measurement unit 233, a sample suitable for measurement by an external device can be easily prepared. For example, with respect to a sample to which separation and sorting have been carried out by using the chip 234, optical measurements of the separated components can be carried out by directly inserting the chip 234 into the measuring device 237. Therefore, analysis on the components in the sample can be certainly carried out with a simple technique.

Note that it may be not structured such that the chip 234 is directly provided for the measuring device, it may be an aspect in which the samples sorted in the sorting units 235 of the chip 234 are extracted and provided for measurement of an external device.

As measurement by using the chip 232, for example, detection of blood sugar level can be quoted. In this case, when blood is introduced as a sample into the inlet 217, the blood cells are separated through the separation region 218. Plasma components diluted with a buffer introduced in the buffer inlet 220 are dispensed into the sorting units 235. In the same way as the detecting reagent in the first embodiment, provided that NAD (β-nicotinamide adenine dinucleotide, oxidized form), ATP (adenosine triphosphate disodium), hexokinase, glucose-6-phosphate dehydrogenase, or magnesium acetate is used as the measuring reagent 236, a blood sugar level can be easily judged by measuring an extent of coloring in the sorting unit 235 by the measuring device 237. Further, it is possible to detect liver enzymes AST, or the like.

A chip having the basic structure described in the first or second embodiment further has a structure described in one of the following embodiments.

### Third Embodiment

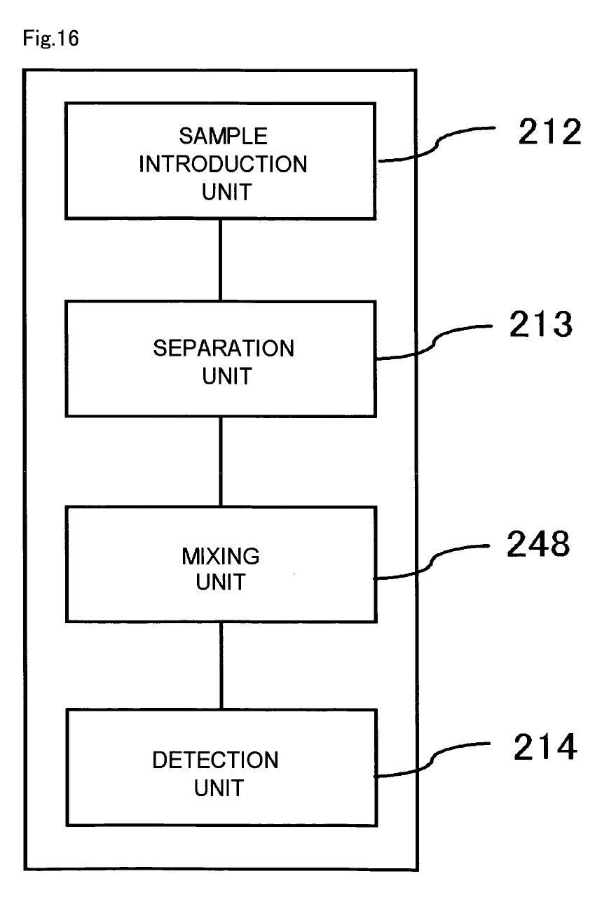

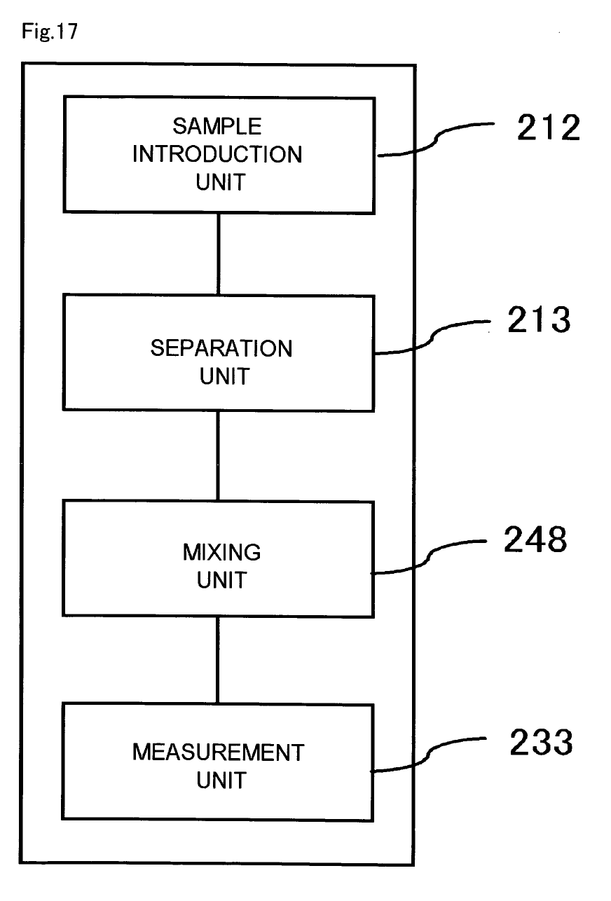

A chip relating to the present embodiment has the basic structure described in the first or second embodiment, and has a mixing unit for homogenizing the concentration of a sample in advance of detection or measurement, between the separation unit 213 and the analysis unit (the detection unit 214 or the measurement unit 233). FIG. 16 and FIG. 17 are functional block diagrams showing the structures of the chips relating to the present embodiment. In a chip 249 of FIG. 16, a mixing unit 248 is formed between the separation unit 213 and an analysis unit (the detection unit 214 or the measurement unit 233). Further, in a chip 250 of FIG. 17, the mixing unit 248 is formed between the separation unit 213 and the measurement unit 233. Hereinafter, a case of the structure in which the detection unit 214 is provided will be described as an example.

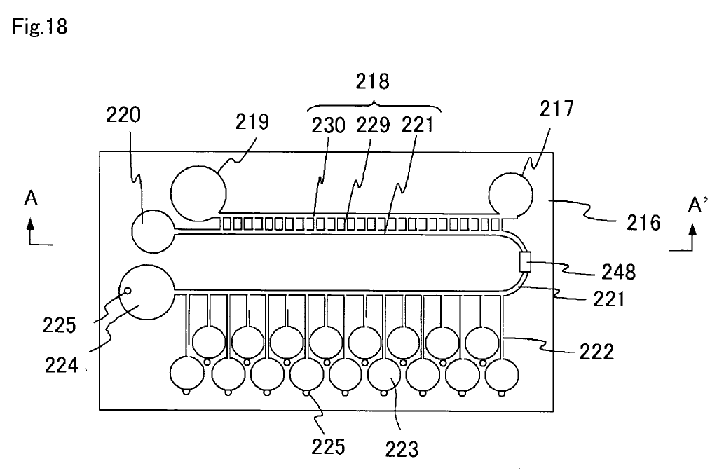

FIG. 18 is a diagram showing one example of a structure of the chip having the mixing unit 248. The basic structure of a chip 251 of FIG. 18 is the same as that of the chip 215 of FIG. 2. However there is a difference in the point that the mixing unit 248 is provided in the main channel 221 between the separation region 218 and the dispensing channels 222.

In the chip 251, there is no limit in particular to the mixing unit 248 which is structured so as to be able to homogenize the concentration of sample components in the liquid flowing in the main channel 221. However, it can be structured as follows.

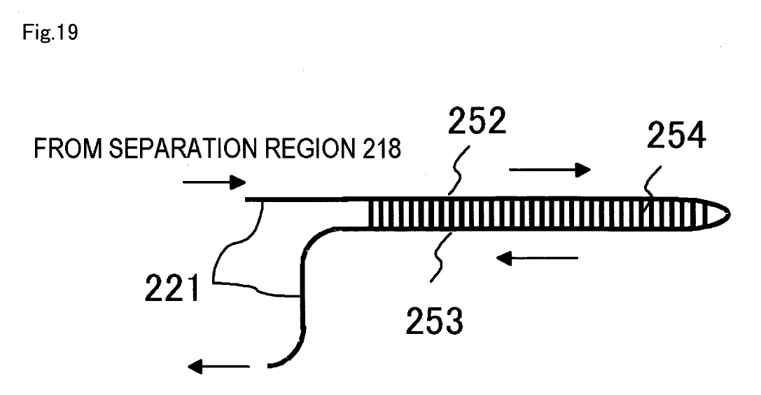

FIG. 19 is a diagram showing one example of the structure of the mixing unit 248. The mixing unit 248 of FIG. 19 is an entrance channel utilizing a homogenization effect due to countercurrent. This channel is structured such that an outward channel 252 and a homeward channel 253 of the main channel 221 are communicated with one another by mixing micro channels 254. The mixing micro channels 254 can be, for example, small holes provided at the partition wall partitioning the outward channel 252 and the homeward channel 253.

The surfaces of the mixing micro channels 254 are made hydrophobic compared to the outward channel 252. In accordance therewith, it can be structured such that the liquid passing through the separation region 218 does not flow in the homeward channel 253 from the mixing micro channels 254 until the liquid fills up the outward channel 252. When the outward channel 252 is filled with the liquid, and the liquid reaches the homeward channel 253, due to the liquid going into the mixing micro channels 254 from the outward channel 252 side and the homeward channel 253 side, the outward channel 252 and the homeward channel 253 are communicated with one another via the mixing micro channels 254. Then, mutual diffusion is brought about between the liquid in the outward channel 252 and the liquid in the homeward channel 253, which can homogenize the concentration of the liquid. The homogenized liquid is introduced into the detection reservoirs 223 through the dispensing channels 222 from the main channel 221.

Provided that such a structure is used, it is possible to homogenize the concentration of liquid which passes through the homeward channel 253 to flow in the dispensing channels 222. Accordingly, when the concentration of the sample components in the liquid passing through the separation region 218 is uneven, the concentration of sample components in a liquid supplied to a plurality of the detection reservoirs 223 can be made constant. Therefore, an accuracy of detection reaction can be improved.

For example, when there is a region in which the concentration of the sample components is high, at the front end region of a liquid flowing in the main channel 221, as it goes forward in the outward channel 252, the liquid is exchanged with the low-concentration liquid in the homeward channel 253 which has already been diluted, and homogenized to have an average concentration. In contrast thereto, when the high-concentration region is distant from the front end of the liquid flowing in the main channel 221, and exists in the outward channel 252 even after the liquid goes into the homeward channel 253, the low-concentration liquid going forward in the homeward channel 253 is homogenized in an average concentration by being mixed with the high-concentration liquid in the homeward channel 253. Note that, in FIG. 19, the main channel 221 is made to be a straight-line shape. However, it may be a zigzag shape or a spiral shape. In accordance therewith, the mixing unit 248 can be made to be a compact shape. Therefore, the chip 251 can be miniaturized.

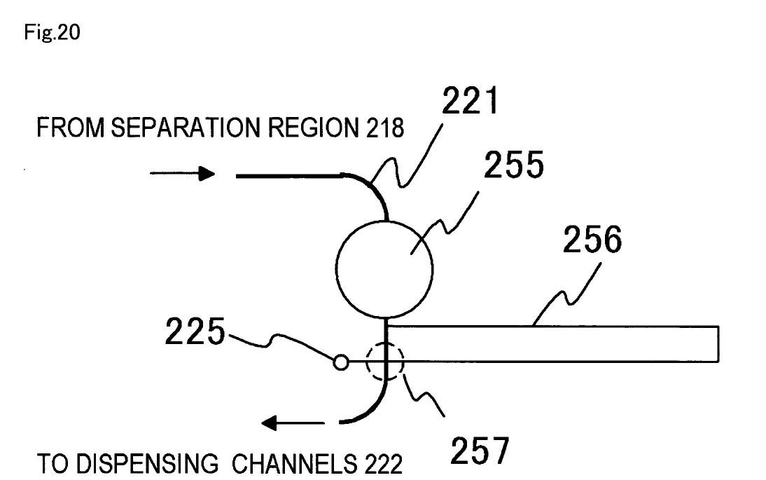

Further, FIG. 20 is a diagram showing another structure of the mixing unit 248. In the mixing unit 248 of FIG. 20, a reservoir 255 is provided in the main channel 221, and the trigger channel 256 making two areas in the main channel 221 be communicated with one another is provided at downstream of the reservoir 255. The trigger channel 256 can adjust a traveling speed of a liquid in the channel by appropriately adjusting an extent of the hydrophilic property in the channel, a diameter of the channel, or the like. In accordance therewith, it is possible to adjust a speed of a switching operation. The liquid switch 257 is provided at a cross point at the downstream side, i.e., at the dispensing channel 222 side among two cross points of the trigger channel 256 and the main channel 221.

In the mixing unit 248 as described above, the liquid switch 257 is initially closed, and the liquid passing through the separation region 218 is reserved in the reservoir 255, and the concentration thereof is homogenized. When the reservoir 255 is filled with the liquid, some of the liquid flows into the trigger channel 256. Then, when the liquid is filled in the trigger flow cannel 256, and reaches the region at which the liquid switch 257 is formed, because the liquid switch 257 is opened, the liquid homogenized in the reservoir 255 flows into the dispensing channels 222.

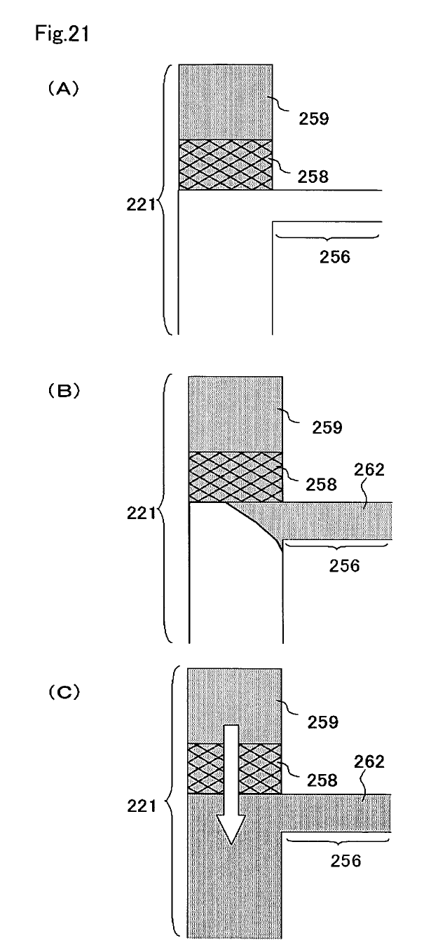

FIG. 21(A) to FIG. 21(C) are top views in which the liquid switch 257 portion of FIG. 19 is enlarged. The liquid switch 257 is a switch for controlling a flow of liquid, and the liquid serves as a trigger for opening and closing the switch. FIG. 21(A) shows a switch closed form, and FIG. 21(B) and FIG. 21(C) show switch open form. In the drawings, the trigger channel 256 is connected to the side face of the main channel 221. The trigger channel 256 can adjust a traveling speed of a liquid in the channel by appropriately adjusting an extent of the hydrophilic property in the channel, a diameter of the channel, or the like. In accordance therewith, a speed of a switching operation can be adjusted. A damming portion 258 is provided at the upstream side of the region at which the main channel 221 and the trigger channel 256 cross (at the upper side in the drawing). The damming portion 258 is a portion having a capillary force stronger than those of the other portions of the channel. As a concrete structure of the damming portion 258, the following examples are exemplified.

(i) A structure in which a Plurality of Columnar Bodies are Provided

In this structure, a channel surface area per channel unit volume in the damming portion 258 is made larger than that of the other portion of the channel. Namely, it is structured such that, when the main channel 221 is filled with the liquid, a solid-liquid interface in the damming portion 258 is made larger than that of the other portion of the channel.

(ii) A structure in which a Plurality of Porous Bodies or Beads are Filled

In this structure, it is structured such that a solid-liquid interface at the damming portion 258 is made larger than that of the other portion of the channel.

In a case of the structure of the above-described (i), the columnar bodies can be formed by an appropriate method in accordance with a type of the substrate. When a glass substrate or a silica substrate is used, those can be formed by utilizing a photolithography technique and a dry etching technique. When a plastic substrate is used, a metal mold having a reversal pattern of the patterns of the columnar bodies to be formed is prepared, and a desired columnar body pattern plane can be obtained by carrying out molding with this metal mold being used. Note that such a metal mold can be formed by utilizing a photolithography technique and a dry etching technique.

In a case of the structure of the above-described (ii), the porous bodies or beads can be formed by directly filling or adhering those to predetermined area in the channel.

In the present embodiment, the structure of the above-described (i) is used.

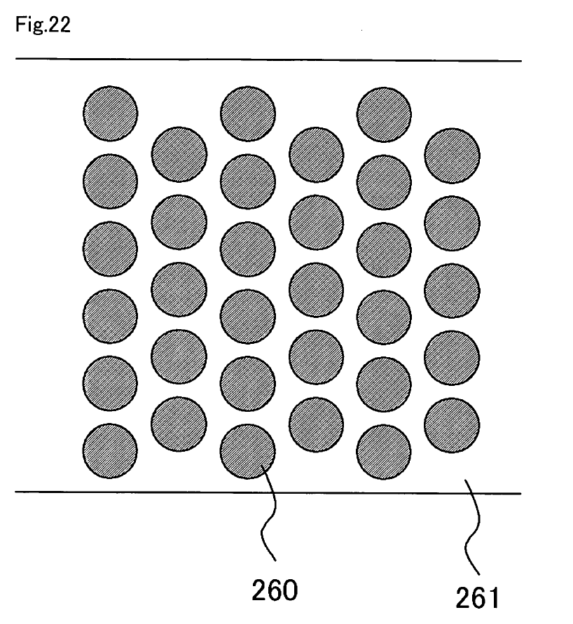

FIG. 22 is a top view of the damming portion 258. A plurality of columnar bodies 260 are regularly disposed at substantially even intervals. The region other than the columnar bodies 260 serves as a micro channel 261. In the damming portion 258, a channel surface area per channel unit volume is larger than that of the other portion of the channel. Therefore, a liquid which has gone into the damming portion 258 is retained in the micro channel 261 by a capillary force.

FIG. 21(A) shows the liquid switch 257 in a standby state. A liquid sample 259 introduced in the main channel 221 is retained at the damming portion 258. When a trigger liquid 262 which has detoured in the trigger channel 256 is introduced from this state at a desired timing, the front end portion of the liquid level of the trigger liquid 262 goes forward as in FIG. 21(B), and contacts the damming portion 258. In the state of FIG. 21(A), the liquid sample 259 is retained at the damming portion 258 by a capillary force. However, when it is in the state of FIG. 21(B) in which the liquid sample 259 has contacted the trigger liquid 262, the liquid sample 259 moves to downward (downstream) side in the drawing, and the liquid sample 259 flows out to downstream of the main channel 221 of FIG. 21(C). Namely, the trigger liquid 262 functions as priming water, and an operation as a liquid switch for drawing out the liquid sample 259 to the downstream side is brought out.

In the above description, the liquid sample 259 and the trigger liquid 262 are liquids which have passed through the reservoir 255. Accordingly, in accordance with this structure, the liquid can be prevented from flowing to the side of the dispensing channels 222 during the time when the liquid which has passed through the separation region 218 fills the reservoir 255, and further reaches the front end of the trigger channel 256, i.e., the cross point at the downstream side of the main channel 221. Therefore, an attempt can be certainly made to homogenize the concentration of sample components in the reservoir 255. Further, a timing in which the liquid flows into the dispensing channels 222 can be favorably adjusted by the structure of the trigger channel 256.

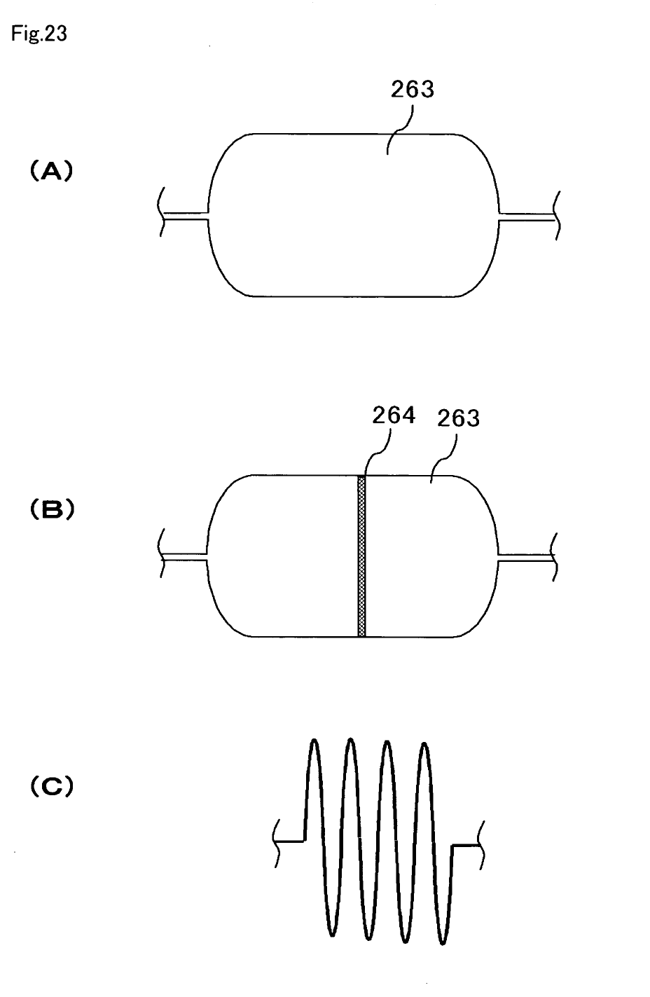

FIG. 23(A) to FIG. 23(C) are diagrams illustrating the structure of the trigger channel 256. In FIG. 23(A), a channel extended region 263 is formed at a part of the trigger channel 256. The channel extended region 263 functions as a time-lag reservoir in the trigger channel 256. In accordance therewith, a timing in which the liquid switch 257 is opened can be delayed.

In FIG. 23(B), a hydrophobic region 264 is formed in the channel extended region 263 in the trigger channel 256 having the structure of FIG. 23(A). The hydrophobic region 264 is formed so as to cross the channel extended region 263 in a direction perpendicular to the traveling direction of the liquid in the trigger channel 256. By providing the hydrophobic region 264, a liquid can be restrained from reaching the other end so as to transmit along only the wall surface in the channel extended region 263.

FIG. 23(C) shows an example of the zigzag shaped trigger channel 256. In this way, by optimizing the shape and the length of the trigger channel 256, it is possible to open the liquid switch 257 at a desired timing. The shape of the trigger channel 256 whose occupied area is small is not limited to the shape of FIG. 23(C), and may be, for example, a spiral shape.

In accordance with the chip 249 or the chip 250 relating to the present embodiment, because the mixing unit 248 is provided between the separation unit 213 and the detection unit 214 or the measurement unit 233, after the concentration of liquid passing through the separation unit 213 is homogenized, the liquid can be introduced into the detection unit 214 or the measurement unit 233. Therefore, unevenness in sample components in the liquid introduced into the detection unit 214 or the measurement unit 233 can be eliminated. Therefore, accuracy in detection reaction in the detection unit 214 or measurement in the measurement unit 233 can be improved.

### Fourth Embodiment

The present embodiment relates to a chip in which a pretreatment unit which applies a predetermined pretreatment onto a sample in advance of separation is provided between the sample introduction unit 212 and the separation unit 213 in the chip described in the above embodiments. The chip of the present embodiment has the basic structure described in the first or second embodiment.

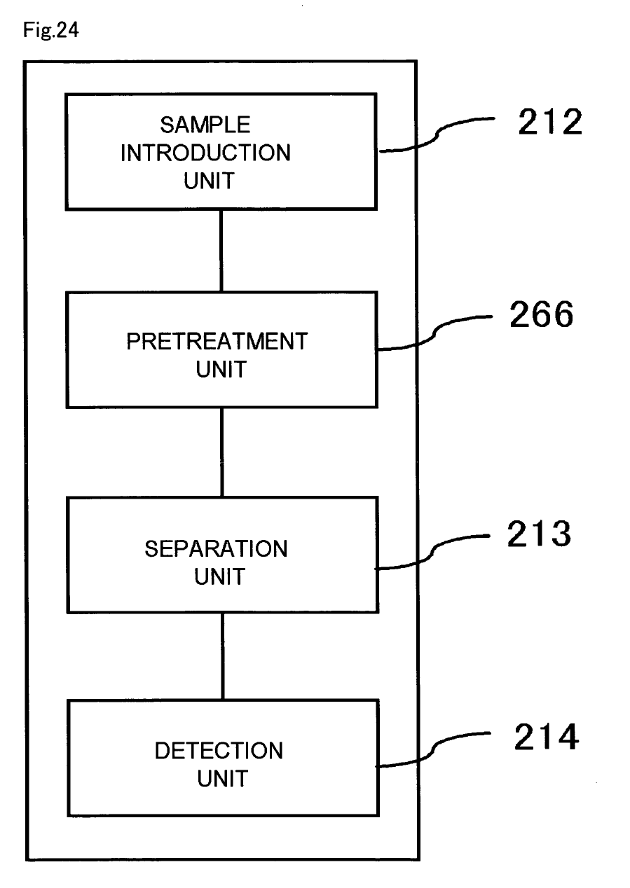

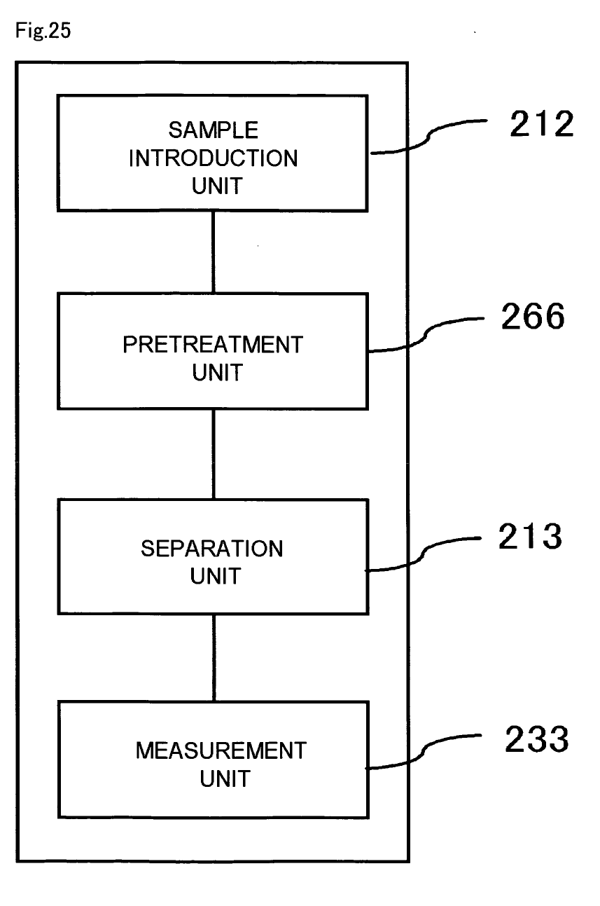

FIG. 24 and FIG. 25 are functional block diagrams showing the structures of the chips relating to the present embodiment. In FIG. 24 and FIG. 25, the detection unit 214 and the measurement unit 233 are respectively provided as an analysis unit. In both of a chip 265 of FIG. 24 and a chip 267 of FIG. 25, a pretreatment unit 266 is formed between the sample introduction unit 212 and the separation unit 213. Hereinafter, a case in which the detection unit 214 is provided as an analysis unit, in concrete, a case in which the detection unit 214 shown in FIG. 24 is provided will be described as an example.

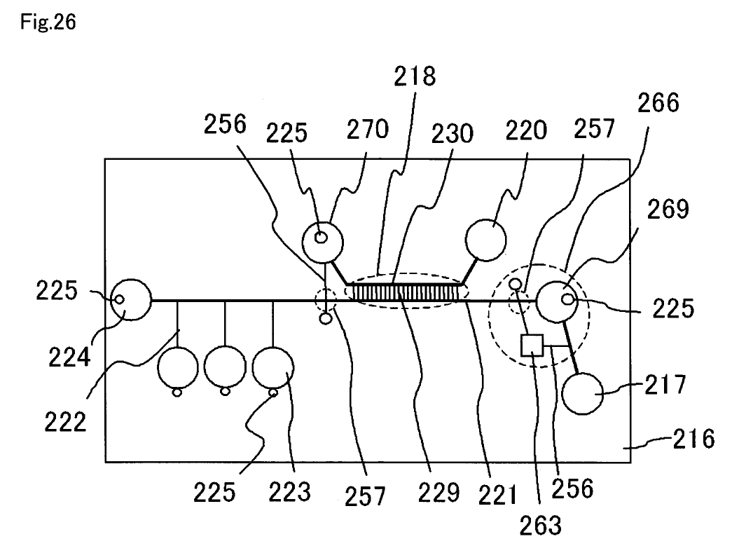

FIG. 26 is a diagram showing one example of the structure of a chip which can be used as the chip 265. In the chip 268 of FIG. 26, the pretreatment unit 266 is formed between the inlet 217 and the separation region 218. The pretreatment unit 266 includes a pretreatment reservoir 269 provided in the main channel 221, the liquid switch 257, and the trigger channel 256. The channel extended region 263 serving as a time-lag reservoir is formed in the trigger channel 256.

The pretreatment reservoir 269 is a reservoir for carrying out a predetermined pretreatment onto a sample introduced in the inlet 217. Although not illustrated, a pretreatment reagent such as enzyme or the like which is used for pretreatment is introduced in advance in the pretreatment reservoir 269.

A sample introduced in the inlet 217 flows in the pretreatment reservoir 269 from the main channel 221, and is mixed with the pretreatment reagent, and a pretreatment is carried out thereto. Because the liquid switch 257 is provided at downstream of the pretreatment reservoir 269, there is no case in which a liquid passing through the pretreatment reservoir 269 initially flows downstream side compared to liquid switch 257. The structure of the trigger channel 256 can be designed in accordance with a pretreatment time in the pretreatment reservoir 269. For example, when a pretreatment time is long, the channel extended region 263 can be made larger.

When the sample going forward in the trigger channel 256 reaches the liquid switch 257 from the main channel 221, the liquid switch 257 is opened due to the sample from the main channel 221 side and the sample from the trigger channel 256 side contacting each other. Then, the sample onto which the pretreatment has been carried out in the pretreatment reservoir 269 goes forward in the main channel 221, and after a predetermined separation operation is carried out thereto at the separation region 218, the sample is dispensed from the dispensing channels 222 into the detection reservoirs 223, and a predetermined detection reaction is carried out in the detection reservoirs 223.

As a pretreatment carried out in the pretreatment reservoir 269, for example, solubilization of insoluble components in the sample can be quoted. When the sample introduced in the inlet 217 is a living body sample, there are cases in which it is necessary to carry out solubilization of cells in the sample. In order to solubilize cells, it is necessary to solubilize the cell membrane and the cytoskeleton. Further, it is necessary to break the extracellular matrix in a case of animal cells, and it is necessary to break the cell walls in a case of plant cells. These pretreatments can be carried out by using the chip 268 having the pretreatment reservoir 269. Hereinafter, a case in which destruction of an extracellular matrix or cell walls is carried out as a pretreatment will be described as an example.

In the pretreatment reservoir 269, a solubilization enzyme is introduced in advance. For example, when a sample is saliva or nasal mucus, lysozyme chloride can be used as a solubilization enzyme. Further, when the sample is a tissue, for example, collagenase can be used. Further, when the sample is plant cells, for example, an enzyme which solubilizes cell walls such as cellulase or the like can be used. Note that incubating may be carried out at a predetermined temperature during the time processing in the pretreatment reservoir 269 is being carried out.

After the pretreatment is carried out for a predetermined time, the sample going forward in the main channel 221 is separated through the separation region 218 due to the liquid switch 257 being opened. Here, extra liquid around the cells are separated and removed at the separation region 218, which enables cleaning of the cells. When a buffer for separation, i.e., a buffer for cleaning in this case is introduced into the buffer inlet 220, the main channel 221 and the channel 230 are communicated with one another via the micro channels 229, and extra liquid components in the main channel 221 are removed. For example, a collagenase processing solvent, blood plasma, or the like are mixed with the buffer for cleaning to be extracted, and it is removed to the reservoir 270.

When the reservoir 270 is filled with the buffer for cleaning, the liquid goes into the trigger channel 256 communicated with the reservoir 270, and when this reaches the liquid switch 257, the liquid switch 257 is opened. When the liquid switch 257 is opened, the cells cleaned up in the main channel 221 are sequentially sorted into the dispensing channels 222 and the detection reservoirs 223 communicated therewith.

In accordance with this structure, in the pretreatment unit 266 formed between the inlet 217 and the separation region 218, it is possible to apply a predetermined pretreatment onto a sample. Therefore, separation and detection on the chip 268 can be executed under more favorable conditions. Note that an introduction of a reaction reagent into the pretreatment reservoir 269 may be carried out in advance at the time of preparing the chip 268, and may be carried out in a predetermined timing at the time of using the chip 268.

Note that a pretreatment carried out in the pretreatment reservoir 269 is not limited to solubilization processing, and may be various processings. For example, when components in a sample are DNA, a PCR reaction may be carried out in the pretreatment reservoir 269.

### Fifth Embodiment

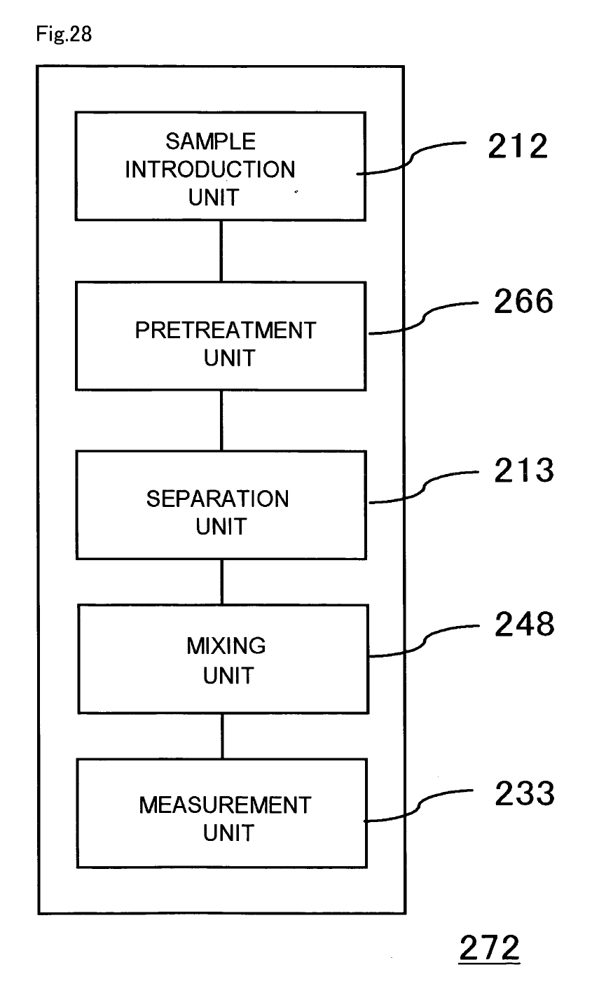

The present embodiment relates to a structure in which the mixing unit 248 is further provided between the separation unit 213 and an analysis unit (the detection unit 214 or the measurement unit 233) in the chip described in the fourth embodiment. FIG. 27 and FIG. 28 are functional block diagrams showing the structures of the chips relating to the present embodiment. In a chip 271 of FIG. 27, the mixing unit 248 is provided between the separation unit 213 and the analysis unit (the detection unit 214), and in a chip 272 of FIG. 28, the mixing unit 248 is provided between the separation unit 213 and the analysis unit (the measurement unit 233).

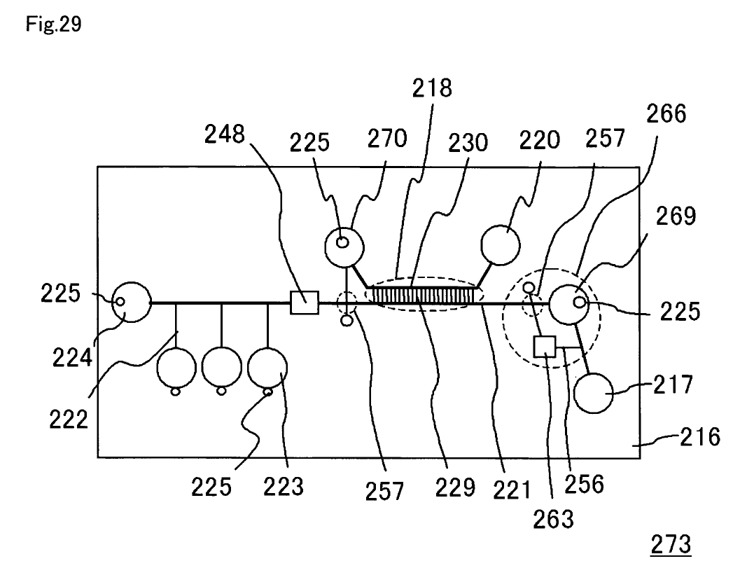

Here, the structure corresponding to the chip 271 shown in FIG. 27 will be described as an example. FIG. 29 is a diagram showing one example of the structure of a chip corresponding to the chip 271. In a chip 273 of FIG. 29, the mixing unit 248 is provided between the separation region 218 and the dispensing channels 222 in the chip 268 shown in FIG. 26. The structure of the mixing unit 248 may be, for example, the structure described in the third embodiment.

Provided that such a structure is used, after the concentration in the main channel 221 of a sample onto which pretreatment and separation have been carried out respectively in the pretreatment reservoir 269 and the separation region 218 is homogenized, and the sample can be sequentially made to flow into the respective dispensing channels 222. Therefore, even when there is a distribution in the sample concentration in the separation region 218, it is possible to average this, unevenness in the concentration of the sample components of the liquid introduced in the respective detection reservoirs 223 can be suppressed. Therefore, an accuracy of detection reaction in the detection reservoir 223 can be improved.

Note that the case in which a concentration distribution of one type of sample is decreased has been described above as an example. However, it may be structured such that a plurality of reservoirs are communicated with the mixing unit 248. In accordance therewith, the samples included in the respective reservoirs can be mixed up.

### Sixth Embodiment

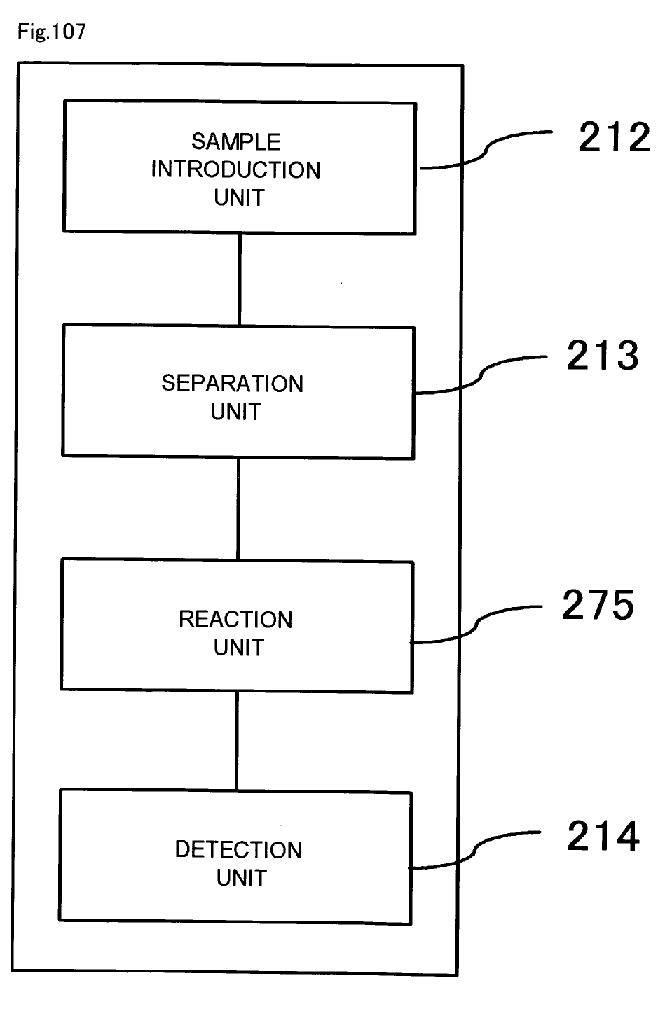

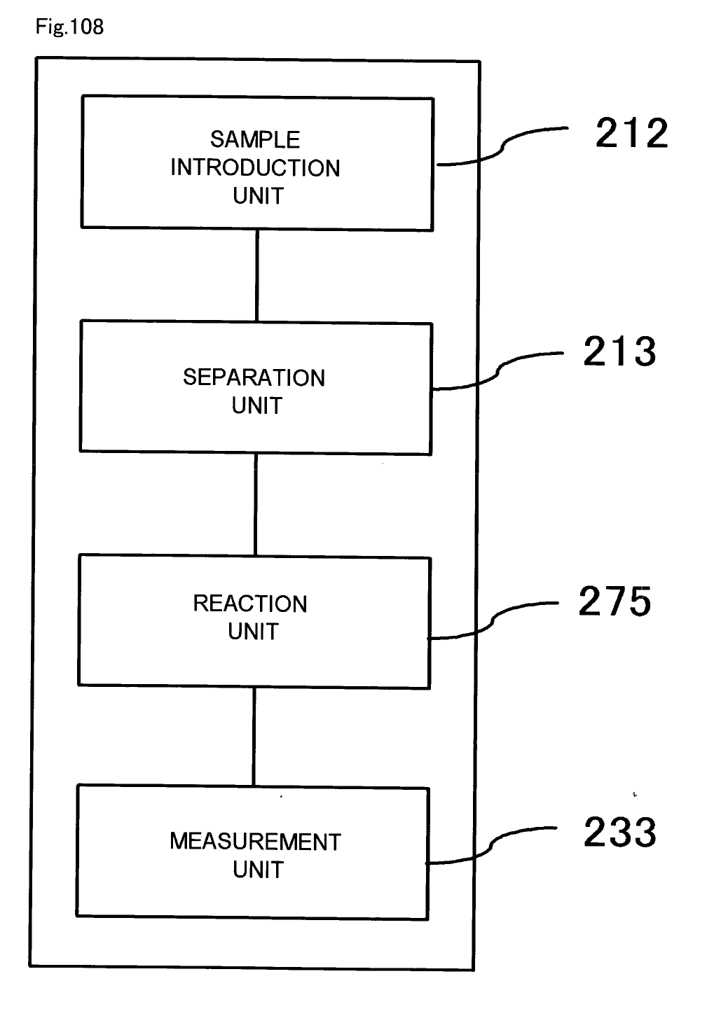

The present embodiment relates to a structure in which a reaction unit 275 is further provided between the separation unit 213 and an analysis unit (the detection unit 214 or the measurement unit 233) in the chip described in the above embodiments. FIG. 107 and FIG. 108 are functional block diagrams showing the structures of chips relating to the present embodiment. The chips shown in FIG. 107 and FIG. 108 respectively have the basic structures described in the first and second embodiments, and the reaction unit 275 is respectively provided between the separation unit 213 and the analysis unit (the detection unit 214), and between the separation unit 213 and the analysis unit (the measurement unit 233).

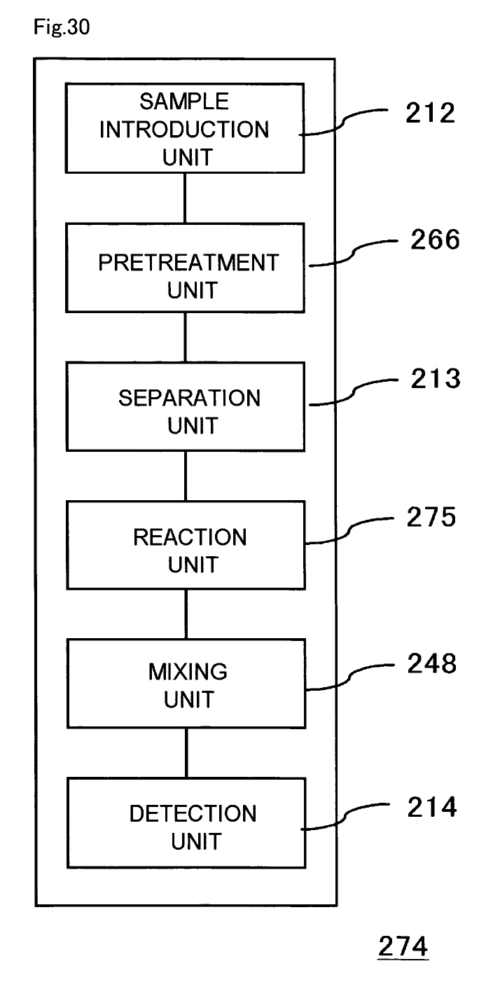

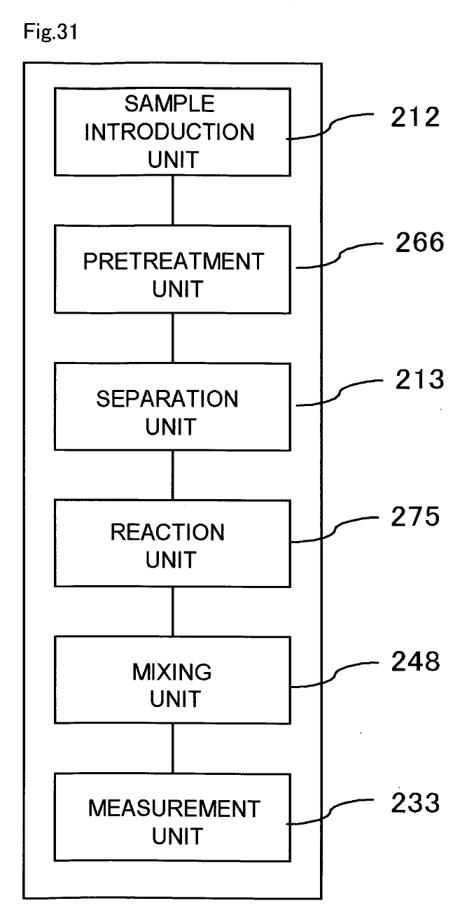

Further, FIG. 30 and FIG. 31 are functional block diagrams showing other structures of the chips relating to the present embodiment. In FIG. 30 and FIG. 31, the detection unit 214 and the measurement unit 233 are respectively provided as an analysis unit. In both of a chip 274 of FIG. 30 and a chip 276 of FIG. 31, the reaction unit 275 is provided between the separation unit 213 and the mixing unit 248.

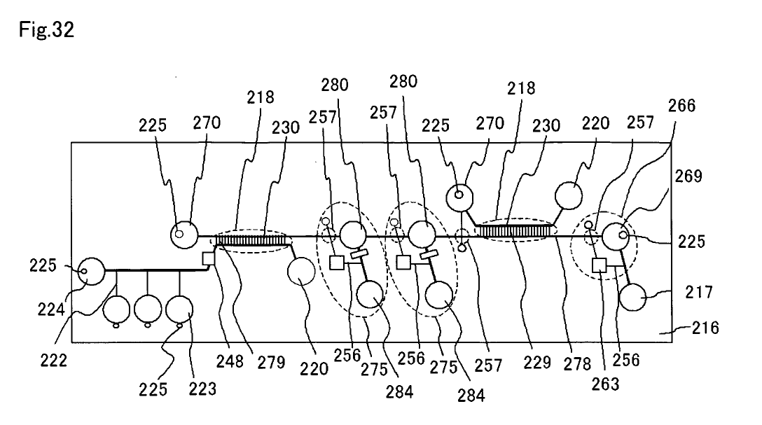

Here, the structure corresponding to the chip 274 will be described as an example. FIG. 32 is a diagram showing one example of the structure of a chip corresponding to the chip 274. In a chip 277 of FIG. 32, the reaction unit 275 is provided following the pretreatment unit 266 and the separation region 218 in the chip 268 shown in FIG. 29. Moreover, the separation region 218 and the mixing unit 248 are provided at downstream of the reaction unit 275, and the dispensing channels 222 and the detection reservoirs 223 are formed in downstream thereof. Further, in the chip 277, a first main channel 278 communicated with the inlet 217 and a second main channel 279 communicated with the dispensing channels 222 are formed. The first main channel 278 and the second main channel 279 are communicated with one another via the separation region 218 formed in downstream of the reaction units 275.

The reaction unit 275 includes a reaction reservoir 280 provided in the first main channel 278, a reservoir 284 communicated with the second main channel 279, the liquid switch 257, and the trigger channel 256. The inside of the trigger channel 256 is communicated with the reservoir 284 and the first main channel 278, and has the channel extended region 263 serving as a time-lag reservoir.

The reaction reservoir 280 is a reservoir for carrying out a predetermined pretreatment onto samples separated at the separation region 218. Although not illustrated, a reaction reagent such as an enzyme or the like which is used for reaction may be introduced in advance at the reaction reservoir 280. Further, it may be a form in which a reaction reagent is introduced in the reaction reservoir 280 in a predetermined timing. Further, a reaction reagent is introduced in advance in the reservoir 284, and may be moved to the reaction reservoir 280 at a predetermined timing.

Further, a reaction reagent is introduced in advance in the reservoir 284, and may be moved to the reaction reservoir 280 at a predetermined timing. In this case, the sample separated at the separation region 218 flow into the reaction reservoir 280, and is mixed up with the reaction reagent introduced in the reservoir 284, and is provided for a predetermined reaction. Because the liquid switch 257 is provided at downstream of the reaction reservoir 280, there is no case in which the liquid initially passing through the reaction reservoir 280 flows downstream side compared to the liquid switch 257. The structure of the trigger channel 256 can be designed in accordance with a pretreatment time in the reaction reservoir 280. For example, when a pretreatment time is long, the channel extended region 263 can be made larger.

When the reaction reagent going forward in the trigger channel 256 reaches the liquid switch 257 from the reservoir 284, the liquid switch 257 is opened due to the sample from the first main channel 278 side and the sample from the trigger channel 256 side contacting each other. Then, the sample onto which the pretreatment has been carried out in the reaction reservoir 280 goes forward in the first main channel 278, and a predetermined separation operation is carried out through the separation region 218.

The structure of the separation region 218 can be made to be, in the same way as in the above embodiments, for example, as illustrated, a structure in which the first main channel 278 and the second main channel 279 are communicated with one another via the micro channels 229. In accordance therewith, only components having a predetermined size or shape in the reacted sample in the first main channel 278 can move into the second main channel 279. Therefore, only predetermined components can be separated from the reacted sample. After homogenization of the concentration is carried out in the mixing unit 248 with respect to the sample which has been separated through the separation region 218 and has reached the second main channel 279, the sample is dispensed from the dispensing channels 222 to the detection reservoirs 223, and a predetermined detection reaction is carried out in the detection reservoirs 223.

As a reaction carried out in the reaction reservoir 280, a solubilization reaction of the cell membrane or the cytoskeleton can be quoted. In this case, as shown in the fourth embodiment, it is possible to carry out destruction of an extracellular matrix or components of cell walls in advance of the solubilization of the cell membrane or the cytoskeleton in the pretreatment reservoir 269. Then, with respect to the cells in the sample from which extra liquid components have been separated and removed through the separation region 218, processings of the solubilization of a cell membrane and the solubilization of a cytoskeleton can be sequentially carried out in the two reaction reservoirs 280 provided on the first main channel 278.

Then, in this case, a surface active agent and a lipase for cell membrane i.e., lipid membrane are introduced as reaction reagents into the reservoir 284 communicated with the reaction reservoir 280 at the upstream side among the two reaction reservoirs 280. In accordance therewith, the sample introduced in the reaction reservoir 280 is mixed with these reaction reagents, and the cell membranes are solubilized.

The sample in which the cell membranes have been solubilized goes forward in the first main channel 278 by extra reaction reagents in the reservoir 284 communicated with the reaction reservoir 280 at the upstream side, and is reserved in the reaction reservoir 280 at the downstream side. In the reaction reservoir 280 at the downstream side, solubilization of a cytoskeleton is carried out. In the reservoir 284 communicated with the reaction reservoir 280 at the downstream side, for example, potassium acetate of 450 mM, Tris-HCl (pH8.5) of 200 mM, MgOAc2 of 250 mM, ATP of 0.5 mM, and a buffer including PTE of 2% are introduced as reaction reagents. When these reaction reagents are introduced in the reaction reservoir 280, solubilization reactions are caused in the reaction reservoir 280.

After the respective reactions are carried out for predetermined time in this way, due to the liquid switch 257 provided at downstream of the reaction reservoir 280 at downstream side being opened, the reacted sample further goes forward in the first main channel 278. The sample is further separated through the separation region 218 formed in downstream of the reaction reservoir 280. Therefore, insoluble components which have not been solubilized even by the series of reactions described above can be removed through the separation region 218 formed downstream of the reaction reservoir 280.

In accordance with this structure, in the reaction reservoirs 280 formed between the separation region 218 and the detection reservoir 223, it is possible to apply a predetermined reaction processing onto the sample. Therefore, detection of components in the sample can be executed under more favorable conditions. Note that an introduction of a reaction reagent into the reaction reservoir 280 or the reservoir 284 may be carried out in advance at the time of preparing the chip 277, or may be carried out in a predetermined timing at the time of using the chip 277.

Note that the structure having the reaction units 275 can be applied to the embodiments described above other than the fourth embodiment. In the chips described in the other embodiments as well, the reaction unit 275 can be provided, for example, between the separation unit 213 and the detection unit 214, between the separation unit 213 and the mixing unit 248, between the separation unit 213 and the measurement unit 233, or between the separation unit 213 and the mixing unit 248. In accordance therewith, after predetermined components in the sample introduced in the sample introduction unit 212 are separated, those can be provided for various reactions in advance of detection or measurement. Therefore, more various detections or measurements can be stably executed with a simple structure.

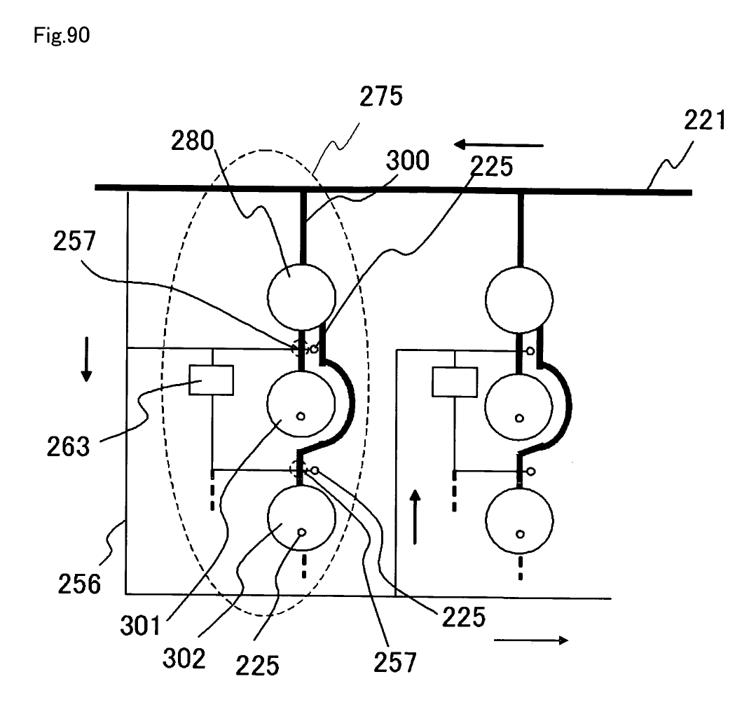

Moreover, the reaction unit 275 may be a structure shown in FIG. 90. In the reaction unit shown in FIG. 90, two reaction units 275 communicated with the main channel 221 are formed. The reaction unit 275 has a channel 300, the reaction reservoir 280 communicated with the channel 300, a reagent reservoir 301 and a reagent reservoir 302 which are communicated with the reaction reservoir 280, the liquid switch 257 provided between the reaction reservoir 280 and the reagent reservoir 301, and the liquid switch 257 provided between the reaction reservoir 280 and the reagent reservoir 302. These two liquid switches 257 are communicated with one another via the channel extended region 263. Further, the two liquid switches 257 are communicated with the main channel 221 via the trigger channel 256 as well.

In the structure of FIG. 90, when a sample flows into the main channel 221, the sample is filled up the reaction reservoirs 280 from the channel 300. Here, the two reaction reservoirs 280 are sequentially filled up. The sample goes forward in the main channel 221 even after filling up the reaction reservoirs 280, and some of the sample detours to the trigger channel 256. The sample flowing in the trigger channel 256 first opens the liquid switch 257 between the reaction reservoir 280 and the reagent reservoir 301. Then, the reagent retained in the reagent reservoir 301 moves to the reaction reservoir 280, and is mixed with the sample. In this way, a first reaction is carried out in the reaction reservoir 280.

Further, some of the sample flowing in the trigger channel 256 opens the liquid switch 257 formed between the reagent reservoir 302 and the reaction reservoir 280 in a predetermined timing after a time-lag is brought about in the channel extended region 263. Then, because the reagent retained in the reagent reservoir 302 further moves to the reaction reservoir 280, the following reaction is carried out in the reaction reservoir 280.

In this structure, a structure is realized in which the reaction reservoir 280 is communicated with a plurality of the reagent reservoirs via the liquid switches 257, and the respective liquid switches 257 are sequentially opened. Therefore, it is possible to execute multistep reactions in predetermined timings with the structure of the chip itself.

By using such a reaction unit, multistep reaction processings can be applied to the separated liquid samples. Therefore, measurement of the concentration of insulin, judgment for a prevalence rate to an infectious disease, or the like, which has been hard to carry out by a conventional device structure are possible. Further, because it is possible to sequentially execute mixing with reagents and cleaning, and be applied to an enzyme antibody technique.

### Seventh Embodiment

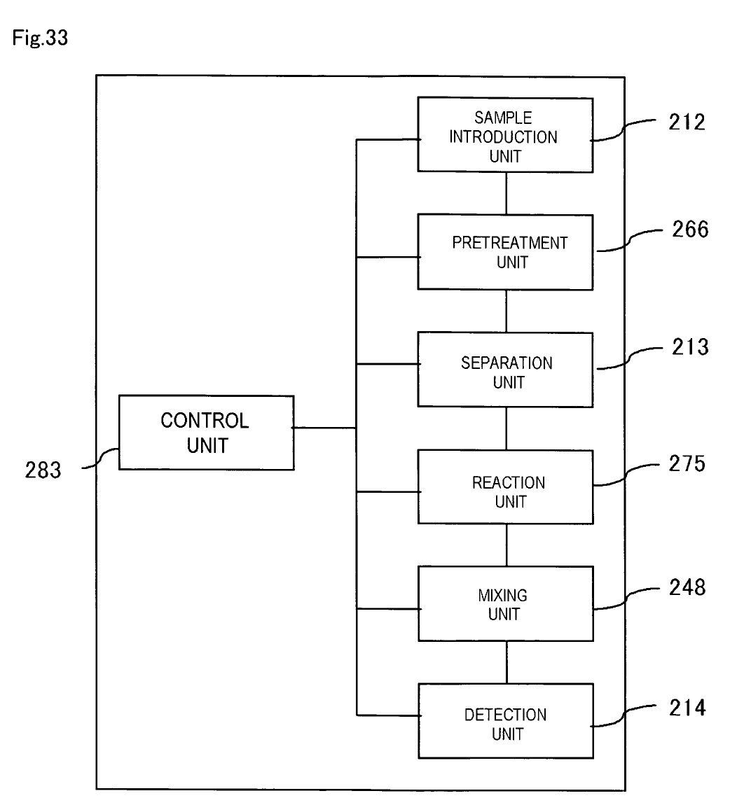

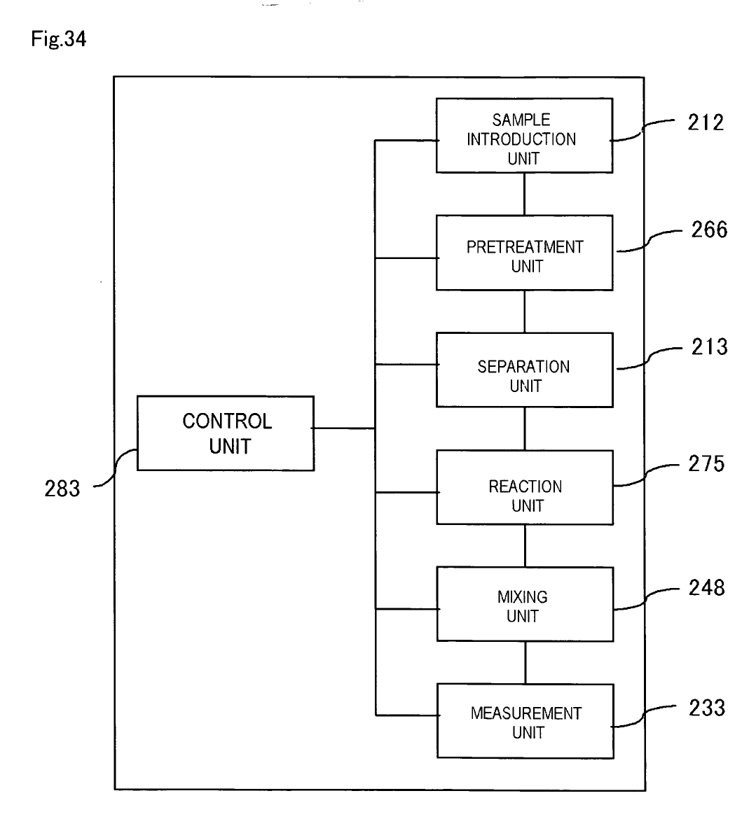

In the chips relating to the embodiments described above, a control unit may be further provided. Hereinafter, a structure in which a control unit is further provided to a chip having the functions described in the sixth embodiment will be described as an example. FIG. 33 and FIG. 34 are functional block diagrams showing structures of chips relating to the present embodiment. A control unit 283 which controls the respective processing conditions in the sample introduction unit 212, the pretreatment unit 266, the separation unit 213, the reaction unit 275, the mixing unit 248, and the analysis unit (the detection unit 214 or the measurement unit 233) is provided in a chip 281 shown in FIG. 33 and a chip 282 shown in FIG. 34.

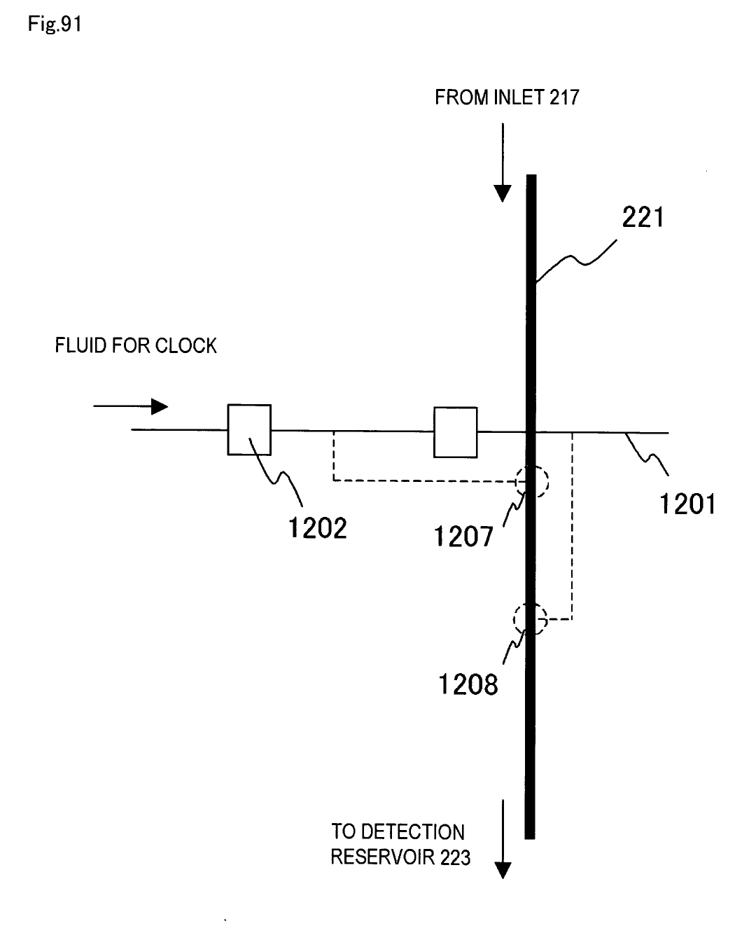

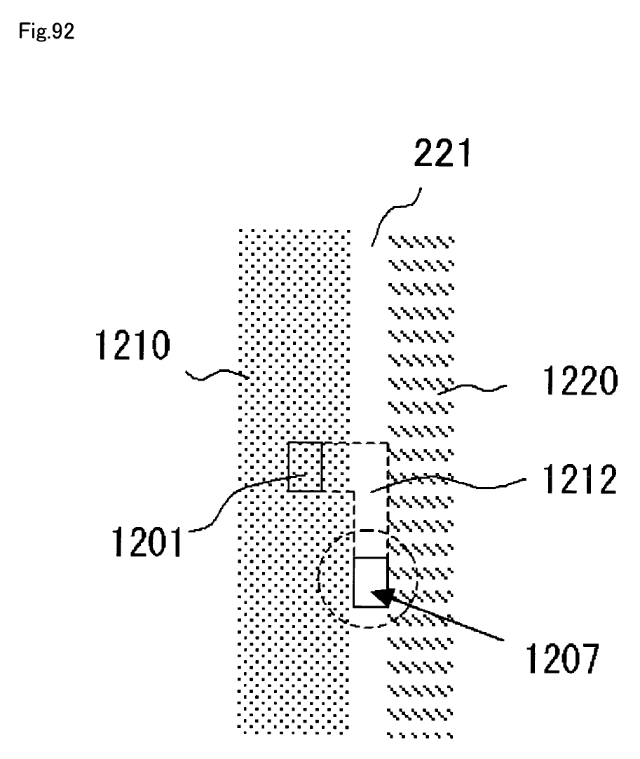

As an example of a chip having the control unit 283, a structure in which a clock line is provided, and a movement of a sample in the channel on the chip is controlled based on the clock line can be quoted. FIG. 91 is a top view showing a structure of a chip in which a clock line is provided. In the chip of FIG. 91, a clock channel 1201 is provided in a direction perpendicular to the main channel 221 through which a sample passes. Those are formed in multilayer channel structure as shown in FIG. 92. FIG. 92 is a cross-sectional view of the chip of FIG. 91. This chip has a structure in which a main channel substrate 1220 and a clock channel substrate 1210 are stacked on one another. The main channel 221 is formed on the surface of the main channel substrate 1220, and the clock channel 1201 is formed on the surface of the clock channel substrate 1210. These channels are connected through a controlling channel 1212. A switch 1207 is provided at the main channel 221.

To be back to FIG. 91, the liquid in the main channel 221 cannot move to the downstream side of the switch 1207 until the switch 1207 is opened, and is dammed up. After the flow of a fluid for clock introduced in the clock channel 1201 is controlled by a time-lag chamber 1202, and the fluid for clock reaches the switch 1207 via the controlling channel 1212. Then, the switch 1207 is made to be in an open-state, and the liquid in the main channel 221 moves to downstream side.

Thereafter, the fluid for clock moves to the downstream side of the clock channel 1201, and reaches a switch 1208 after passing through another time-lag chamber. In this way, due to the switches being sequentially opened with the fluid for clock serving as a trigger liquid, predetermined processing can be applied onto the sample passing through the main channel 221 for a predetermined time.

With respect to the flow of the fluid for clock in the clock channel 1201, a time required for reaching an arbitrary position in the channel is precisely reproduced. Therefore, it is possible to execute arbitrary processing on the chip with satisfactory time controllability by utilizing the clock channel.

Further, the control unit 283 may be the following structures. Here, the chip 251 of FIG. 8 will be described as an example. In the chip 251, it is important to control the following (i) and (ii) timings.

(i) a timing in which a buffer is made to flow from the buffer inlet 220 to the main channel 221, and

(ii) a timing in which a sample whose component concentration has been homogenized in the mixing unit 248 is made to flow to the dispensing channels 222.

Then, in order to control these timings, the following (I) to (IV) may be provided on the chip 251.

(I) A sensor sensing that a sample has reached the Inside of the waste reservoir 219 with reference to the continuity of an electrode couple,

(II) a liquid switch using a magnet for controlling flowing-out of a buffer from the buffer inlet 220,

(III) a sensor having an electrode couple which detects that a solution has reached the mixing unit 248 when the mixing unit 248 is, for example, the structure having an entrance channel shown in FIG. 19, and

(IV) a liquid switch using a magnet for controlling the advance of a liquid at the outlet of the entrance channel.

By providing the above-described (I) to (IV) to the chip 215, and due to a stage for control at which a magnet which is connected so as to be movable to a solenoid or the like under the liquid switch portion of the chip 251 being used, it is possible to certainly control the above-described (i) and (ii) timings.

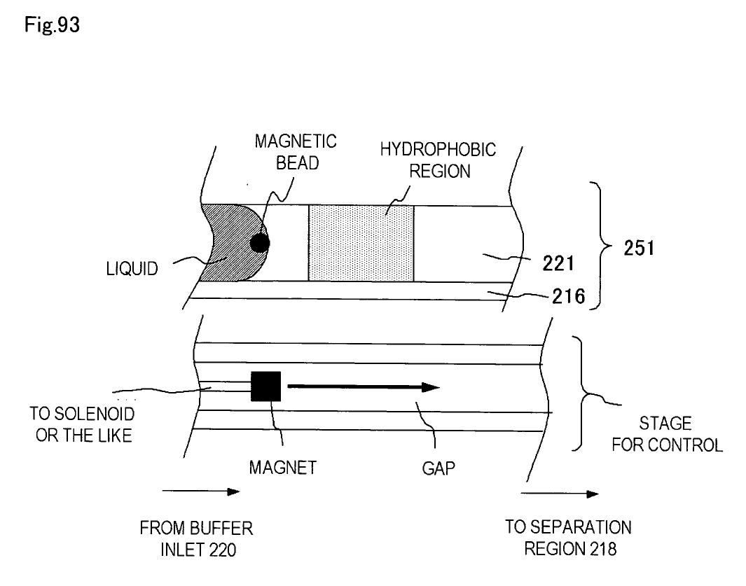

FIG. 93 is a cross-sectional view schematically showing a structure of the liquid switch having a magnet provided on the chip 251, and a structure of a stage which controls a movement of the magnet. In FIG. 93, a hydrophobic region is provided at a part of the main channel 221, and a magnetic bead is introduced in advance at the buffer inlet 220 side compared to the hydrophobic region. The hydrophobic region and the magnetic bead can be used as liquid switches.

The operation of the chip 251 is as follows. Namely, first the chip 251 is provided on the stage for control. Then, it is sensed what a sample has reached the inside of the waste reservoir 219 with reference to the continuity of the electrode couple. The magnet positioned at the buffer inlet 220 side compared to the hydrophobic region is moved in the hydrophobic region along the channel at the timing that the sample has reached the inside of the waste reservoir 219. Then, the magnetic bead moves in the main channel 221, and crosses the hydrophobic region. At this time, the liquid dammed directly before the main channel 221 moves along with the magnetic bead, and the switch is opened.

When the switch is opened, predetermined separation is carried out at the separation region 218. The separated sample moves toward the mixing unit 248. Then, it is detected by using the electrode couple that the solution has reached the mixing unit 248. The magnet directly beneath the stage for control is moved at the timing that the sample has reached the mixing unit 248, and the liquid switch provided on the entrance channel is opened. Then, the sample homogenized in the mixing unit 248 is dispensed into the dispensing channels 222.

In this way, by providing the control unit 283, for example, cleaning operations or the like with respect to the respective functional blocks can be controlled to carry out. Therefore, at the time of reusing the chip 281 or the chip 282, contamination of the surface of the substrate 216 is suppressed, and a series of operations on the chip can be certainly carried out.

### Eighth Embodiment

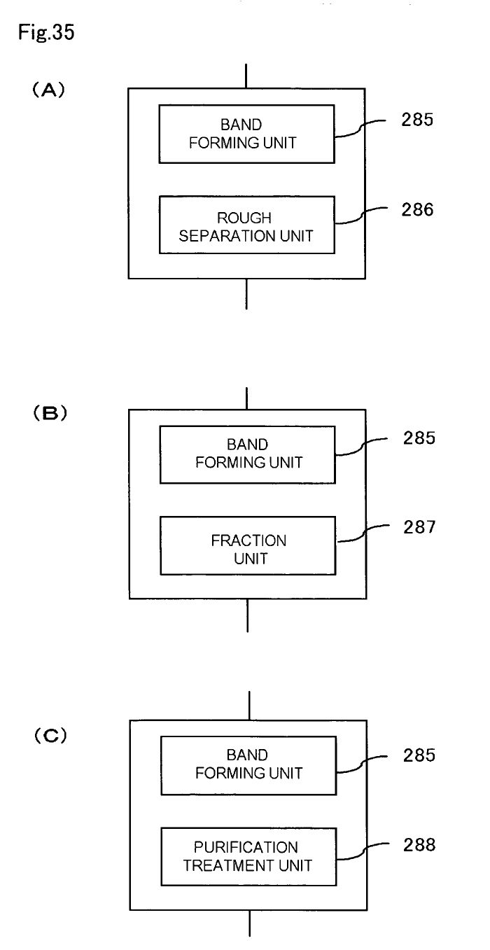

In the chips described in the above embodiments, the structure of the separation unit 213 may be as follows. FIG. 35(A) to FIG. 35(C) are functional block diagrams for explanation of the separation unit 213 more in detail. The separation units 213 shown in FIG. 35(A) to FIG. 35(C) respectively have a rough separation unit 286, a fraction unit 287, and a purification treatment unit 288. Therefore, in the respective separation units 213, rough separation, fraction, and purification treatment can be carried out. Further, in the separation units 213 shown in FIG. 35(A), FIG. 35(B) and FIG. 35(C), a band forming unit 285 is provided at upstream of the rough separation unit 286, the fraction unit 287, or the purification treatment unit 288.

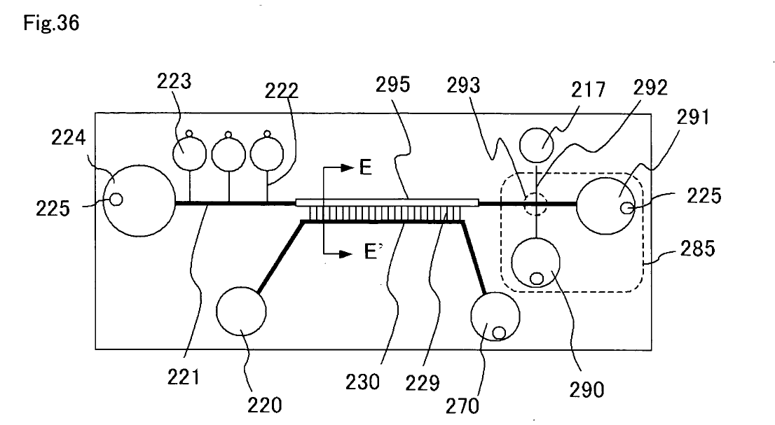

As a structure which can be used as the rough separation unit 286 or the purification treatment unit 288, for example, the separation region 218 provided in the chip 215 described in the above embodiments can be quoted. Further, as a structure which can be used for rough separation, fraction, and purificating of components in a sample, for example, a structure shown in FIG. 36 can be quoted.

FIG. 36 is a diagram schematically showing one example of the structure of the chip relating to the present embodiment. In a chip 289 shown in FIG. 36, the band forming unit 285 is formed between the inlet 217 and a separation region 295. The band forming unit 285 has a band forming channel 292 communicated with the inlet 217, a reservoir 290 communicated with the band forming channel 292, a developing buffer reservoir 291 communicated with the main channel 221, and the liquid switch 257 provided at the cross point between the main channel 221 and the band forming channel 292.

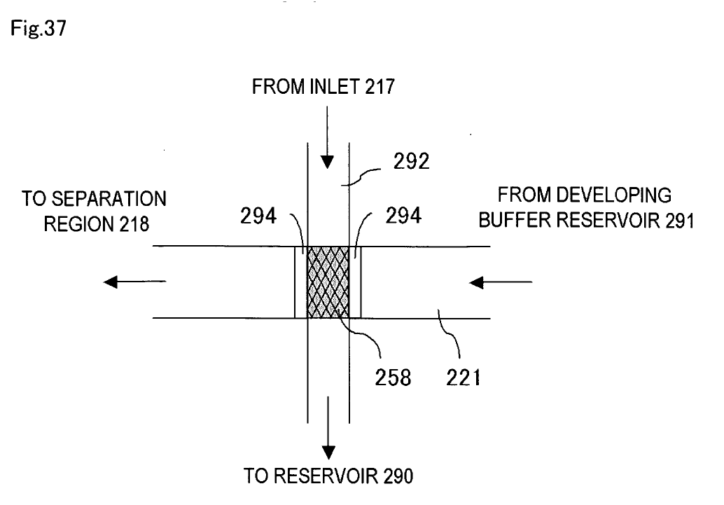

Further, FIG. 37 is an enlarged view of a band forming liquid switch 293 of FIG. 36. In the band forming liquid switch 293, the damming portion 258 is formed at the cross point between the main channel 221 and the band forming channel 292. The structure of the damming portion 258 may be, for example, the structure shown as an example in the third embodiment. Further, in the main channel 221, gaps 294 are formed at the both sides of the damming portion 258. The gaps 294 may be, for example, regions that hydrophobic processing has been carried out onto the surface of the main channel 221.

When the chip 289 having the band forming liquid switch 293 as described above is used, first, a developing buffer which develops a sample is introduced into the developing buffer reservoir 291. The developing buffer cannot go to the downstream side compared to the gaps 294 due to the gaps 294 formed at the main channel 221. However, when a sample is introduced into the inlet 217, the sample rapidly flows into the damming portion 258 by a capillary force, and is retained in the damming portion 258. When the sample is retained in the damming portion 258, some of the sample is extruded to the gaps 294 formed at the both sides thereof. Then, the developing buffer dammed up directly before the gaps 294 and the extruded liquid are connected, and the developing buffer moves in the main channel 221. At that time, the sample retained so as to have a width of the band forming channel 292 in the main channel 221 flows along with the developing buffer, and is guided to the separation region 295.

By providing the band forming liquid switch 293, the sample introduced in the inlet 217 can be moved in the main channel 221 after making the band width thereof narrow. Therefore, the separation efficiency of the sample can be improved.

The separation region 295 is formed in the main channel 221. As a structure of the separation region 295, for example, the followings can be quoted:

(A) a structure in which a plurality of columnar bodies are provided,

(B) a structure in which a plurality of concave portions are provided, and

(C) a structure in which hydrophobic patches are provided. The concrete structures from (A) to (C) will be sequentially described in ninth to eleventh embodiments.

The sample in the main channel 221 is separated through the separation region 295, and the respective components are distributed to different positions on the separation region 295. Many small holes are provided at the side walls of the separation region 295, and the separation region 295 is communicated with the channel 230 through the small holes serving as the micro channel 229. Because the surface of the micro channels 229 is weakly hydrophobic, there is no case in which a liquid initially moves from the micro channels 229 to the channel 230.

When the development in the separation region 295 is completed, a liquid including a coloring reagent is introduced into the reservoir 284. When the coloring reagent moves in the channel 230, the both are communicated with one another due to the liquid being extruded into the micro channels 229 from the main channel 221 and the channel 230. Then, the components in the main channel 221 and the components in the channel 230 are mutually diffused. Here, the traveling speed of the coloring reagent going forward in the channel 230 is sufficiently fast for being developed over the entire area on the separation region 295.

Because the coloring reagent developed on the separation region 295 colors in accordance with the components developed on the main channel 221, shading patterns of coloring are formed on the separation region 295. Then, these patterns can be sequentially sorted into the detection reservoirs 223. Note that analysis may be carried out by providing the shading patterns formed on the separation region 295 for an image analysis.

Such a structure can be utilized for, for example, analysis of an LDH isozyme group. The LDH isozyme group introduced in the inlet 217 is developed on the separation region 295 in accordance with a molecular weight thereof. Therefore, the shading patterns reflect some measure in the quantity of the isozyme group. For example, when a position of the LDH due to myocardium is dyed darker than the other region, there is a possibility of a myocardial disease.

As described above, because separation efficiency can be improved by using the structure of the chip 289, an accuracy and a sensitivity in an analysis of components in a sample can be improved. Note that the chip 289 having the detection unit 214 has been described above as an example. However, the structure of the separation unit 213 relating to the present embodiment can be applied to a chip having the measurement unit 233 as well.

Note that the separation region 295 may be structured such that particulates are filled in the main channel 221. At that time, among the components in the sample, the higher affinity with a buffer introduced in the buffer inlet 220 is, the more rapidly the components move. And the components are developed in accordance with an affinity of components in the sample. As particulates to be filled into the main channel 221, a material used as an adsorbing agent in a TLC (thin-layer chromatography), or the like can be used. Concretely, for example, silica gel, alumina, cellulose, or the like is used, and a particle diameter thereof may be made to be, for example, 5 to 40 nm. For example, when silica gel is used as particulates, filling of silica gel fine particles into the separation region 295 can be carried out such that, after a damming member is formed downstream of the main channel 221, a mixture of silica gel fine particles, binder, and water is made to flow into the channel, and thereafter, this mixture is dried to become solidified.

### Ninth Embodiment

In the present embodiment, (A) A structure in which a plurality of columnar bodies are provided in the eighth embodiment will be described concretely.

In this structure, a plurality of columnar bodies are provided in the separation region 295. The columnar bodies can be formed, for example, by etching the substrate so as to be a predetermined pattern shape. However, there is no limit in particular to the manufacturing method.

The shapes of the columnar bodies include various shapes such as stripe-form protrusions or the like, in addition to pseudo-cylindrical shapes such as a cylinder, an elliptic cylinder, or the like; conical shapes such as a circular cone, an elliptic cone, a triangular pyramid, or the like; square columns such as a triangular pole, a square pole, or the like. As the sizes of the columnar bodies, the width can be made to be, for example, about 10 nm to 1 mm, and the height can be made to be, for example, about 10 nm to 1 mm.

An interval between adjacent columnar bodies is appropriately set in accordance with a separation purpose. For example, in processings such as

(i) separation and condensation of cells and other components,

(ii) separation and condensation of solid bodies (pieces of cell membrane, mitochondria, endoplasmic reticulum) and liquid fraction (cytoplasm) among contents obtained by destructing cells, and

(iii) separation and condensation of high-molecular-weight components (DNA, RNA, protein, sugar chain) and low-molecular-weight components (steroid, glucose, or the like) among components of liquid fraction,

in a case of (i), the interval can be made to be 1 μm to 1 mm,

in a case of (ii), the interval can be made to be 100 nm to 10 μm, and

in a case of (iii), the interval can be made to be 1 nm to 1 μm.

Further, one or two, or more columnar body disposition units can be provided in the separation region 295. The columnar body disposition units include columnar body groups. The columnar body groups in the respective columnar body disposition units can be arbitrarily disposed in different sizes and at different intervals. Further, the columnar bodies may be regularly formed in a same size at substantially even intervals.

A path through which a sample can pass is formed at an interval between adjacent columnar body disposition units. Here, when an interval between columnar body disposition units is made larger than an interval between columnar bodies, because molecules in a giant size or the like can be smoothly moved, the separation efficiency can be further improved.

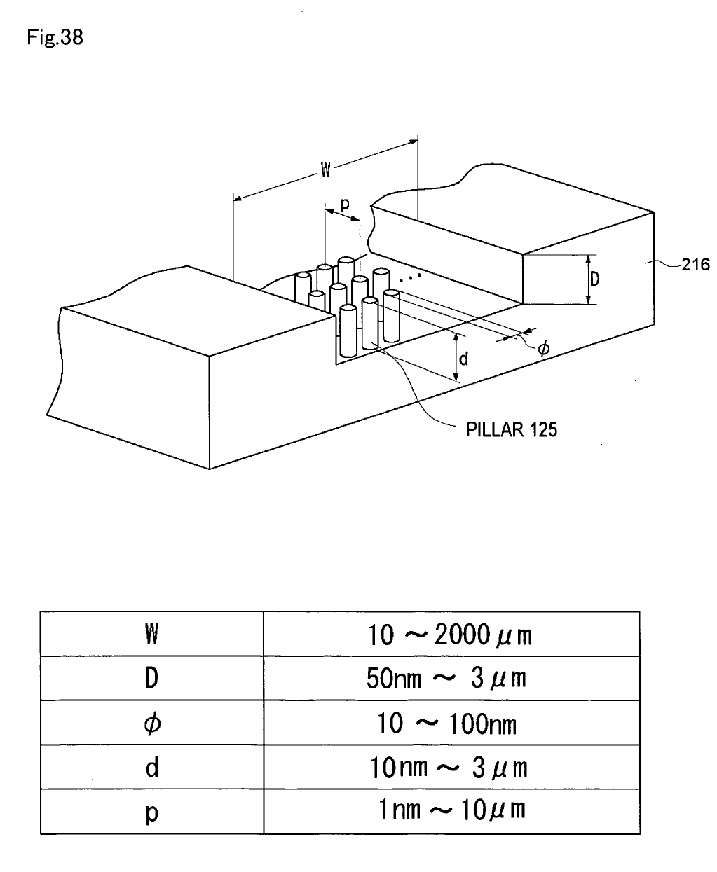

FIG. 38 shows the structure of the separation region 295 in FIG. 36 in detail. Note that the structure shown in FIG. 38 can be applied to the drawings on and after FIG. 38. In FIG. 38, a groove portion of width W and depth D is formed on the substrate 216, and cylindrical pillars 125 of diameter φ and height D are regularly formed at even intervals. A sample transmits the intervals among the pillars 125. An average interval among adjacent pillars 125 is p. The respective dimensions can be made to be, for example, within the ranges shown in FIG. 6.

Note that, in the embodiments in this specification, “pillar” is shown as one type of a columnar body, and means a minute columnar body having a type of cylinder or elliptic cylinder. Further, “pillar patch” and “patch region” are shown as one shape of a columnar body disposition portion, and mean a region at which many pillars are formed in a group.

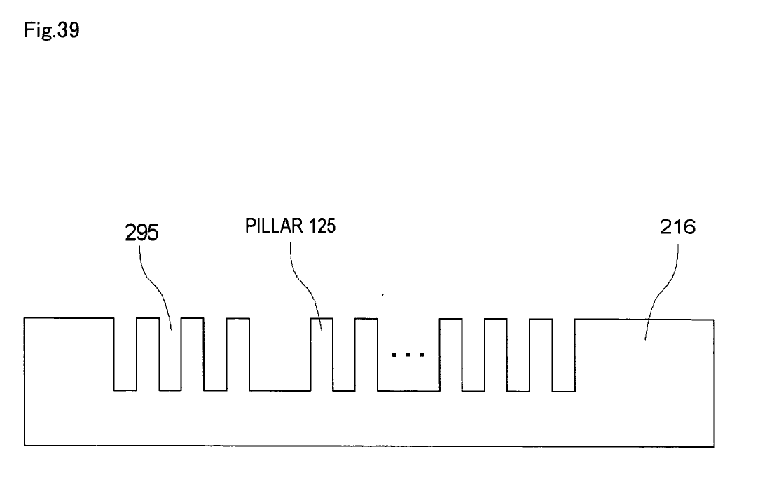

FIG. 39 is a cross-sectional view of the separation region 295 of FIG. 36. Many pillars 125 are formed in the space formed by the groove portion formed on the substrate 216. The intervals among the pillars 125 serve as a channel for separation.

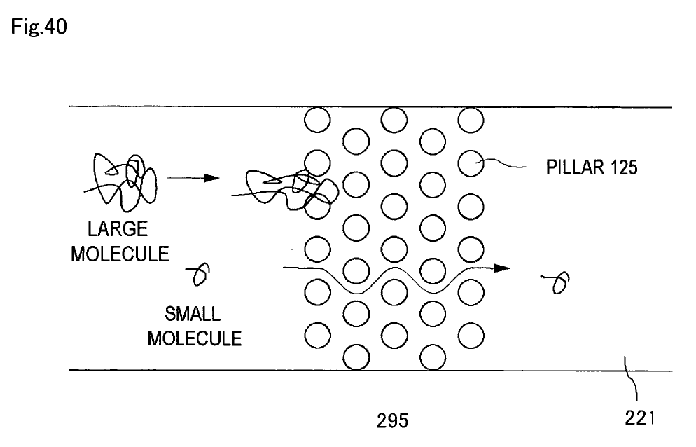

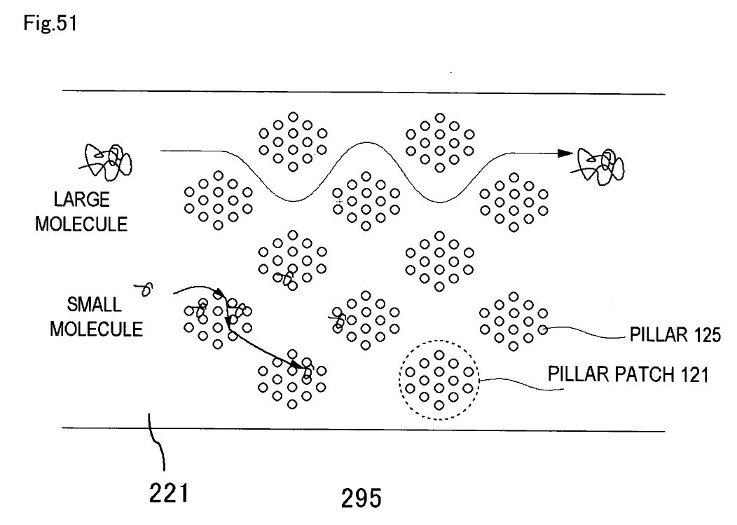

When a structure in which many pillars 125 are densely formed is used as sample separating means, two separation systems can be mainly conceived. One system is a separation system shown in FIG. 40. The other system will be described later with reference to FIG. 51. In the system of FIG. 40, the larger the molecular size is, the more obstructive the pillars 125 are, and a time for passing through the separation region 295 in the drawing is made longer. A sample which has a smaller molecular size relatively smoothly passes through the intervals among the pillars 125, and passes through in a short time as compared with a sample which has a larger molecular size.

A plurality of components in a sample can be certainly separated by using the pillars 125.

Further, the example in which the columnar bodies are provided at even intervals has been shown above. However, the columnar bodies may be provided at different intervals in the columnar body disposition units. In accordance therewith, molecules or ions in a plurality of sizes of large, medium, small, or the like can be more efficiently separated. Further, with respect to the layout of the columnar bodies, it is effective to use a method of disposing the columnar bodies alternately in a traveling direction of a sample. In accordance therewith, target components can be efficiently separated while effectively preventing clogging.

Further, the columnar bodies provided in the separation region 295 preferably have a shape in which the diameter of the top thereof is smaller than the diameter of the bottom. Namely the columnar bodies preferably has a conical shape or puesdo-conical shape and cross-section thereof is preferably broaden toward the end. Particularly in a case where a hydrophilic film such as a silicon oxide film or the like is formed on the surface of the columnar bodies, an effect due to such a shape will be notable. For example, when an attempt is made to provide a thermally-oxidized film on the surfaces thereof by thermally oxidizing the columnar bodies, in some cases, oxidization is made to progress in the vicinity of the bottoms of the columnar bodies, and the heights of the columnar bodies are decreased, and the aspect ratio thereof is reduced. Provided that the shapes of the columnar bodies are formed as described above, such a reduction in an aspect ratio due to oxidization can be effectively prevented.

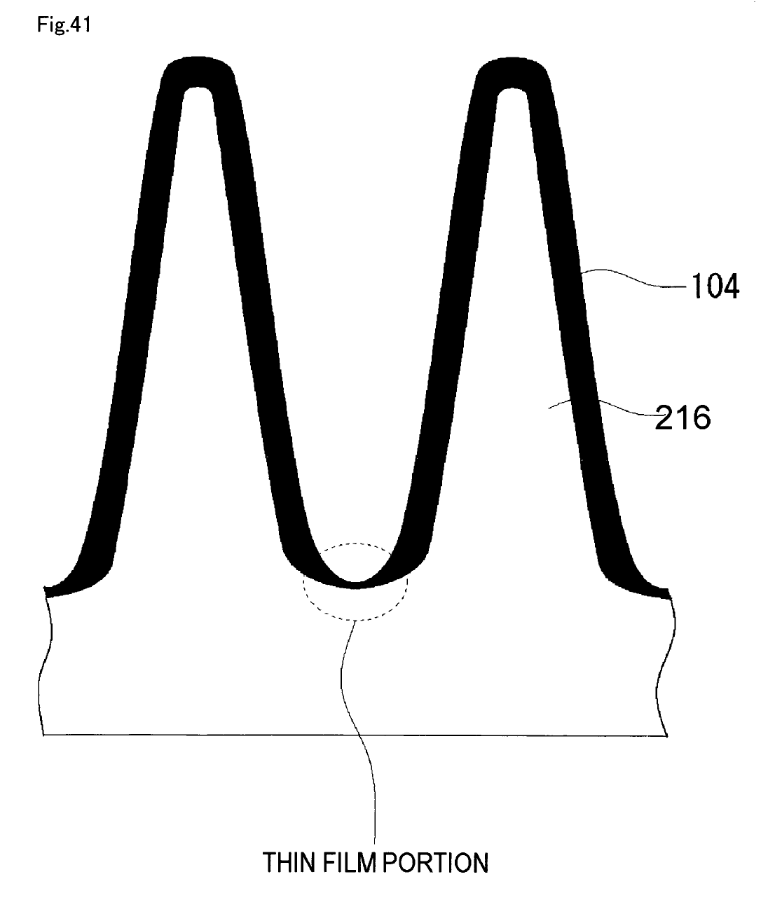

Further, on the assumption that the above-described shape is used as a shape of a columnar body, it is preferable for the columnar bodies provided in the sample separation region to be formed so as to be close to one another to an extent that the side faces of adjacent columnar bodies are in contact with one another at the bottoms of the columnar bodies. In accordance therewith, a reduction in an aspect ratio due to oxidization can be more effectively prevented. FIG. 41 is one example of the columnar bodies using such a structure. In a nano-structure shown in FIG. 41, conical columnar bodies are provided on the surface of the substrate 216, and the surface thereof is covered with a silicon oxide film 104. The columnar bodies are formed so as to be close to one another to an extent that the side faces of the adjacent columnar bodies are in contact with one another at the bottoms of the columnar bodies.

In accordance with such a layout, when the surface is covered with a silicon oxide film by thermally oxidizing the substrate 216, a film thickness of the silicon oxide film 104 at the bottom of the columnar bodies is made thin, and an aspect ratio of the columnar body can be satisfactorily maintained. This reason is not necessarily apparent, it can be inferred that, because the conical columnar bodies are structured such that the side faces thereof are in contact with one another, when oxidization progresses in the vicinity of the bottoms of the columnar bodies, a compression stress is generated, which makes more oxidization hard to progress.

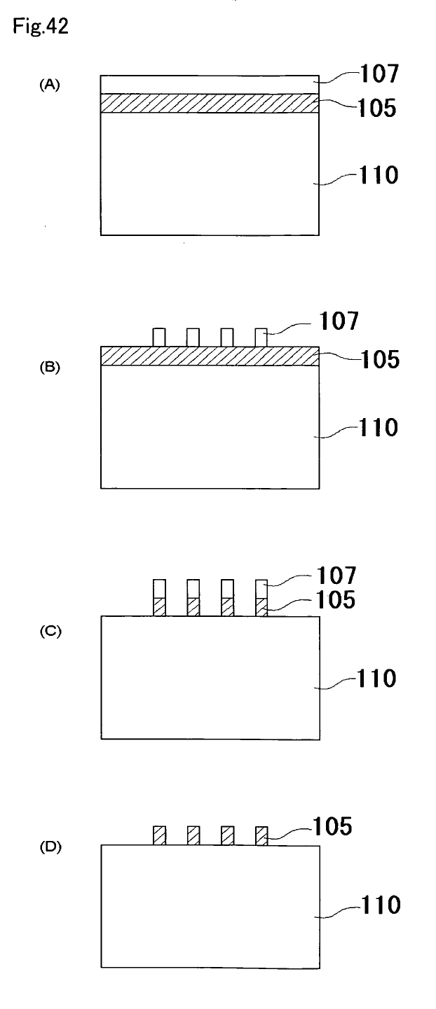

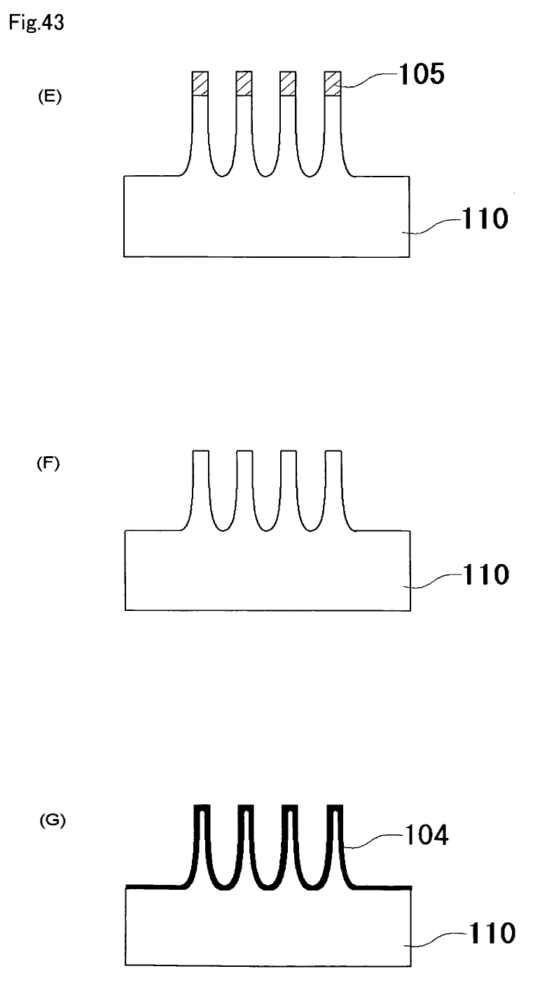

Next, by using a case in which the substrate 216 is a silicon substrate 110 as an example, a method of forming the nano-structure shown in FIG. 41 will be described with reference to FIG. 42(A) to FIG. 42(D) and FIG. 43(E) to FIG. 43(G). Here, first, as shown in FIG. 42(A), a silicon oxide film 105 and a resist film 107 are deposited in this order on the substrate 110. Next, a pattern having predetermined opening portions is formed by patterning the resist film 107 by electron bean exposure or the like (FIG. 42(B)).

Next, a hard mask formed from the silicon oxide film 105 is formed by carrying out dry etching or the like onto the silicon oxide film 105 by using the resist film 107 (FIG. 42(C)). After the resist film 107 is removed (FIG. 42(D)), columnar bodies having a high aspect ratio can be obtained by dry etching onto the substrate 110 (FIG. 43(E)). After the silicon oxide film 105 is removed (FIG. 43(F)), a silicon oxide film 104 is formed by oxidizing the surface at a high temperature of 850° C. or more (FIG. 43(G)). The nano-structure shown in FIG. 41 is obtained by the above processes. This nano-structure is formed on the main channel 221, and can be used for separation of a sample.

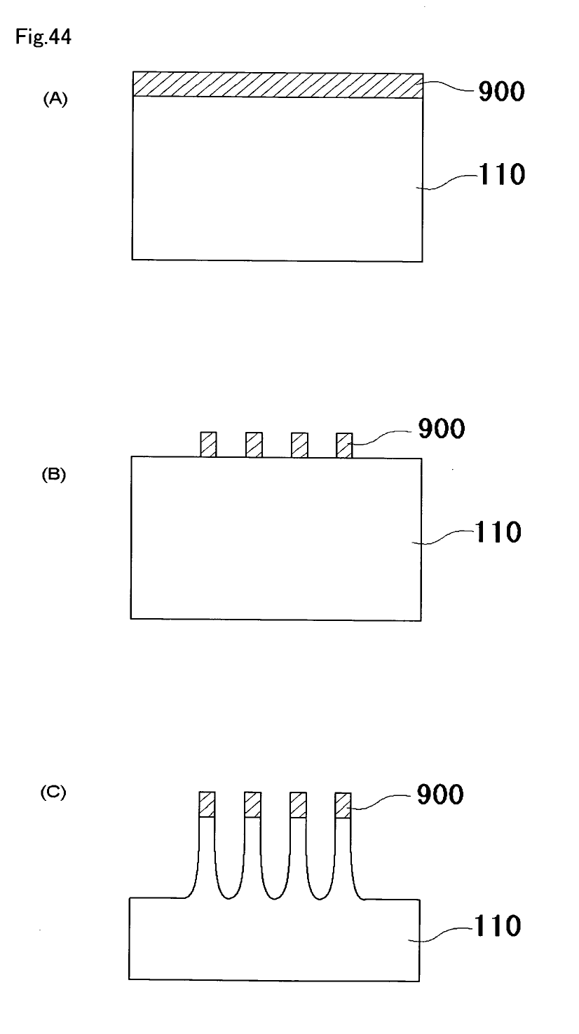

In FIG. 42(A) to FIG. 42(D) and FIG. 43(E) to FIG. 43(G), etching is carried out onto the substrate 110 with the hard mask formed by using the resist mask. However, etching can be directly carried out onto the substrate 110 by using the resist mask. FIG. 44(A) to FIG. 44(C) are diagrams showing this method. In the process shown in FIG. 44(A) to FIG. 44(C), after a resist 900 is formed on the substrate 110 (FIG. 44(A)), patterning is carried out (FIG. 44(B)), and columnar bodies are formed by etching the substrate 110 by using this resist 900 as a mask (FIG. 44(C)).

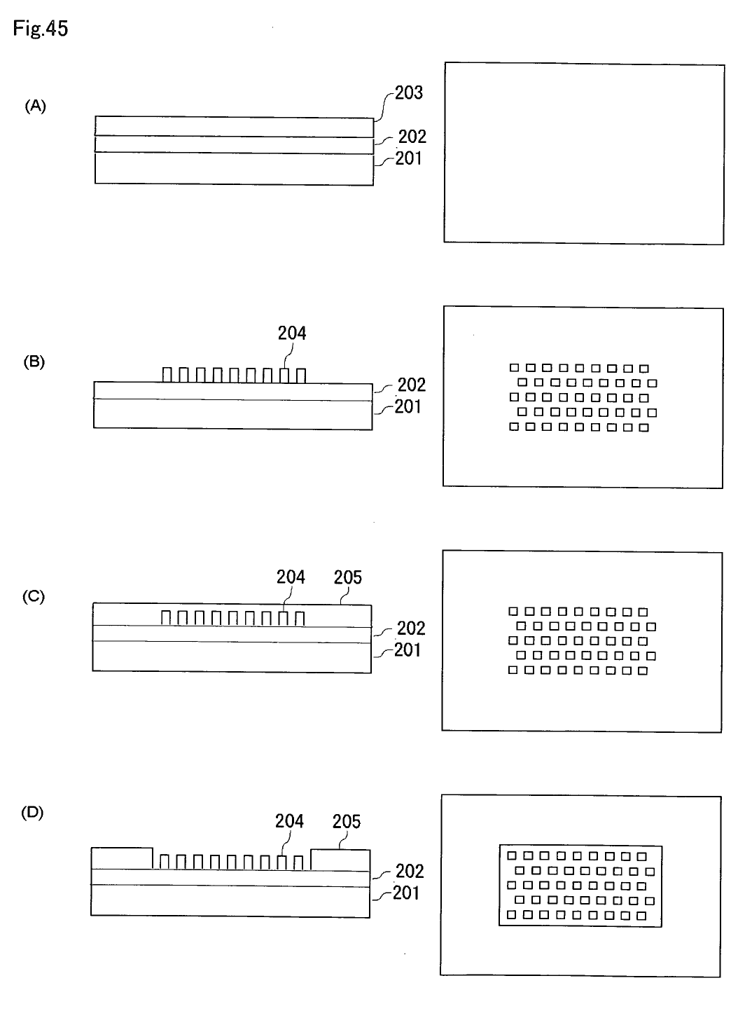

Next, another method of forming the separation region 295 having columnar bodies will be described by using FIG. 45(A) to FIG. 49. In FIG. 45(A) to FIG. 49, the drawings in the right side are top views, and the drawings in the left side are cross-sectional views. A silicon substrate 201 is used as the substrate 216. First, as shown in FIG. 45(A), a silicon oxide film 202 and a calixarene electron beam negative resist 203 are formed in this order on the silicon substrate 201. The film thicknesses of the silicon oxide film 202 and the calixarene electron beam negative resist 203 are respectively made to be 35 nm and 55 nm. Next, an array region serving as a channel for a sample is exposed by using an electron beam (EB). Development is carried out with using xylene, and rinsing is carried out with isopropyl alcohol. By this process, as shown in FIG. 45(B), a resist 204 onto which patterning has been carried out can be obtained.

Note that the calixarene electron beam negative resist 203 having a structure which will be shown below is used as a resist for electron bean exposure, and can be favorably utilized as a resist for nano-processing.

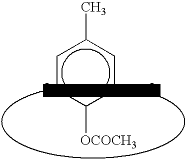

Next, a positive type photoresist 205 is applied onto the entire surface (FIG. 45(C)). The film thickness is made to be 1.8 μm. Thereafter, development is carried out by mask-exposing such that the array region is exposed (FIG. 45(D)).

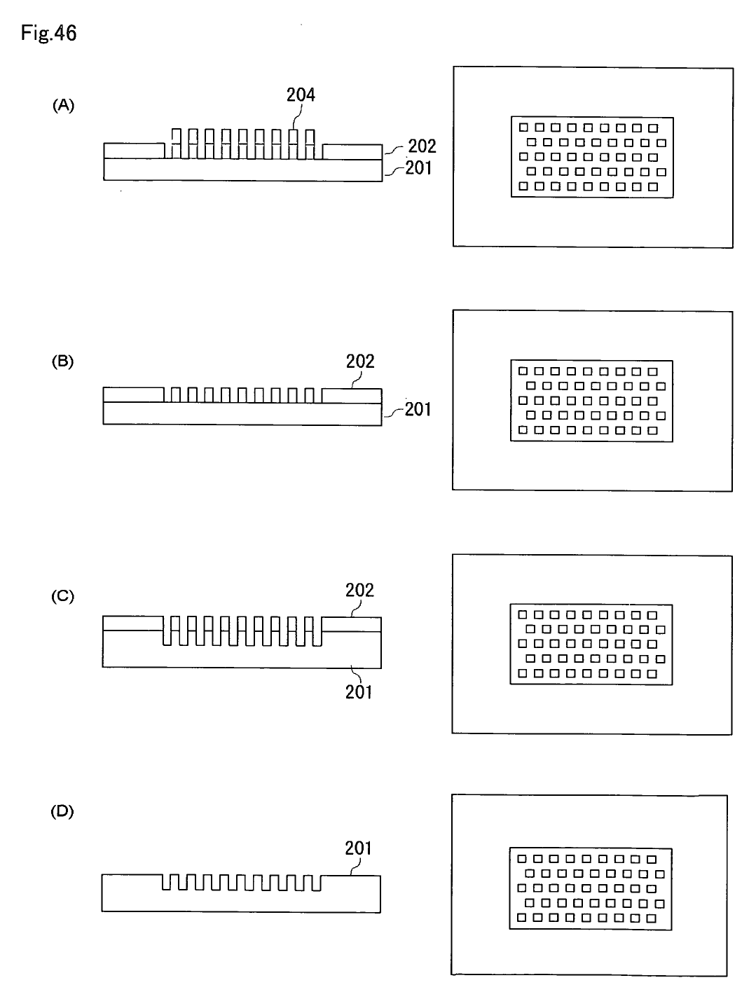

Next, RIE etching is carried out onto the silicon oxide film 202 by using a mixed gas of CF₄ and CHF₃. The film thickness after the etching is made to be 35 nm (FIG. 46(A)). After the resist is removed by organic cleaning using a mixture of acetone, alcohol, and water, oxidation plasma treatment is carried out (FIG. 46(B)). Next, ECR etching is carried out onto the silicon substrate 201 by using an HBr gas. The film thickness of the silicon substrate 201 after the etching is made to be 400 nm (FIG. 46(C)). Next, the silicon oxide film 202 is removed by carrying out wet etching with a BHF buffered hydrofluoric acid (FIG. 46(D)).

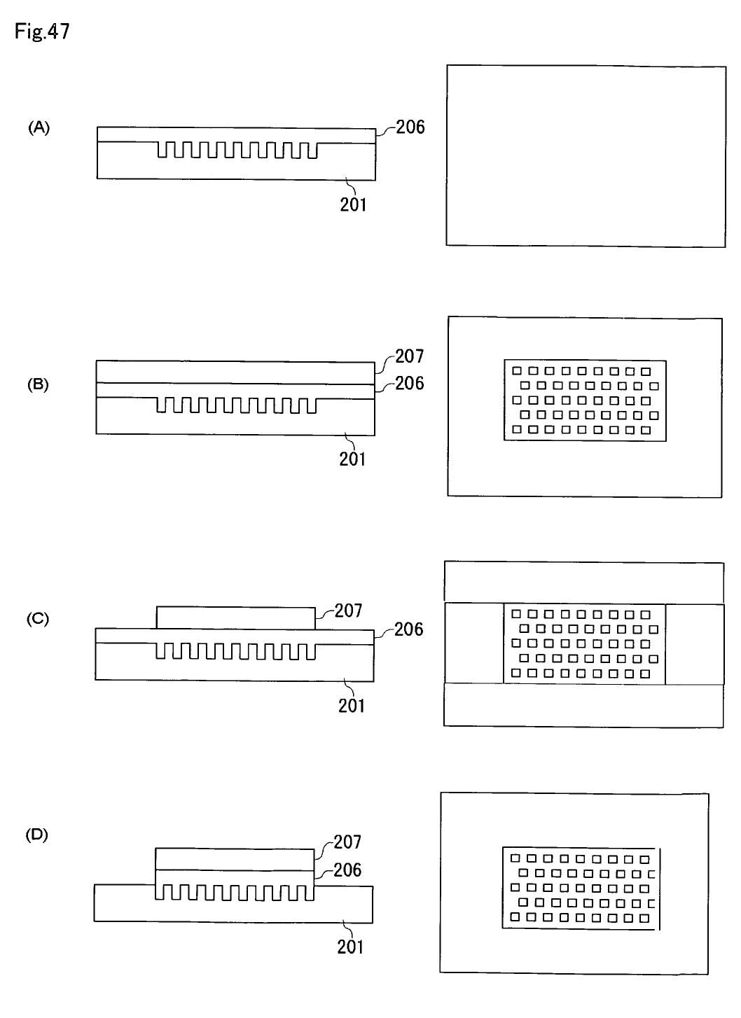

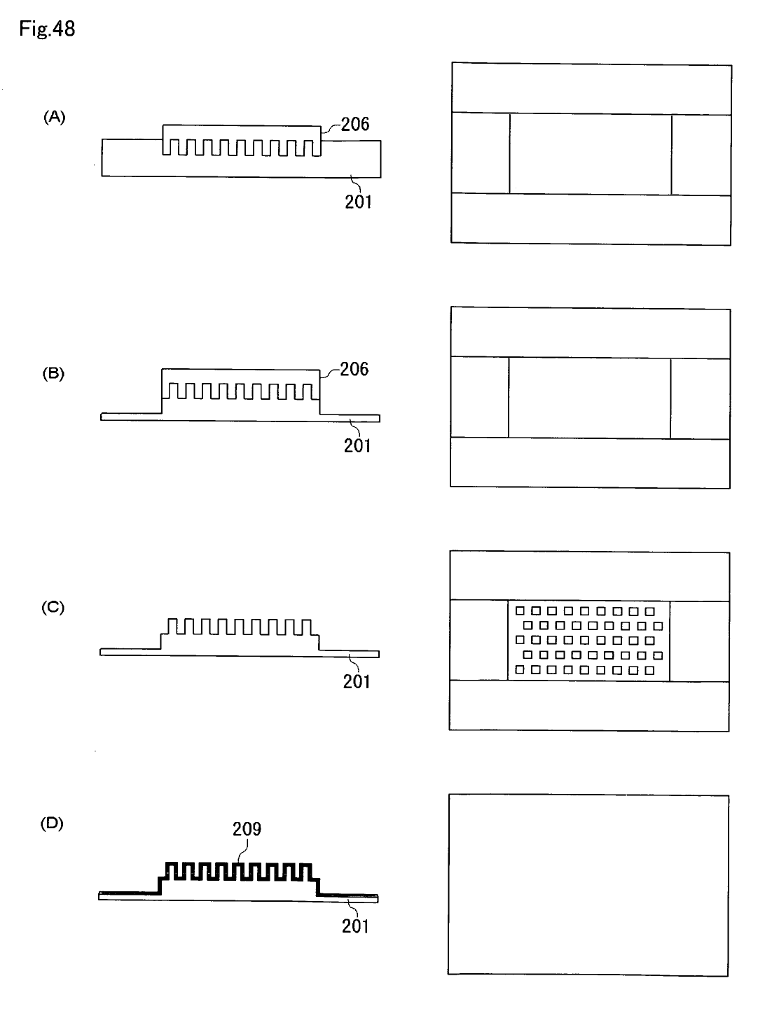

Next, a CVD silicon oxide film 206 is deposited on the silicon substrate 201 (FIG. 47(A)). The film thickness is made to be 100 nm. Next, a positive type photoresist 207 is applied onto the entire surface (FIG. 47(B)). The film thickness is made to be 1.8 μm. Next, as shown in FIG. 47(C), mask-exposure is carried out onto a channel region (the array region is protected) and development is carried out. Thereafter, wet etching is carried out onto the CVD silicon oxide film 206 with buffered hydrofluoric acid (FIG. 47(D)). Thereafter, the positive type photoresist 207 is removed by organic cleaning (FIG. 48(A)), and wet etching is carried out onto the silicon substrate 201 by using TMAH (tetramethylammoniumhydroxide) (FIG. 48(B)). Next, the CVD silicon oxide film 206 is removed by wet etching with buffered hydrofluoric acid (FIG. 48(C)).

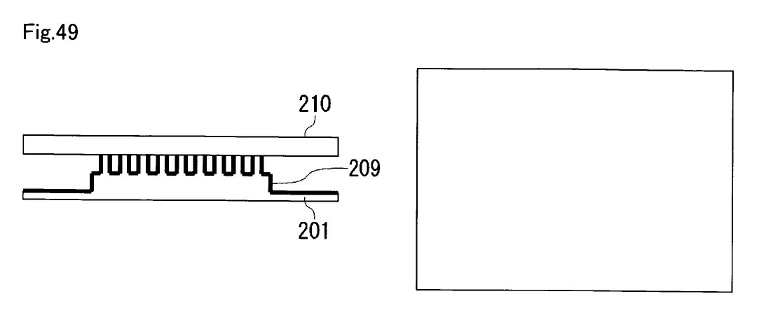

Then, a silicon thermally-oxidized film 209 is formed by putting the silicon substrate 201 in this state in a furnace (FIG. 48(D)). At this time, the thermal treatment condition is selected such that the film thickness of the silicon thermally-oxidized film 209 is made to be, for example, 20 nm. The surface of the channel is made hydrophilic by forming such a film, and the difficulty at the time of introducing a buffer solution into the channel can be eliminated. Thereafter, a cover 210 may be provided on the channel (FIG. 49). The covering 210 can be used as the cover 226 shown in FIG. 3.

In accordance therewith, the channel having columnar bodies can be obtained. In this method, it is possible to certainly form a minute columnar body array structure with a high accuracy.

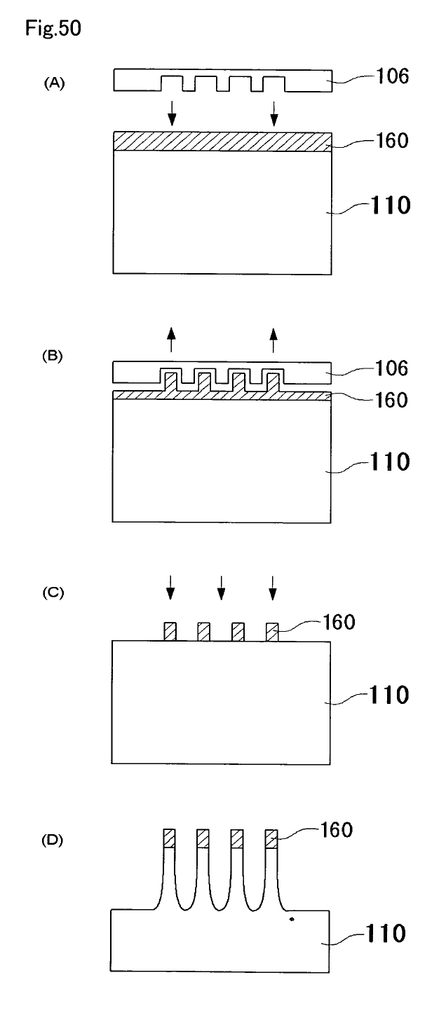

Moreover, as another method of preparing a channel having columnar bodies, a method in which patterning for a mask is carried out by using a metal mold. FIG. 50(A) to FIG. 50(D) are cross-sectional showing processes of a method of manufacturing the separation region 295. First, as shown in FIG. 50(A), a substrate 110 made of silicon in which a resin film 160 is formed on the surface, and a metal mold 106 whose molding plane is processed in a predetermined concavo-convex form are prepared. The material of the resin film 160 is a polymethyl methacrylate based material, and the thickness thereof is made to be about 200 nm. The material of the metal mold 106 is not limited in particular, but Si, SiO₂, SiC, or the like can be used.

Next, as shown in FIG. 50(B), the metal mold 106 is pressurized while being heated in a state in which the molding plane thereof is made to abut against the surface of the resin film 160. The pressure is made to be about 600 to 1900 psi, and the temperature is made to be about 140 to 180° C. Thereafter, the substrate 110 is removed from the metal mold, and patterning is carried out onto the resin film 160 by carrying out oxygen plasma ashing (FIG. 50(C)).

Next, dry etching is carried out onto the substrate 110 by using the resin film 160 as a mask (FIG. 50(D)). As an etching gas, for example, a halogen type gas is used. The etching depth is about 0.4 μm, and an interval among the columnar bodies formed by the etching is about 100 nm. An aspect ratio of the etching (horizontal to vertical ratio) is about 4:1. At this time, in the vicinity of the bottom of the concave portions generated by the etching, the progress of etching is made slow down by a micro-loading effect, and the tips of the concave portions are made narrow, which become curved surfaces. As a result, the columnar bodies broaden toward the ends, and the cross-sectional shapes thereof are made such that the bottoms are broader than the tops. Further, because a distance between the columnar bodies is narrow, the respective columnar bodies are formed so as to be close to one another to an extent that the side faces of adjacent columnar bodies are in contact with one another at the bottoms of the columnar bodies.

After FIG. 50(D), thermal oxidization is carried out by annealing in a furnace at 800 to 900° C., and a silicon thermally-oxidized film (not shown in FIG. 50(A) to FIG. 50(D)) is formed on the side walls of the columnar bodies. At this time, because the shapes of the columnar bodies and the concave portions are made to be shapes broadening toward the ends described above, as described previously by using FIG. 41, the thicknesses of the oxide films at the bottoms of the columnar bodies are made thin, and an aspect ratio of the columnar body can be satisfactorily retained.

The columnar body groups are formed on the substrate 110 by the above processes. In accordance therewith, because the process of forming mask opening portions by electron beam exposure is made unnecessary, the productivity is remarkably improved.

In FIG. 50(A) to FIG. 50(D), the metal mold is used at the time of carrying out patterning onto the resin film 160 serving as a mask. However, the columnar bodies can be formed directly by using this metal mold. Concretely, after cover of a predetermined plastic material is applied onto the substrate, it can be processed to be molded by the processes which are the same as those described above. As a plastic material to be covered onto the substrate, a material has a satisfactory moldability, and an appropriate hydrophilic property is preferably used. For example, a polyvinyl alcohol based resin, in particular, an ethylene-vinylalcohol resin (EVOH), a polyethlene terephthalate, or the like are preferably used. Even in a case of a hydrophobic resin, because the surface of the channel can be made hydrophilic by carrying out the above-describe coating after molding, it can be utilized.

Note that, when the separation region 295 is structured as in FIG. 40, there are cases in which clogging is brought about when materials in giant size are included in a sample. It is generally difficult to eliminate clogging which has been once brought about.

The problem of clogging is made more remarkable when an attempt is made to separate a sample including many types of materials in small molecular sizes with a high separative power. In order to separate a sample including many types of materials in small molecular sizes with a high separative power, it is necessary to set spaces among the pillars 125 to be small to some extent. However, this leads to a form in which clogging is more easily brought about with respect to molecules in larger sizes.

In this point, provided that a separation system shown in FIG. 51 is used, such a problem is eliminated. In FIG. 51, a plurality of columnar body disposition units (the pillar patches 121) are formed so as to be spaced from one another in the separation region 295. At each of the columnar body disposition units, pillars 125 in a same size are disposed at even intervals. At this separation region 295, larger molecules pass through in advance of smaller molecules. This is because that substances in a smaller molecular size are trapped in the separation region so as to pass through a longer route, and on the other hand, substances in a larger size smoothly pass through the path among adjacent pillar patches 121.

As a result, separation is carried out in a form in which substances in smaller sizes are discharged after substances in larger sizes. Because it is a system in which substances in large sizes relatively smoothly pass through the separation region, the problem of clogging is reduced, and the throughput is remarkably improved. In order to make such an effect more remarkable, it is preferable for a width of a path between adjacent pillar patches 121 to be made wider than a space between the pillars 125 in the pillar patch 121. The width of a path is preferably about two to twenty times as wide as a space between the pillars 125, and is more preferably five to ten times as wide as it.

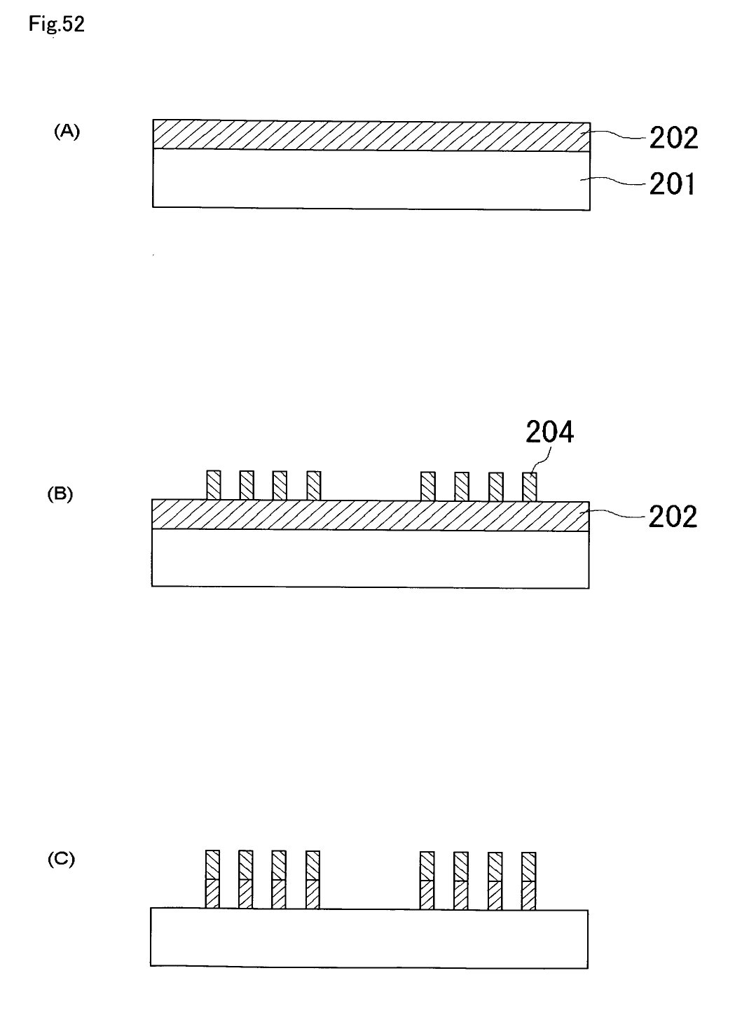

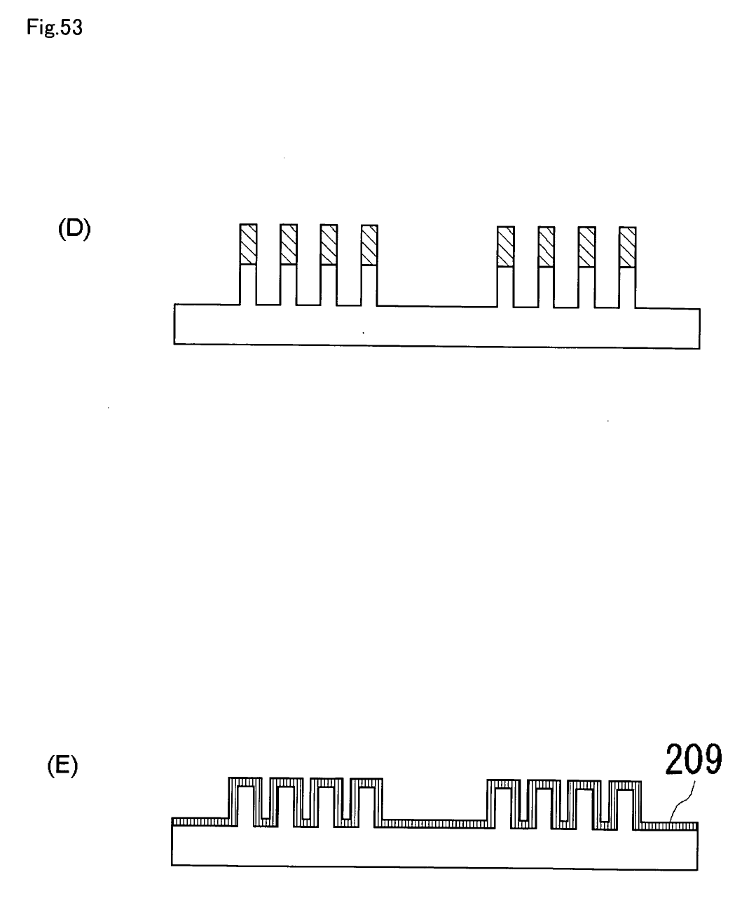

The separation region 295 having a plurality of columnar body disposition units can be prepared, for example, as follows. FIG. 52(A) to FIG. 52(C) and FIG. 53(D) to FIG. 53(E) are diagrams showing processes for preparing the separation region 295.

First, as shown in FIG. 52(A), the silicon oxide film 202 whose film thickness is 35 nm is formed on the silicon substrate 201. Next, the calixarene electron beam negative resist whose film thickness is 55 nm is formed, and an array region serving as a channel for a sample is exposed by using an electron beam (EB). Development can be carried out with using xylene. Further, rinsing can be carried out with isopropyl alcohol. By this process, as shown in FIG. 52(B), the resist 204 onto which patterning has been carried out can be obtained.

Next, RIE etching is carried out onto the silicon oxide film 202 by using a mixed gas of CF₄ and CHF₃ (FIG. 52(C)). Then, after the resist is removed by organic cleaning using a mixture of acetone, alcohol, and water, oxide plasma processing is carried out, and ECR etching is carried out onto the silicon substrate 201 by using an HBr gas and an oxygen gas (FIG. 53(D)). Thereafter, the silicon oxide film is removed by carrying out wet etching with a BHF buffered hydrofluoric acid. The silicon thermally-oxidized film 209 is formed by putting the substrate obtained in this way being in a furnace (FIG. 53(E)). As described above, the channel having a plurality of columnar body disposition units can be obtained.

Note that, in this structure as well, the columnar bodies may be provided at different intervals in the columnar body disposition units.

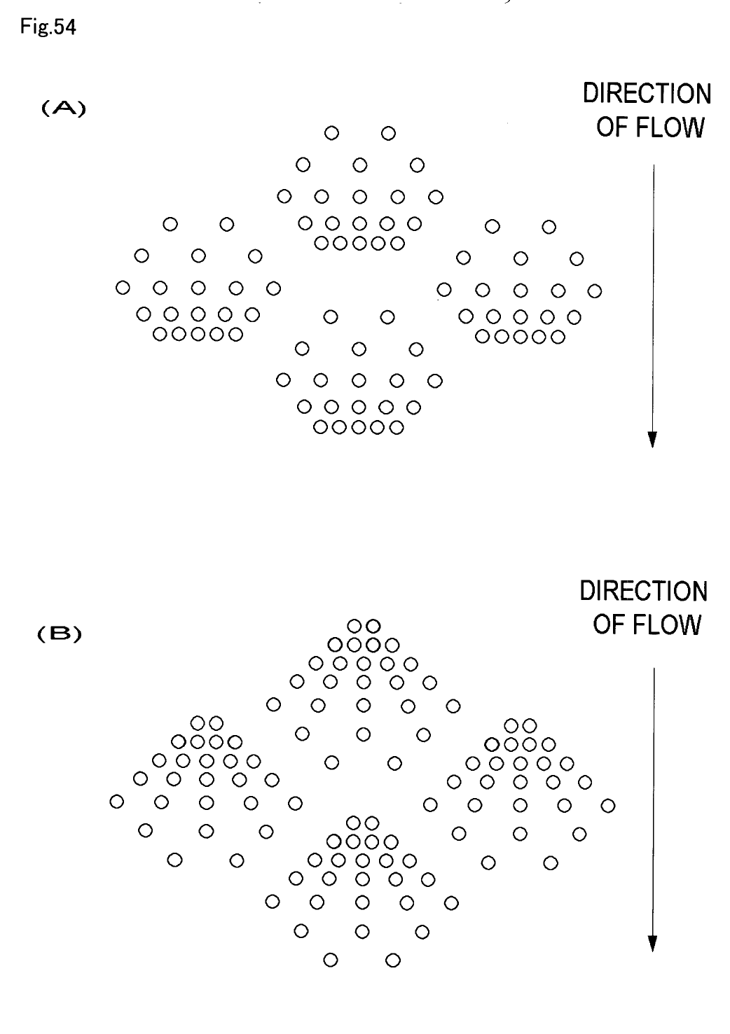

For example, as in FIG. 54(A), the columnar body disposition units in which intervals among the pillars are made gradually smaller according as a direction of a flow can be used. In this case, because the more the molecules which have gone into the columnar body disposition units move, the lower the traveling speed is, a retention time difference with molecules in the large size which cannot go into the columnar body disposition units is made remarkable. As a result, an improvement in separative power is realized. On the other hand, as in FIG. 54(B), columnar body disposition units in which intervals among the pillars are made gradually larger according as a direction of a flow can be used. In this manner, because clogging at the columnar body disposition units can be suppressed, an attempt can be made to improve the throughput. Note that the form in which intervals among the pillars are made gradually smaller or larger according as a direction of a flow can be applied to a separation region which does not have columnar body disposition units.

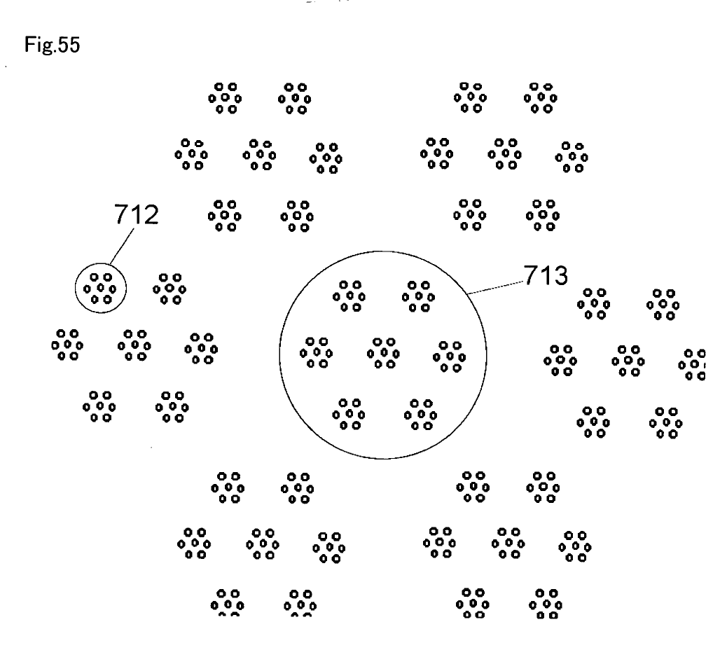

Moreover, a hierarchical layout is possible in which a plurality of columnar body disposition units are collected to become a larger columnar body disposition unit, and intervals among the large columnar body disposition units are made wider than intervals among the original columnar body disposition units. One example thereof is shown in FIG. 55. A middle level pillar patch 713 is formed due to seven small pillar patches 712 gathering together, and moreover, a large pillar patch 714 is formed due to seven middle pillar patches 713 gathering together. In this way, due to the columnar body disposition units being hierarchically structured, it is possible to separate molecules in a broad size range at one time and in descending order. Namely, larger molecules pass through among larger columnar body disposition units, and in contrast thereto, middle size molecules in an intermediate size are trapped at the inside of middle size columnar body disposition units in an intermediate size to be separated. Further smaller molecules are trapped at the inside of further smaller columnar body disposition units to be separated. Therefore, it takes longer time for smaller molecules to flow out, which makes it possible for a plurality of molecules in different sizes to be separated in descending order.

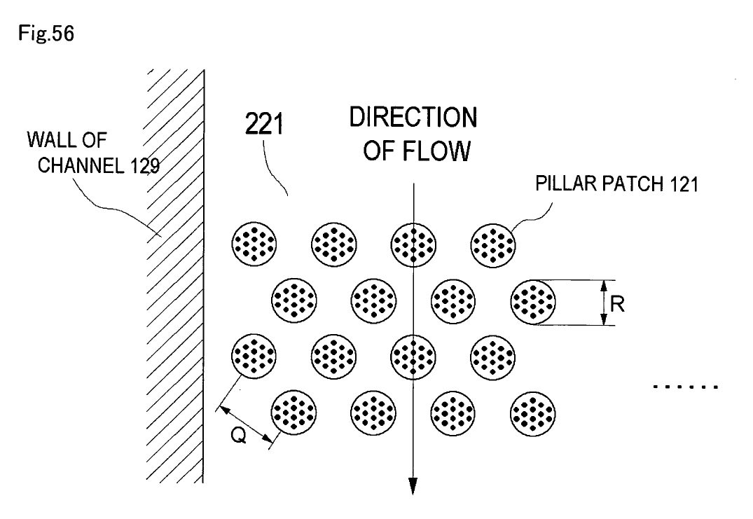

A structure of the sample separation region realizing the separation system shown in FIG. 51 will be described with reference to FIG. 56. As shown in FIG. 56, this sample separation region has a structure in which the pillar patches 121 are disposed at even intervals in a space surrounded by the walls 129 of the channel. The pillar patches 121 are respectively composed of many pillars. Here, width R of the pillar patch 121 is made less than or equal to 10 μm. On the other hand, interval Q between the pillar patches 121 is made less than or equal to 20 μm.

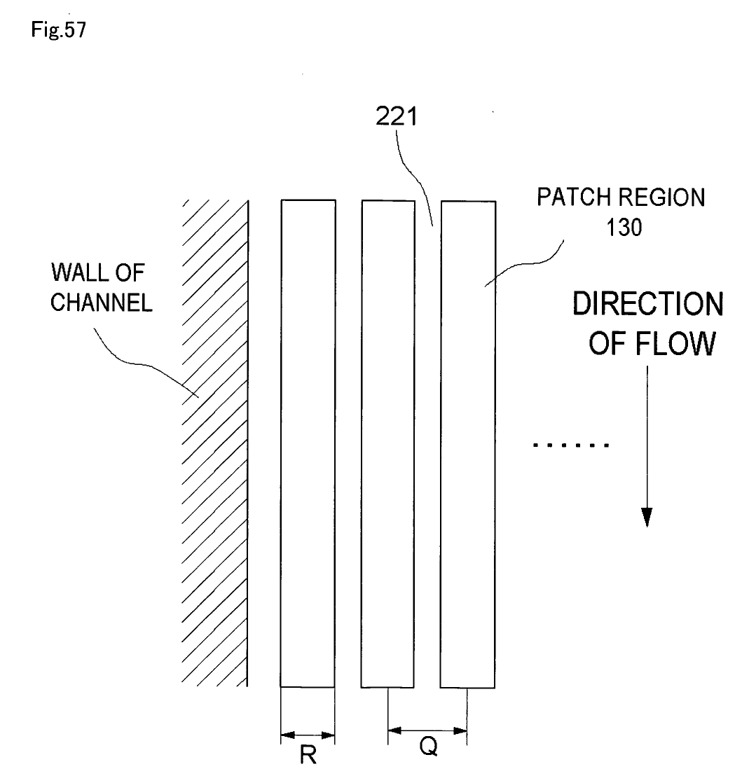

In FIG. 51, the pillar patch 121 formed due to pillars densely gathering are formed as a circular region seen from the top surface. However, the pillar patch 121 is not limited to a circular shape, and may be another shape. In an example of FIG. 57, patch regions 130 are formed to be stripe-shape regions seen from the top surface. In this form, width R of the patch region 130 is made less than or equal to 10 μm, and interval Q between the patch regions 130 is made to be 10 to 100 μm.

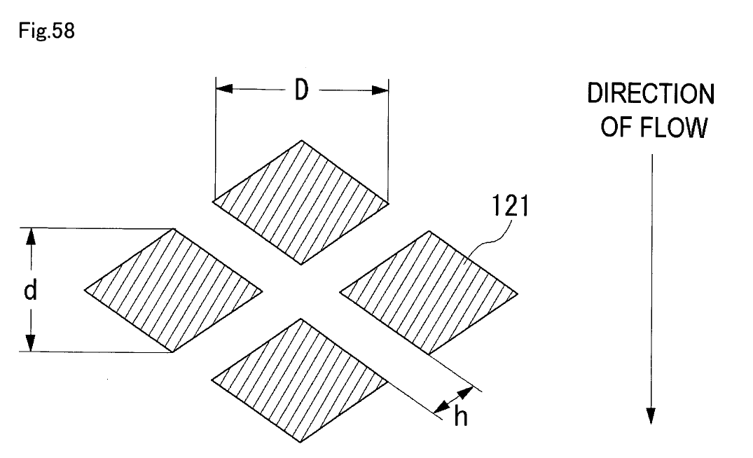

Further, FIG. 58 is an example in which rhombic pillar patches 121 are used, and moreover, a plurality of the pillar patches 121 are disposed so as to be a rhombic shape. In this case, directions of paths and a flow are at a constant angle, and because a contact frequency between molecules and the pillar patches 121 is increased, a probability that molecules smaller than an interval among the pillars structuring the pillar patch 121 are trapped in the pillar patches 121 is increased. Therefore, because a retention time difference between molecules trapped in the pillar patches 121 and molecules in the large size which are not trapped is made remarkable, an attempt can be made to improve a separative power. Further, when a diameter of molecules which are targets to be separated is R, it is preferable for interval h between the pillar patches 121, diagonal lines d and D of the pillar patch 121, interval p between pillars structuring a pillar patch to satisfy the following conditions. In accordance therewith, target molecules can be separated with high accuracy.

h: R≦h<10R

p: 0.5R≦p<2R

d: 5h≦d<20h

D: 5h≦D<20h

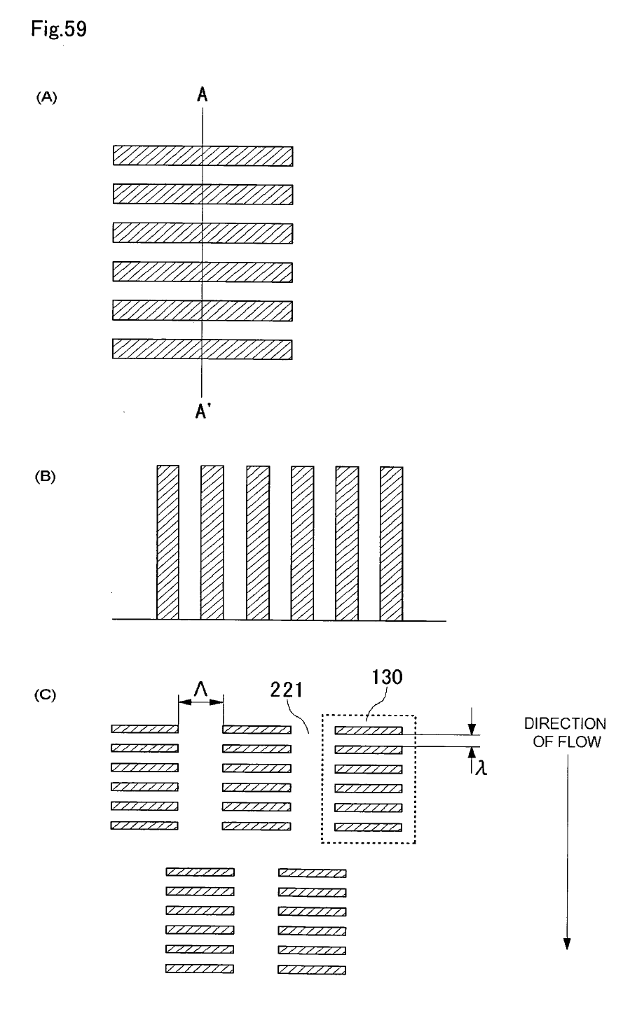

Further, Pillars are not limited as structuring a patch region. For example, it may be a patch region formed due to plate-like bodies being disposed at even intervals. This example is shown in FIG. 59(A) to FIG. 59(C). FIG. 59(A) is a top view, and a cross-sectional view taken along A-A′ in the drawing is shown in FIG. 59(B). These patch regions are disposed as shown in FIG. 59(C). Molecules which have been once trapped in the patch regions 130 are to remain in the patch regions 130 until the molecules escape to the main channel 221. Accordingly, a retention time difference between molecules which have been trapped in the patch regions and molecules which are not trapped in the patch regions is made remarkable, which improves a separative power. Further, when the diameter of molecules which are targets to be separated is R, it is preferable for interval Λ between the patch regions 130, and interval λ between plate-like bodies structuring the patch region 130 to satisfy the following conditions. In accordance therewith, target molecules can be separated with high accuracy.

Λ: R≦Λ<10R

λ: 0.5R≦λ2R

Further, the tops of the above-described columnar bodies or plate-like bodies and the top surface of the channel may be made in contact with one another, or may be spaced from one another. When those are separated from one another, because there are gaps between the columnar bodies or the plate-like bodies and the top surface of the channel, an opportunity for the passage of larger molecules is increased. Therefore, an attempt can be made to solve additional clogging. Further, with respect to smaller molecules, because an opportunity that get into the patch regions from upper side via the gaps is increased, the separative effect is further improved. Such a form can be easily realized by a groove portion being provided in advance at a member (a cover glass or the like) serving as the top surface of the channel, or by a height of the columnar bodies and the plate-like bodies being prepared so as to be lower than a depth of the channel.

Further, a width of a path between the columnar body disposition units, and an interval between the columnar bodies in the columnar body disposition units are appropriately selected in accordance with a size of components to be separated, for example, organic molecules such as nucleic acid, amino acid, peptide, protein, or the like, or molecules or ions such as chelated metallic ions or the like. For example, it is preferable for an interval between columnar bodies to be at the same level as an inertia radius corresponding to a median of the sizes in a molecular group to be separated, or in the slightly smaller size or in the slightly larger size than it. Concretely, a difference between the above-described inertia radius corresponding to the median and the interval between columnar bodies is made less than or equal to 100 nm, and more preferably less than or equal to 10 nm, and most preferably less than or equal to 1 nm. By appropriately setting the interval between columnar bodies, the separative power is further improved.

It is preferable for an interval between adjacent columnar body disposition units (a width of a path) to be at the same level as an inertia radius of a molecule in a maximum size included in a sample, or in the slightly smaller size or in the slightly larger size than it. Concretely, a difference between an inertia radius of a molecule in a maximum size included in a sample and an interval between the columnar body disposition units is made less than or equal to 10% of the inertia radius of the molecule, and more preferably less than or equal to 5% thereof, and most preferably less than or equal to 1% thereof. When the interval between the columnar body disposition units is too broad, there are cases in which separation of molecules in smaller sizes cannot be sufficiently carried out, and when the interval between the columnar body disposition units is too narrow, there are cases in which clogging is easily brought about.

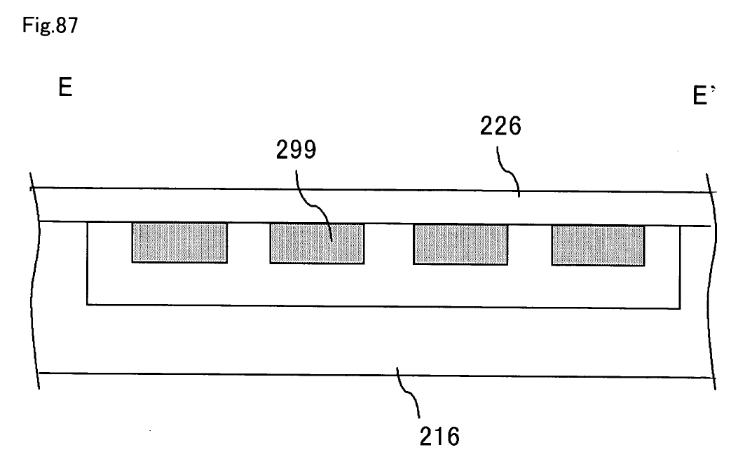

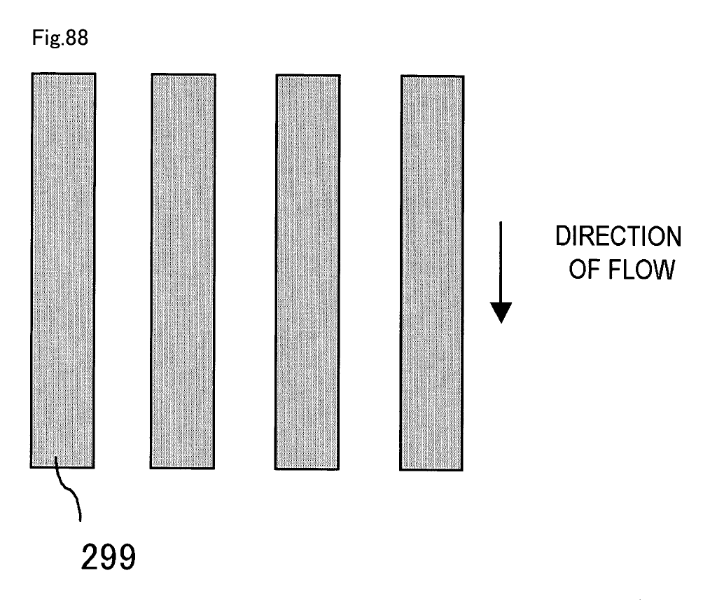

The example of the structure in which the columnar bodies are provided at the substrate 216 side has been described above. However, the columnar bodies may be provided at the cover 226. FIG. 87 is a diagram showing another structure of the separation region 295, and is a cross-sectional view in the E-E′ direction of the separation region 295 of FIG. 36. In FIG. 87 and the separation region 295, a resist pattern 299 is formed at the cover 226. Further, FIG. 88 is a plan view of the resist pattern 299. In FIG. 88, the resist pattern 299 in which a plurality of stripe-shape columnar bodies are disposed in parallel with one another.

The material of the resist pattern 299 may be, for example, a resin. Further, the resist pattern 299 may be a resin film covering a predetermined region of the cover 226. In the channel 221, the depths of the channel at the regions under the resist pattern 299 are shallow, and in contrast thereto, the depths of the regions at which the resist pattern 299 is not provided are deep. By utilizing such a structure, components in a sample can be separated into components which can pass through the regions under the resist pattern 299 and components which cannot pass through the regions.

The structure shown in FIG. 87 and FIG. 88 can be formed without carrying out nanoscale lithography onto the substrate 216. Therefore, chips can be stably produced inexpensively. For example, when the cover 226 is a glass substrate, a resist is applied onto the surface of the glass substrate, and patterning is carried out onto this. In this way, provided that the cover 226 on which the resist pattern 299 has been formed is joined such that the forming plane of the resist pattern 299 is directed to the substrate 216 side, the separation region 295 of FIG. 87 can be obtained.

Note that, in the structure of FIG. 87 and FIG. 88, the depth of the channel can be appropriately selected in accordance with objects to be separated. However, for example, when the objects to be separated are DNA molecules of about 10 kb, the depth of the channel under the resist pattern 299 can be made to be about several hundred nm, and the depth of the channel under the regions at which the resist pattern 299 are not formed can be made to be about several μm to several ten μm.

In the structure of the present embodiment, because a plurality of columnar bodies are provided in the separation region 295, separation of components in a sample can be efficiently and certainly carried out.

### Tenth Embodiment

In the present embodiment, (B) a structure in which a plurality of concave portions are provided in the eighth embodiment will be described concretely.

The concave portions of a cylinder, an elliptic cylinder, a circular cone, and an elliptic cone are favorably used. However, various shapes such as a rectangular parallelepiped, a triangular parallelepiped, or the like can be used. Further, the sizes of the concave portions can be appropriately set in accordance with a separation purpose. For example, in processings such as

(i) separation and condensation of cells and other components,

(ii) separation and condensation of solid bodies (pieces of cell membrane, mitochondria, endoplasmic reticulum) and liquid fraction (cytoplasm) among contents obtained by destructing cells, and

(iii) separation and condensation of high-molecular-weight components (DNA, RNA, protein, sugar chain) and low-molecular-weight components (steroid, glucose, or the like) among components of liquid fraction,

in a case of (i), it can be made to be 1 μm to 1 mm,

in a case of (ii), it can be made to be 100 nm to 10 μm, and

in a case of (iii), it can be made to be 1 nm to 1 μm.

The depth of the concave portion as well can be appropriately set in accordance with a usage, and for example, it can be set to 5 to 2000 nm. Further, an average interval of adjacent concave portions is preferably made less than or equal to 200 nm, and more preferably less than or equal to 100 nm, and yet more preferably less than or equal to 70 nm. There is no lower limit in particular, and for example, it can be made greater than or equal to 5 nm. Note that an interval between the concave portions means a distance between the central points of the concave portions.

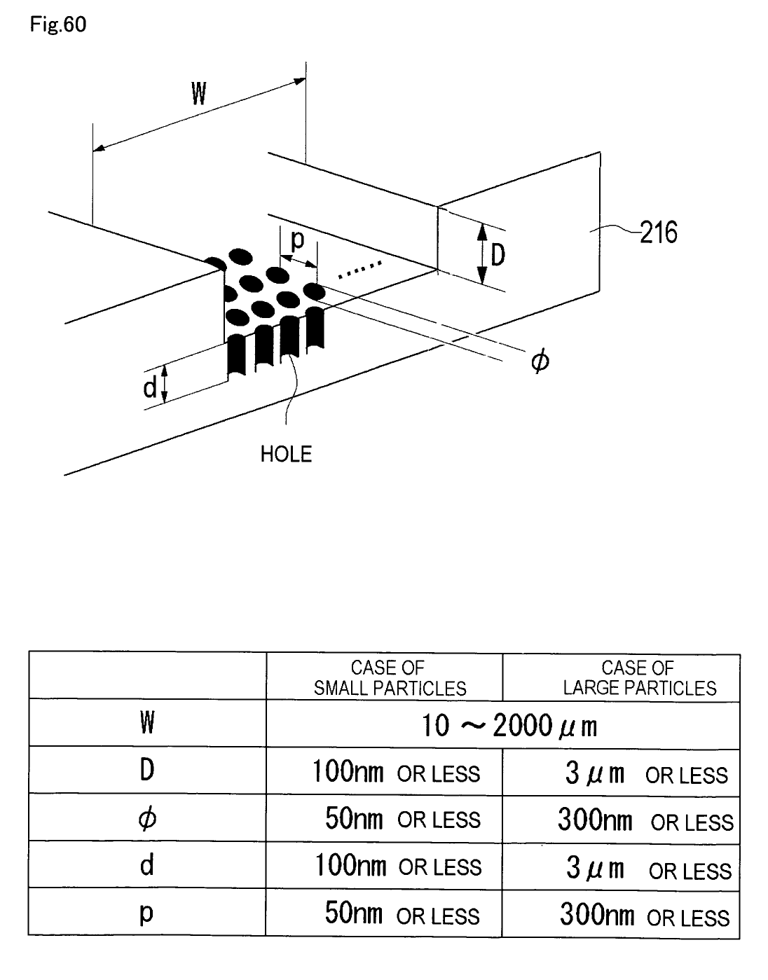

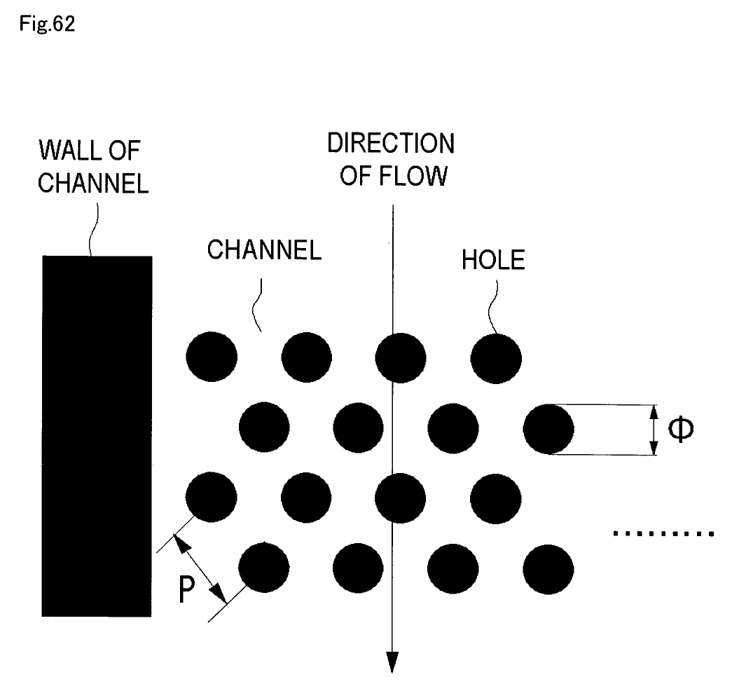

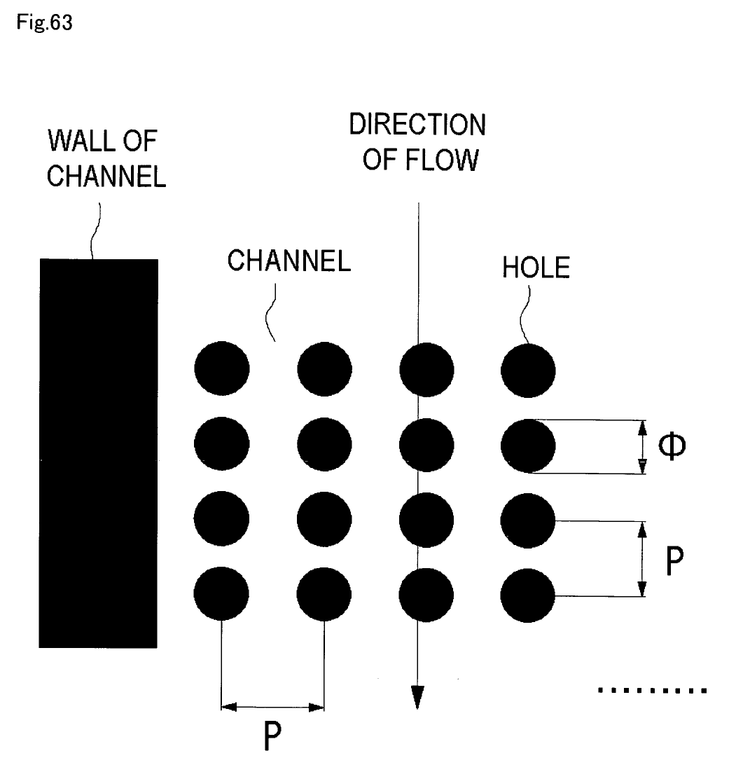

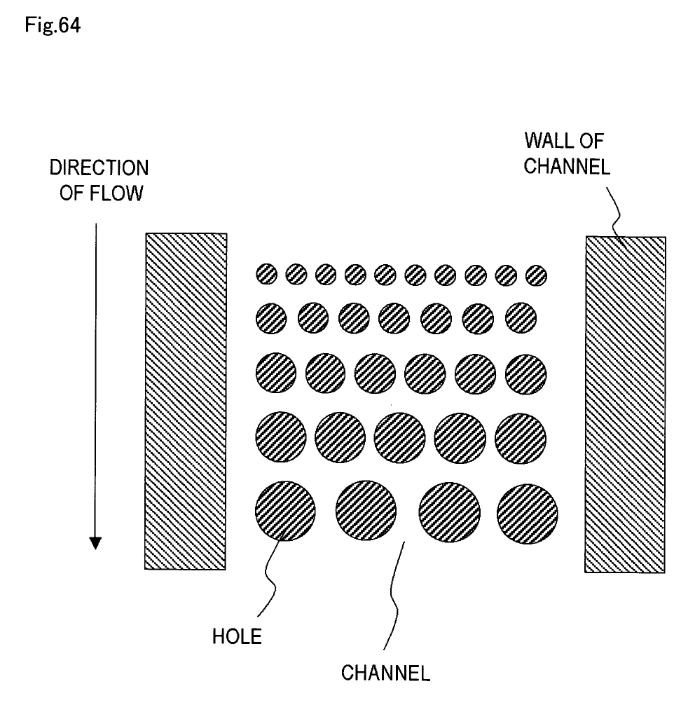

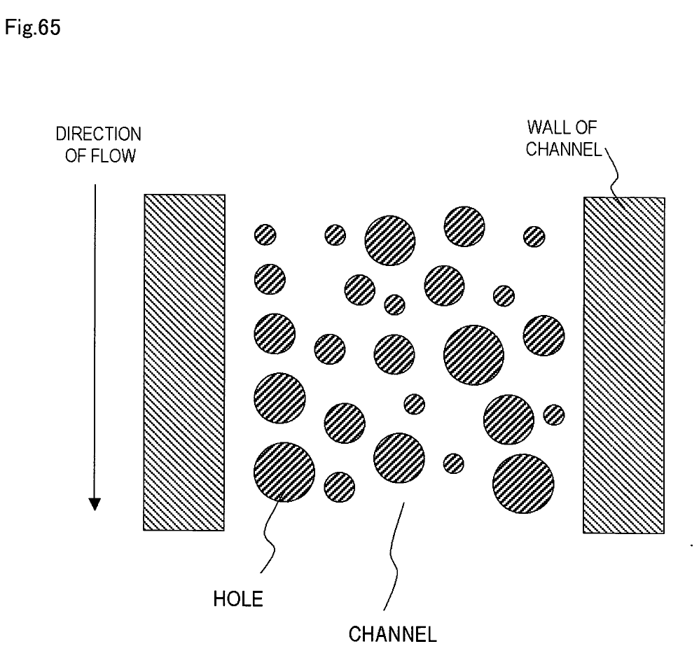

FIG. 60 shows a structure of the separation region 295 of the chip relating to the present embodiment in detail. In FIG. 60, a groove portion of width W and depth D is formed on the substrate 216, and cylindrical holes with diameter φ and depth d are regularly formed at even intervals p at the bottom of this groove portion. Note that, width W of the channel, depth D of the channel, diameter φ of the hole, a depth d of the hole, and interval p between the holes can be, for example, in the illustrated sized. Further, in forms shown in FIG. 62, FIG. 63, FIG. 64, and FIG. 65 which will be described later, W, D, φ, d, and p can be in the same size.

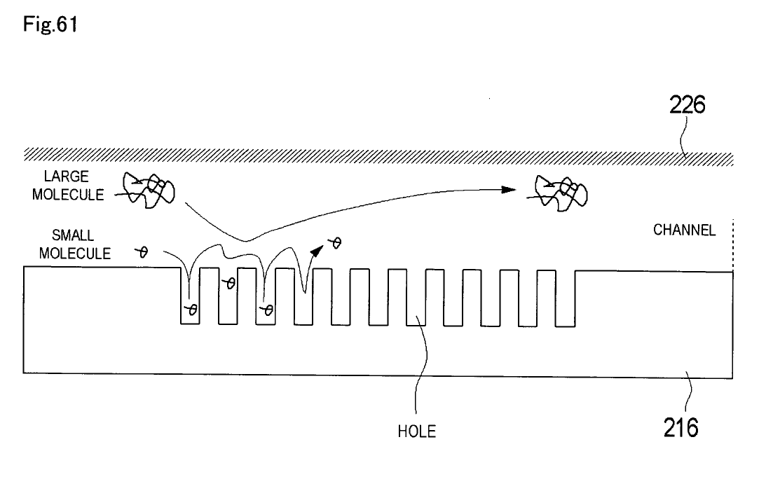

Next, the reason for that the structure in which many holes are provided functions as a sample separating means will be described with reference to FIG. 61. In FIG. 61, a plurality of holes are formed at even intervals in the separation region 295. When a sample passes through this region, because molecules in sizes larger than a diameter of the hole pass straight through without being trapped in the holes, the molecules pass through this region in a short time. On the other hand, molecules in smaller sizes are trapped in the holes provided on the substrate, and pass through a long route. As a result, the sample is separated such that the substances in smaller sizes are discharged after the substances in larger sizes.

In this way, in the structure in which concave portions are formed in the separation region 295, because it becomes a system in which substances in larger sizes which easily cause clogging relatively smoothly pass through the separation region, the problem of clogging is reduced, which improves the throughput remarkably.

An example of the structure of the sample separation region realizing the separation system shown in FIG. 61 will be described with reference to FIG. 62. As shown in FIG. 62, in this sample separation region, concave portions whose opening portion maximum diameter is φ are regularly formed as intervals of p.

FIG. 63 is an example of another sample separation region. In this example, the concave portions are arrayed in a row in an orderly manner.

FIG. 64 is an example of other sample separation region. In this example, it is structured such that concave portions in larger sizes are arrayed as it goes forward the channel.

FIG. 65 is an example of other sample separation region. In this example, it is structured such that concave portions whose opening diameters are different from one another are arrayed in random order.

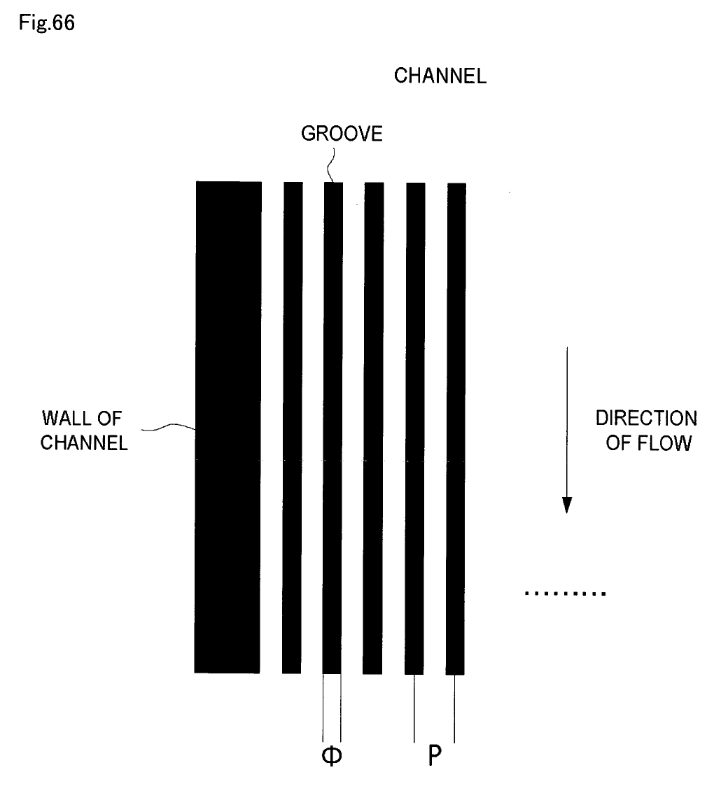

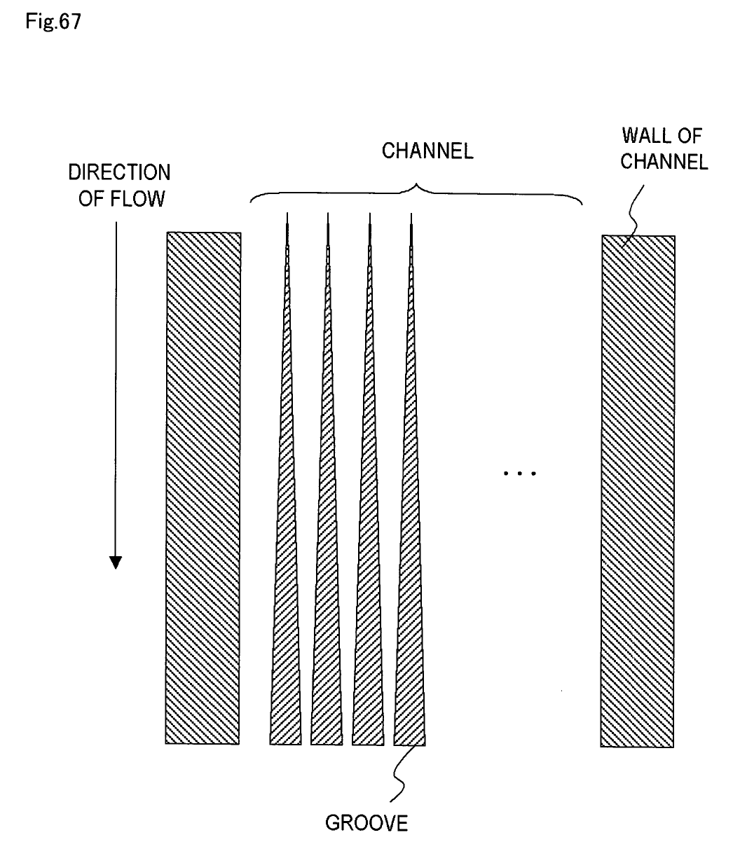

FIG. 66 is an example of other sample separation region. In this example, concave portions are formed in a stripe shape. Namely, the concave portions are not holes, but grooves. In this case, φ and p respectively express a width of a groove, and an interval between a groove and a groove.

FIG. 67 is an example of other sample separation region. In this example, it is structured such that grooves whose widths gradually broaden as it goes forward the channel are provided in the channel.

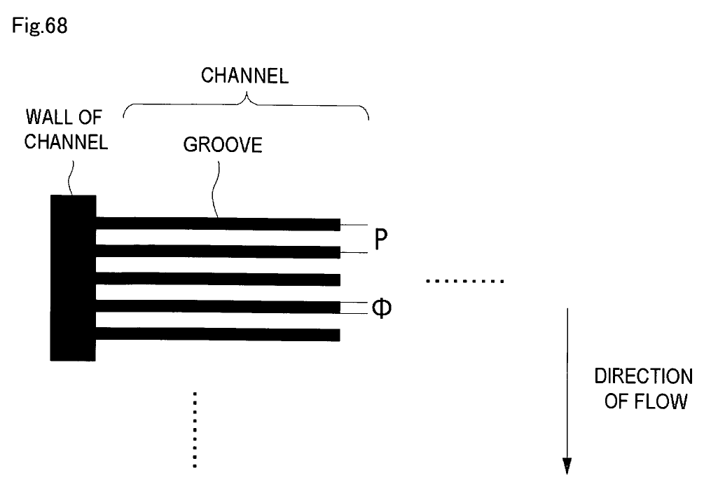

FIG. 68 is an example of other sample separation region. In the same way as in FIG. 66, concave portions are formed in a stripe shape. However, the direction of the stripes with respect to a direction of a flow of a sample is parallel in FIG. 66, and in contrast thereto, those are in a vertical relationship in FIG. 68. In this case as well, φ and p respectively express a width of a groove, and an interval between a groove and a groove.

Due to the separation region 295 being structured as shown in FIG. 64, FIG. 65, and FIG. 67, the following effects can be obtained.

It is difficult for molecules larger than a size of a hole or a groove to obtain a separative effect due to the holes. Accordingly, when the sizes of holes or grooves are made constant, a separative power with respect to molecules greater than the size of the holes or grooves deteriorates as compared with the case of smaller molecules. Further, when the sizes of holes or grooves are made constant, a range of molecular sizes which can obtain a great separative effect is made narrow. Therefore, due to the separation region 295 being structured as shown in FIG. 64, FIG. 65, and FIG. 67, a separative power with respect to molecules in larger sizes can be improved, and a range of molecular sizes which can obtain a great separative effect can be made broad.

A maximum diameter of the opening portion of the concave portion is appropriately selected in accordance with a size of components to be separated. For example, it may be at the same level as an inertia radius corresponding to a median of sizes in a molecular group to be separated, or in the slightly smaller or in the slightly larger than it. Concretely, a difference between the above-described inertia radius corresponding to a median and a maximum diameter of the opening portion of the concave portion is made less than or equal to 100 nm, and more preferably less than or equal to 10 nm, and most preferably less than or equal to 1 nm. By appropriately setting a maximum diameter of the opening portion of the concave portion, the separative power is further improved.

Further, in the above structure, the example in which the concave portions are provided at even intervals has been shown. However, the concave portions may be provided at different intervals in the sample separation region. In accordance therewith, molecules or ions in a plurality of sizes of large, medium, small, or the like can be more efficiently separated. Further, with respect to the layout of the concave portions, as shown in FIG. 62, it is effective to use a method of disposing the concave portions alternately in a traveling direction of a sample. In accordance therewith, because an opportunity for encounter between the concave portions and molecules is increased, target components can be efficiently separated while effectively preventing clogging.

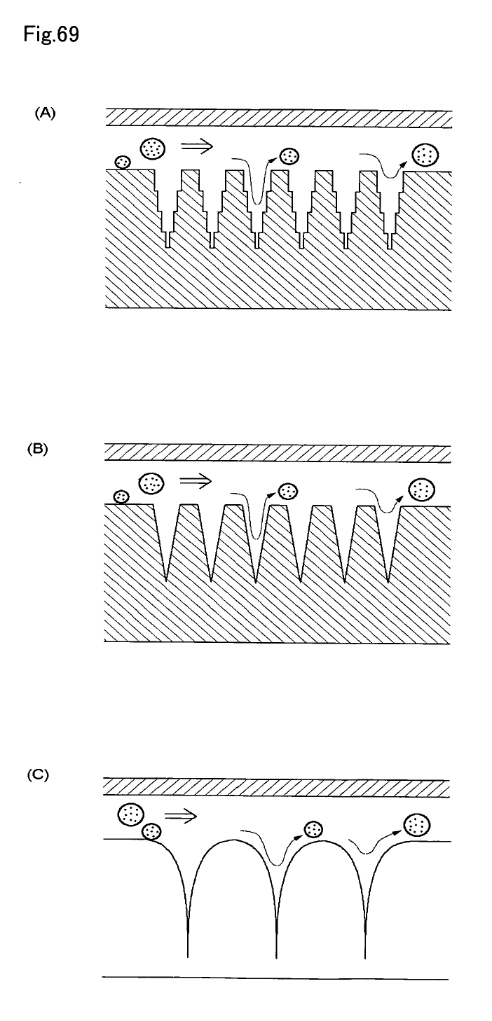

Further, in the above structure, the example in which the concave portions are cylindrical has been shown, the shape of the concave portions is not limited thereto. For example, a tapered form in which the inside diameter of a concave portion becomes smaller as it approaches to the bottom can be used. Concretely, a form in which the inside diameter of the concave portion becomes smaller in stages as shown in FIG. 69(A), and a form in which the inside diameter of the concave portion becomes smaller serially as shown in FIG. 69(B) or FIG. 69(C) can be quoted. In these cases, because smaller molecules are possible to move deeper into the concave portions, a time in which the molecules stay in the concave portions is made longer. As a result, the separative power is further improved.

Such tapered concave portions can be provided by various techniques. For example, at the time of providing concave portions by an anodic oxidation method described above, tapered concave portions can be provided by gradually lowering a voltage.

Further, tapered concave portions can be provided by etching. For example, when silicon is used as a substrate, first, vertical holes having an inside diameter at the same level as an inside diameter of the bottom surface of the concave portions to be provided are provided by dry etching. Next, wet etching using an isotropic etchant is carried out with respect to the vertical holes. At this time, an exchange velocity of the etchant in the vertical holes is the lowest at the bottoms of the vertical holes, and is made higher as it goes from the bottoms toward the opening portions of the vertical holes. Therefore, side etching is hardly brought about in the vicinity of the bottoms of the vertical holes, and the inside diameters are hardly broadened. On the other hand, because an extent of side etching is made greater as it approaches from the bottoms to the opening portions, the inside diameters are made broader according thereto. Tapered concave portions can be provided in this way.

Moreover, in the above structure, the example in which the concave portions are disposed on a plane has been shown. However, the concave portions can be disposed three-dimensionally. For example, the channel is divided into two layers by providing a separation plate in the channel, and concave portions can be provided at the separation plate and the channel walls.

In the structure of the present embodiment, there is the property that the smaller molecules are made to flow out slower. In order to sort small molecules as rapid as large molecules, through holes with a diameter at the same level as a size of target small molecules can be provided at the above-described separation plate. In accordance therewith, the target molecules can detour around the channel in which the concave portions are provided. Therefore, it is possible to sort small molecules as rapid as large molecules, and it is possible to realize separation of the other molecules.

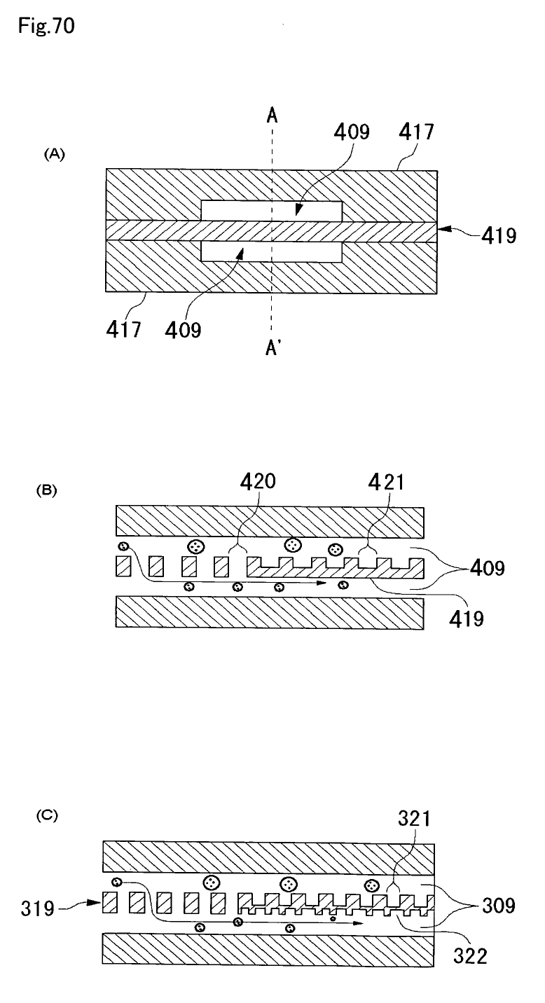

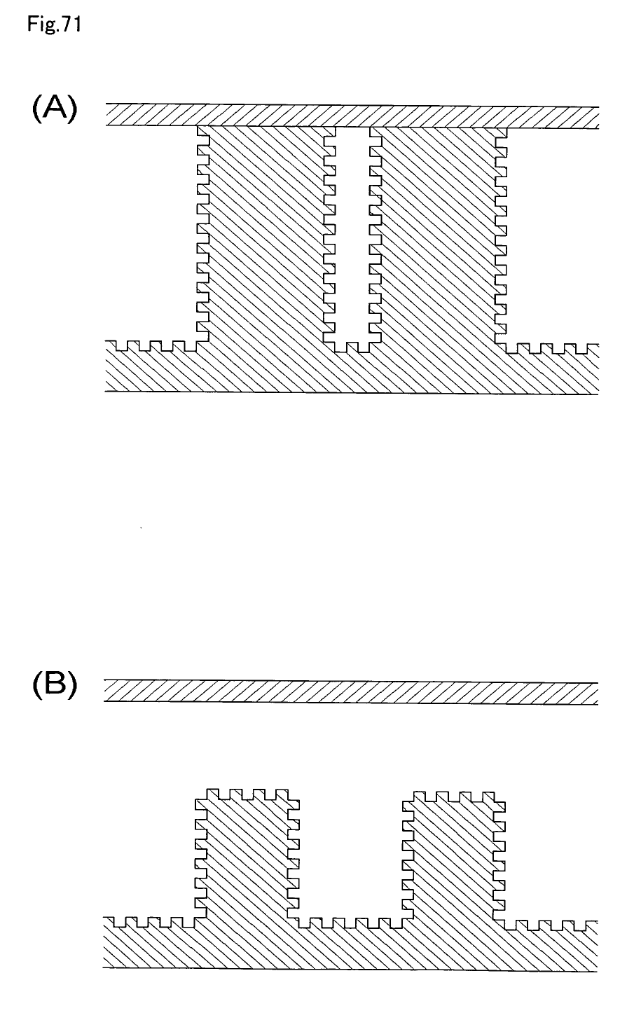

FIG. 70(A) to FIG. 70(C) are diagrams showing one example of the form in which the channel is divided into two layers. FIG. 70(A) is a vertical cross-sectional view with respect to the flow direction. Here, a case in which the substrate 216 is a silicon substrate 417 will be described as an example. A channel 409 provided in the silicon substrate 417 is divided into two layers with a separation plate 419. FIG. 70(B) is a cross-sectional view taken along A-A′ plane in FIG. 70(A). Through holes 420 and concave portions 421 are partially provided at the separation plate 419, and molecules which can pass through the through holes 420 move to the lower channel 409 in the drawing. By using such a structure, it is possible to rapidly sort small molecules whose flowing-out time is slow in a structure in which the channel is one layer. Moreover, concave portions 422 smaller than the concave portions 421 can be provided at the separation plate 419 (FIG. 70(C)). In accordance therewith, precise separation of small molecules can be realized in the channel 409 downstream side.

Further, as in FIG. 71(A) or FIG. 71(B), pillars or protrusions may be provided in the channel, and concave portions may be provided on the pillars or protrusions and the channel walls. In accordance therewith, because the area of the separation region having the concave portions can be increased, an attempt can be made to improve the separative power.

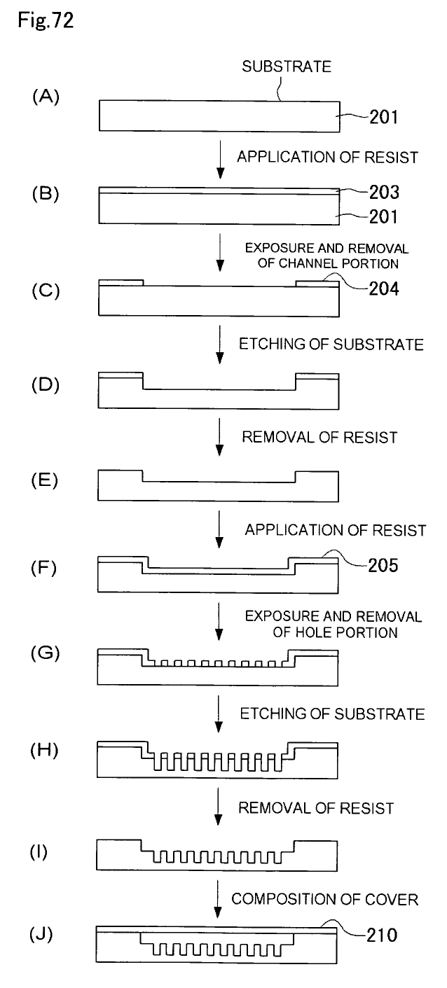

Next, a method of forming concave portions on the substrate will be described. The concave portions can be prepared by applying etching onto the substrate. FIG. 72(A) to FIG. 72(J) are diagrams for explanation of processes for preparing concave portions onto the substrate. Here, a case in which the substrate 216 is the silicon substrate 201 will be described as an example.

First, as shown in FIG. 72(A), the silicon substrate 201 is prepared, and the calixarene electron beam negative resist 203 is applied thereon (FIG. 72(B)). Next, a portion which will be a channel for a sample is exposed by using an electron beam (EB). Development is carried out with using xylene, and rinsing is carried out with isopropyl alcohol. By this process, as shown in FIG. 72(C), the resist 204 onto which patterning has been carried out can be obtained.

Next, etching is carried out onto the silicon substrate 201 by using this as a mask (FIG. 72(D)). After the resist is removed (FIG. 72(E)), the positive type photoresist 205 is applied onto the entire surface again (FIG. 72(F)). Thereafter, mask-exposure is carried out so as to expose the channel portion and development is carried out (FIG. 72(G)). Patterning is carried out onto the positive type photoresist 205 such that desired concave portions (hole portions) are formed on the silicon substrate 201.

Next, RIE etching is carried out onto the silicon substrate 201 by using a mixed gas of CF₄ and CHF₃ (FIG. 72(H)). After the resist is removed by organic cleaning using a mixture of acetone, alcohol, and water (FIG. 72(I)), the cover 210 is provided as needed, and the concave portions are completed (FIG. 72(J)). Note that the cover 210 can be used as the cover 226 shown in the above embodiment.

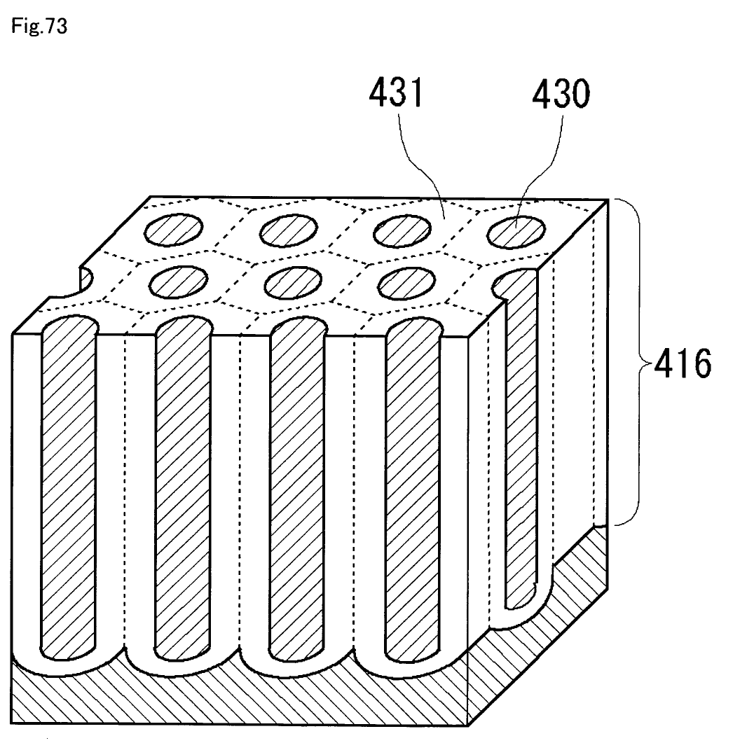

Further, the concave portions can be formed by an anodic oxidation method as well. The anodic oxidation method means processing in which current is applied to metal which is to be oxidized in electrolyte as an anode (for example, aluminum, titanium, zirconium, niobium, hafnium, tantalum, or the like), and the metal is oxidized. In this processing method, an acid electrolyte is used, and due to electrolytic process for water by applying current, hydrogen is generated in the cathode, but oxygen is not generated in the anode, and an oxide film layer is formed on the surface of the metal. In a case of aluminum, this oxide film layer is called porous alumina, and as shown in FIG. 73, a porous alumina layer 416 has a periodic structure in which fine pores 430 are provided in the centers of respective cells 431. Because these structures are formed self-organizationally, patterning is not required, and a nano-structure can be easily obtained. Intervals among cells are proportional to an oxidation voltage (2.5 nm/V), and in a case of aluminum, sulfuric acid (to 30V), oxalic acid (to 50V), and phosphoric acid (to 200V) are used as acidic electrolyte in accordance with an oxidation voltage.

On the other hand, the sizes of fine pores depend on the oxidization conditions and the surface processing after oxidization. A diameter of a fine pore is enlarged according to a rise in an oxidation voltage. For example, when an oxidation voltage is set to 5V, 25V, 80V, and 120V, fine pores whose opening portions are circular shapes or elliptic circular shapes, which respectively have a maximum diameter of about 10 nm, 20 nm, 100 nm, and 150 nm are formed. Further, after the porous alumina is formed, surface processing in which etching is carried out onto the surface thereof by, for example, phosphoric acid of 3 wt %. However, the longer the time for this surface processing is, the more the diameter of a fine pore is enlarged.

As described above, by appropriately selecting an oxidation voltage or a time for surface processing, it is possible to provide concave portions which are regularly arrayed, and which have a desired interval and diameter.

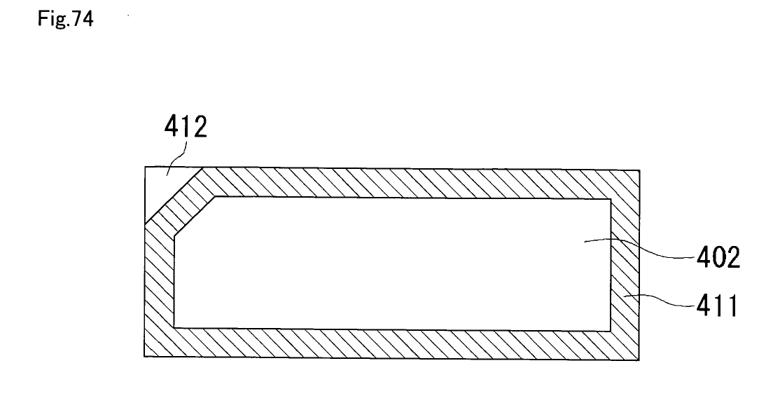

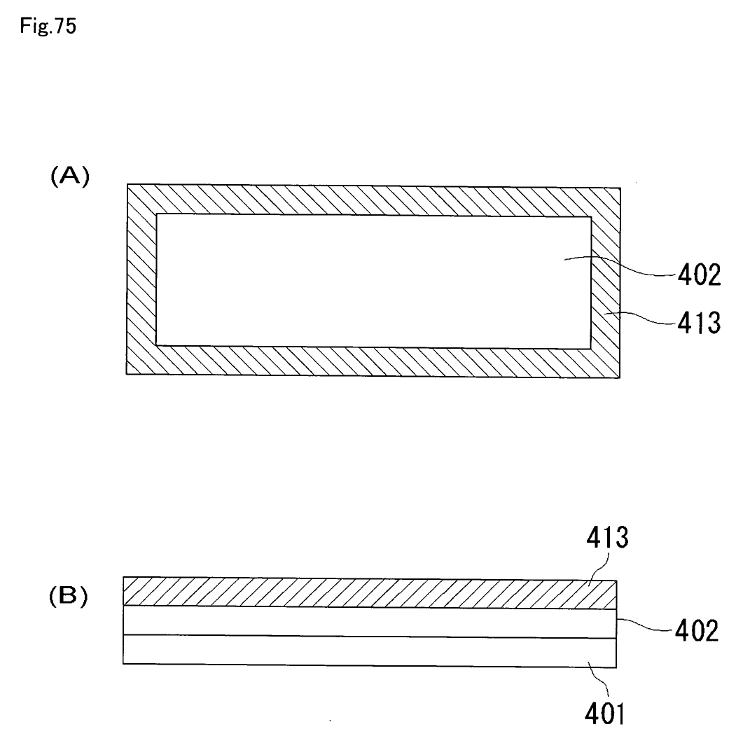

Note that, in order to provide porous alumina so as to be more homogenous, as shown in FIG. 74 and FIG. 75, it is preferable to execute the above-described anodic oxidation while covering the peripheral portion of the aluminum layer serving as an object to which anodic oxidation is applied with an insulating layer. For example, FIG. 74 is a top view showing a state in which the peripheral portion of an aluminum layer 402 formed on an insulating substrate is covered with an insulating film 411. As the insulating film 411, for example, an insulating resin such as photosensitive polyimide or the like can be used. In accordance therewith, because a phenomenon that an anodic oxidation reaction is rapidly made to progress only at the periphery of an electrode attaching portion 412, and regions which cannot be oxidized are formed at portions distant from an anode can be suppressed, it is possible to homogeneously provide porous alumina on the entire aluminum layer 402.

Further, by a method of ASOU and others (J. Vac. Sci. Technol., B, 19(2), 569(2001), it is possible to provide porous alumina in a desired layout by executing anodic oxidation after depressions are provided in advance by using a mold at an area at which an attempt is made to provide porous alumina. In this case as well, in the same way as in the above description, a maximum diameter of a concave portion can be made to be in a desired size by controlling a voltage.

Further, FIG. 75 is diagrams showing a state in which the periphery portion of the aluminum layer 402 is covered with an electrically conductive layer 413. FIG. 75(A) is a top view, and FIG. 75(B) is a cross-sectional view. As shown in FIG. 75(A) and FIG. 75(B), it is possible to homogeneously provide porous alumina on the entire aluminum layer 402 by executing anodic oxidation as well after the electrically conductive layer 413 is formed by evaporating a conductive material (gold or the like) which cannot be anodic-oxidized onto the aluminum layer 402 provided on a slide glass 401. Note that, after the anodic oxidation is executed, the electrically conductive layer 413 is removed by a gold etchant when the conductive material is gold. The gold etchant can be obtained by mixing potassium iodide and a solution of iodine in water. The mixture ratio is made to be in potassium iodide:iodine:water=1:1:3 (pound for pound).

Moreover, in order to prevent molecules such as DNA, protein, or the like from being adhered to the channel walls, it is preferable to carry out hydrophilic processing such as cover onto the channel walls or the like. As a result, it is possible to exert a satisfactory separative power. As a cover material, for example, a substance having a structure similar to that of phospholipids structuring a cell membrane can be quoted. As such a substance, LIPIDURE® (manufactured by NOF CORPORATION) or the like can be exemplified. When LIPIDURE® is used, for example, this is dissolved in a buffer solution such as a TBF buffer so as to be of 0.5 wt %, and this solution is filled into the channel, and is left for a several minutes, which enables cover onto the channel walls.

Due to the separation region 295 being structured as described above, separation of a sample on the chip can be certainly carried out efficiently.

### Eleventh Embodiment

In the present embodiment,

(C) a structure in which hydrophobic patches are provided in the eighth embodiment will be described concretely.

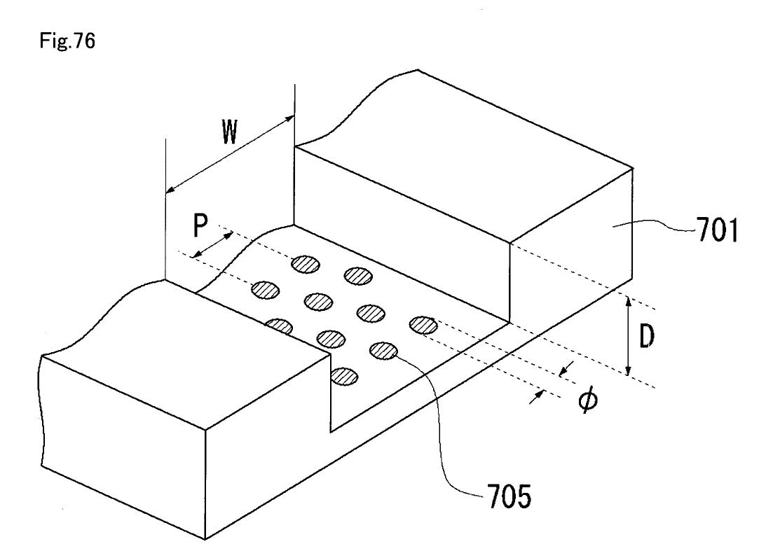

The surface of the separation region 295 in the present embodiment is composed of a plurality of hydrophobic regions which are disposed two-dimensionally at substantially even intervals, and a hydrophilic region occupying the surface of the sample separation region other than the hydrophobic regions. FIG. 76 shows a structure of the separation region 295 in the eighth embodiment in detail. In FIG. 76, a groove portion whose depth is D is formed in a substrate 701, and hydrophobic regions 705 whose diameter is φ are regularly formed at even intervals. Note that the substrate 701 can be used as the substrate 216 of the chip described in the above embodiments.

In the present embodiment, the hydrophobic regions 705 are formed due to a coupling agent having a hydrophobic group being adhered to or coupled with the surface of the substrate 701.

In FIG. 76, the dimensions of the respective portions are made, for example, as follows.

W: 10 to 20 μm

D: 50 nm to 10 μm

φ: 10 to 1000 nm

p: 50 nm to 10 μm

The sizes of the respective portions can be appropriately set in accordance with a separation purpose. For example, with respect to p, in processings such as

(i) separation and condensation of cells and other components,

(ii) separation and condensation of solid bodies (pieces of cell membrane, mitochondria, endoplasmic reticulum) and liquid fraction (cytoplasm) among components obtained by destructing cells, and

(iii) separation and condensation of high-molecular-weight components (DNA, RNA, protein, sugar chain) and low-molecular-weight components (steroid, glucose, or the like) among components of liquid fraction,

in a case of (i), it can be made to be 1 μm to 1 mm,

in a case of (ii), it can be made to be 100 nm to 10 μm, and

in a case of (iii), it can be made to be 1 nm to 1 μm.

Further, a size of depth D is an important factor dominating the separative power, and is preferably made to be about one to ten times as long as an inertia of a sample, and more preferably about one to five as long as it.

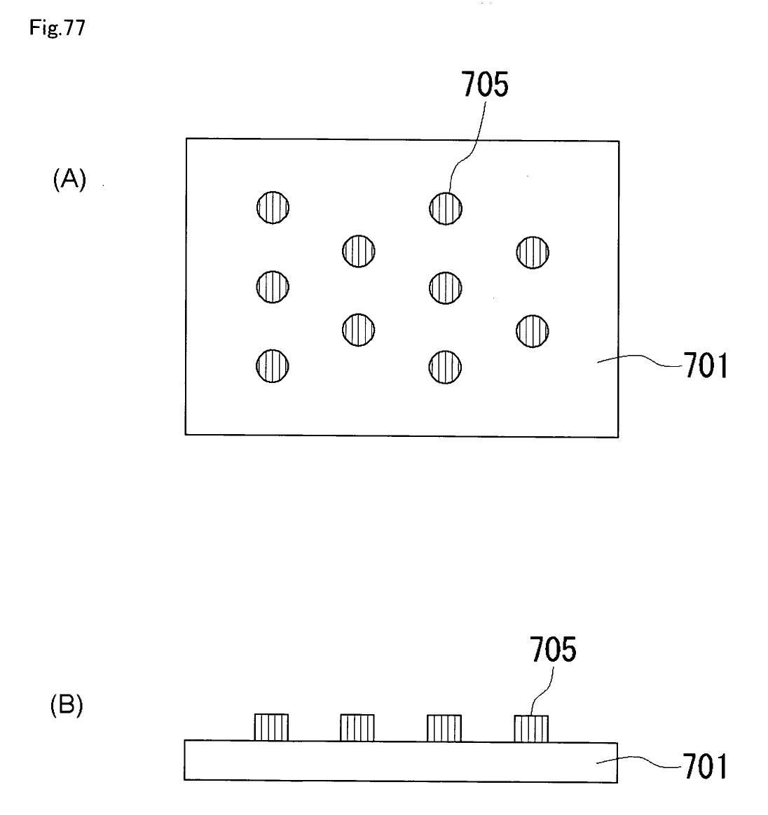

FIG. 77(A) and FIG. 77(B) are a top view of the structure of FIG. 76 (FIG. 77(A)) and a side view (FIG. 77(B)). The hydrophobic regions 705 are usually made to have a film thickness of about 0.1 to 100 nm. The portion other than the hydrophobic regions 705 is in a state in which the surface of the substrate 701 is exposed. Due to a hydrophilic material such as a glass substrate being selected as the substrate 701, in the structure of FIG. 76, it is structured such that a hydrophobic surface is formed so as to have a predetermined pattern on the hydrophilic surface, and a sample separating function is developed.

Namely, when a hydrophilic buffer solution or the like is used as a carrier solvent, the sample passes through only on the hydrophilic surface, but does not pass through on the hydrophobic surface. Therefore, the hydrophobic regions 705 function as obstacles to the passage of the sample, and a sample separating function is developed.

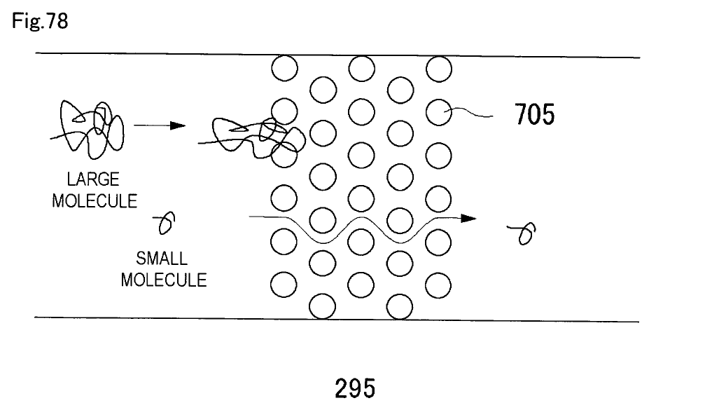

Next, a separation system at the separation region 295 by forming a pattern of the hydrophobic regions 705 will be described focusing on a molecular size. Two systems can be conceived as a separation system. One is a separation system shown in FIG. 78. In this system, the larger the molecular size is, the more obstructive the hydrophobic regions 705 are, and a time required for passing through the illustrated separation unit is made longer. Molecules in smaller sizes relatively smoothly pass through gaps among the hydrophobic regions 705, and pass through the separation region 295 in a shorter time as compared with molecules in larger sizes.

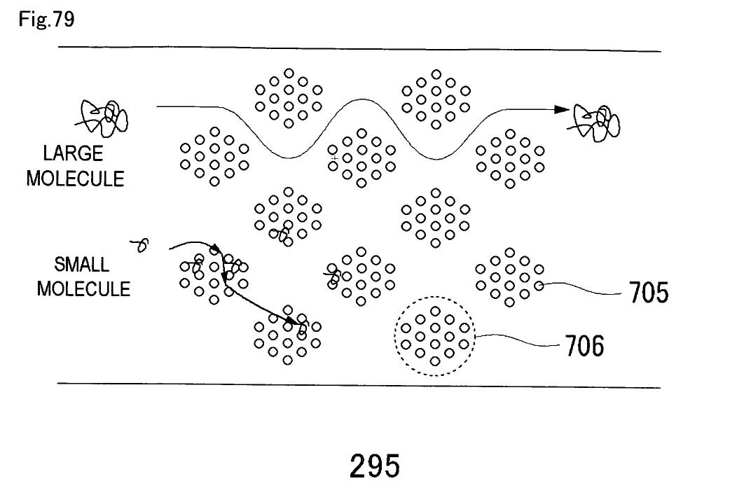

FIG. 79 is, in contrast to that of FIG. 78, made to be a system in which larger molecules rapidly flow out, and smaller molecules slowly flow out. In the system of FIG. 78, when substances in giant size are included in a sample, there are cases in which such substances block the intervals among the hydrophobic regions 705, which deteriorates the separative efficiency. In the separation system shown in FIG. 63, such a problem is solved. In FIG. 79, a plurality of sample separation units 706 are formed so as to be spaced from one another in the main channel 221. The hydrophobic regions 705 in substantially the same size are disposed at even intervals respectively in the respective sample separation units 706.

Because broad paths through which large molecules can pass are provided among the sample separation units 706, in contrast to that of FIG. 78, larger molecules rapidly flow out, and smaller molecules slowly flow out. This is because that, molecules in smaller sizes are trapped in the separation region to pass through a longer route, and on the other hand, substances in larger sizes smoothly pass through the path among adjacent sample separation units 706. As a result, separation is carried out in a form in which substances in smaller sizes are discharged after substances in larger sizes. Because it is a system in which substances in larger sizes relatively smoothly pass through the separation region, the problem described above that the larger molecules are trapped among the hydrophobic regions 705 and the separative efficiency is reduced, and the separative efficiency is remarkably improved. In order to make such an effect more remarkable, it is preferable for a width of a path between adjacent sample separating units 706 to be made wider than an interval between the hydrophobic regions 705 in the sample separating units 706. The width of the path is preferably about two to two-hundred times as long as an interval between the hydrophobic regions 705, and more preferably about five to one-hundred times as long as it.

Note that, in the example of FIG. 79, the hydrophobic regions 705 in a same size and at even intervals are formed in the respective sample separation units. However, the hydrophobic regions 705 respectively in different sizes and at different intervals may be formed in the respective sample separation units.

When substances in molecular sizes are separated, a width of a path between the sample separation units, and an interval between the hydrophobic regions 705 in the sample separation unit are appropriately selected in accordance with a size of components to be separated (organic molecules such as nucleic acid, amino acid, peptide, protein, or the like, or molecules or ions such as chelated metallic ions or the like). For example, it is preferable for an interval between the hydrophobic regions 705 to be at the same level as an inertia radius of a molecule in a minimum size included in a sample, or in the slightly smaller size or in the slightly larger size than it. Concretely, a difference between the above-described inertia radius of a molecule in a minimum size included in a sample and the interval between the hydrophobic regions 705 is made less than or equal to 100 nm, and more preferably less than or equal to 50 nm, and most preferably less than or equal to 10 nm. By appropriately setting the interval between the first regions, the separative power is further improved.

It is preferable for an interval between adjacent sample separation units 706 (a width of a path) to be at the same level as an inertia radius of a molecule in a maximum size included in a sample, or in the slightly smaller size or in the slightly larger size than it. Concretely, a difference between an inertia radius of a molecule in a maximum size included in a sample and an interval between the sample separation units is made less than or equal to 10% of the inertia radius of the molecule, and more preferably less than or equal to 5% thereof, and most preferably less than or equal to 1% thereof. When the interval between the sample separation units 706 is too broad, there are cases in which separation of molecules in smaller sizes cannot be sufficiently carried out, and when the interval between the sample separation units 706 is too narrow, there are cases in which clogging is easily brought about.

Further, in the above-described embodiment, the example in which the hydrophobic regions are provided at even intervals has been shown. However, the hydrophobic regions may be provided at different intervals in the sample separation unit 706. In accordance therewith, molecules or ions in a plurality of sizes of large, medium, small, or the like can be more efficiently separated. Further, with respect to the layout of the hydrophobic regions, it is effective to use a method of disposing the hydrophobic regions alternately in a traveling direction of a sample. In accordance therewith, target components can be efficiently separated.

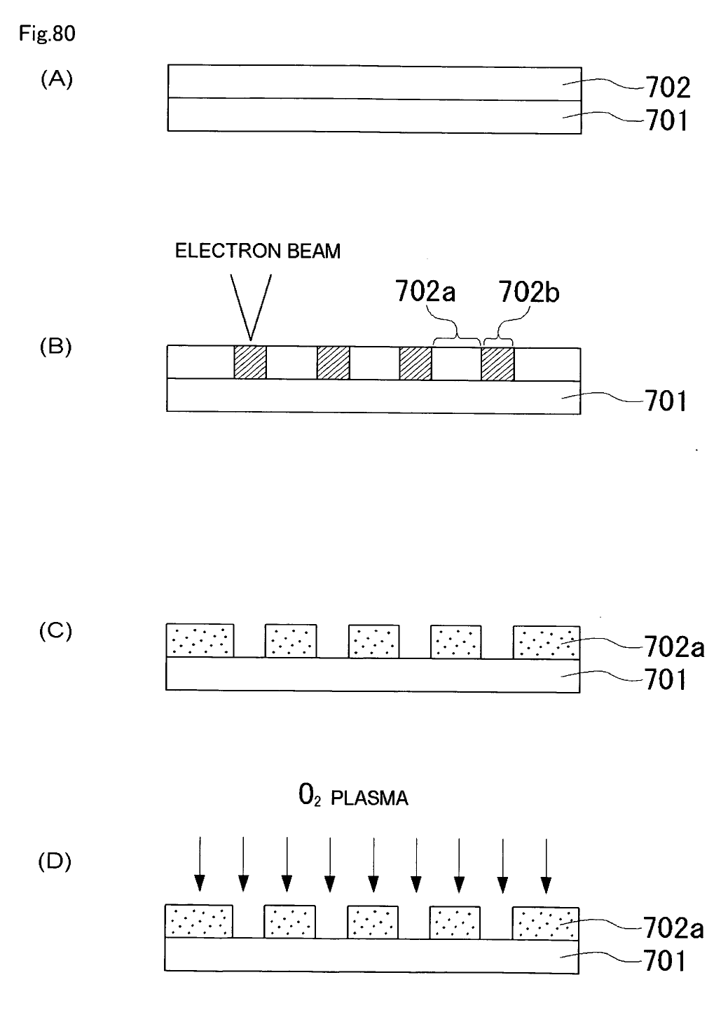

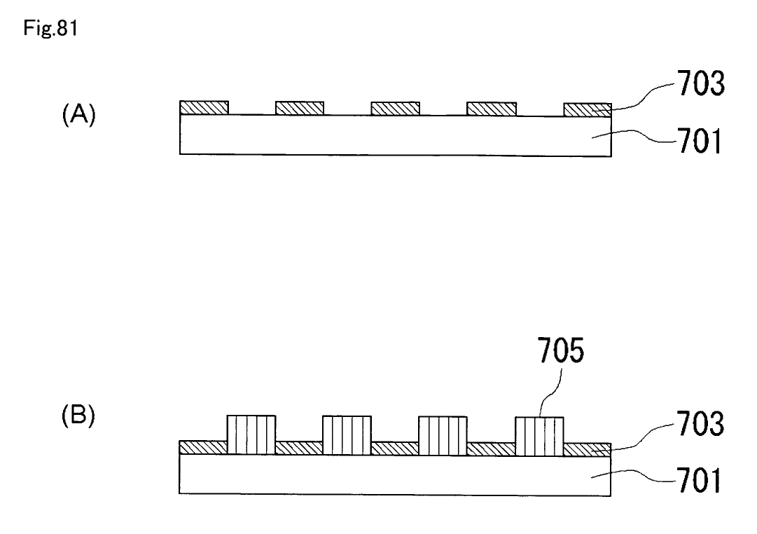

Next, a method of manufacturing the separation region 295 having the structure of the present embodiment will be described by using FIG. 80(A) to FIG. 80(D) and FIG. 81(A) to FIG. 81(B). First, as in FIG. 80(A), an electron beam exposure resist 702 is formed on the substrate 701. Next, patterning exposure is carried out onto the electron beam exposure resist 702 so as to be in a predetermined shape (FIG. 80(B)). When the exposed portion is dissolved and removed, opening portions onto which patterning has been carried out so as to be in a predetermined shape are formed as in FIG. 80(C). Thereafter, oxygen plasma ashing is carried out as in FIG. 80(D)). Note that oxygen plasma ashing is required at the time of forming a submicron-order pattern. This is because, provided that oxygen plasma ashing is carried out, a ground to which a coupling agent is adhered is activated, and a surface suitable for forming a fine pattern can be obtained. On the other hand, the necessity thereof is less in a case of forming a large pattern of a micron-order or more.

After completing ashing, it comes into the state of FIG. 81(A). In the drawing, the hydrophilic regions 703 are formed due to resist dross and contaminator being deposited. In this state, the hydrophobic regions 705 are formed (FIG. 81(B)). As a film forming method of a film structuring the hydrophobic regions 705, for example, a gas phase method can be used. In this case, the substrate 701 and a liquid including a coupling agent having a hydrophobic group are disposed in an airtight container, and those are left for a predetermined time, which forms a film. In accordance with this method, because a solvent or the like is not adhered to the surface of the substrate 701, a processed film having a desired fine pattern can be obtained. A spin coat method can be used as another film forming method. In this case, the hydrophobic regions 705 are formed by carrying out surface processing by applying a coupling agent solution having a hydrophobic group. A 3-thioltriethoxysilane can be used as a coupling agent having hydrophobic group. In addition thereto, a dip method or the like can be used as a film forming method. Because the hydrophobic regions 705 are not deposited on the hydrophilic regions 703, but are deposited only on the exposed portions of the substrate 701, as shown in FIG. 77(A) and FIG. 77(B), a surface structure in which many hydrophobic regions 705 are formed so as to be spaced from one another is obtained.

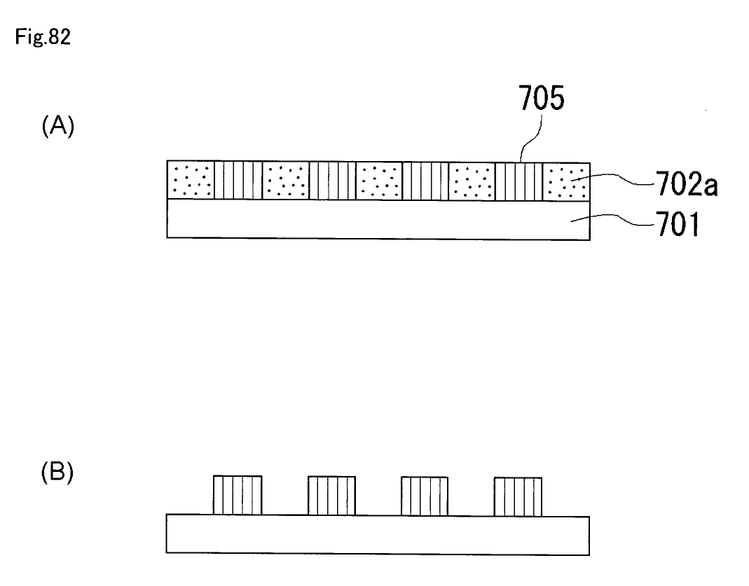

In addition to the processes described above, a surface structure which is the same as that of the above description can be obtained by the following method. In this method, after unexposed portions 702a to which patterning has been carried out are formed as shown in FIG. 80(C), the hydrophobic regions 705 are formed by depositing 3-thiolpropyltriethoxysilane at the resist opening portions as shown in FIG. 82(A) without carrying out oxygen plasma ashing. Thereafter, the structure of FIG. 82(B) is obtained by carrying out wet etching by using a solvent which can remove the unexposed portions 702a selectively. At this time, it is important to select as a solvent one which does not damage the films structuring the hydrophobic regions 705. Such a solvent, for example, acetone or the like can be quoted.

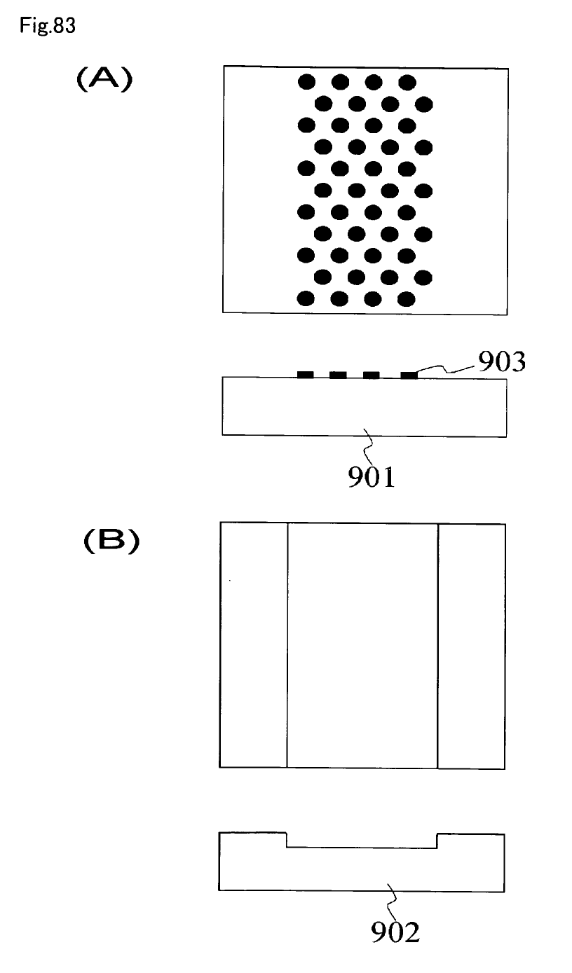

In the above-described embodiment, the hydrophobic regions are formed in the groove portion of the channel. However, the following method can be used in addition thereto. First, two types of substrates are prepared as shown in FIG. 83(A) and FIG. 83(B). A substrate of FIG. 83(A) is structured such that a hydrophobic film 903 made of a compound having a hydrophobic group such as 3-thiolpropyltriethoxysilane or the like is formed on a glass substrate 901. The hydrophobic film 903 is formed in a predetermined patterning shape. The areas at which the hydrophobic film 903 is formed serves as a sample separation unit. On the other hand, a substrate of FIG. 83(B) is structured such that a stripe-shape groove is provided on the surface of a glass substrate 902. A portion of this groove serves as a sample channel. A method of forming the hydrophobic film 903 is as described above. It is possible to easily carry out formation of the stripe-groove on the surface of the glass substrate 902 by wet etching with using a mask. Due to those being stacked onto one another as in FIG. 71(A) and FIG. 71(B), the structure of the present embodiment can be obtained. A space 904 formed by the two substrates serves as a sample channel. In accordance this method, because the hydrophobic film 903 is formed on the flat surface, it is easy to manufacturing it, and the stability in manufacture is satisfactory.

As a method of preparing a coupling agent film, a method can be used in which a film made of a silane coupling agent is formed on the entire surface of the substrate by, for example, an LB film pulling method, and a hydrophilic/hydrophobic micro-pattern is formed.

Moreover, in the present embodiment, only one hydrophobic region can be provided in the separation region 295. In this case, for example, one hydrophobic region provided to extend in a direction of a flow of a sample can be formed in the separation channel having the hydrophilic surface. In this way as well, when a sample passes through the separation channel, it is possible to separate the sample due to the surface property of the sample separation region.

Moreover, the main channel 221 itself can be formed by the hydrophobic processing and the hydrophilic processing described above.

When the channel is formed by hydrophobic processing, portions corresponding to the walls of the channel are formed as hydrophobic regions by using a hydrophilic substrate such as a glass substrate or the like. Because a buffer solution which is hydrophilic goes forward so as to avoid the hydrophobic regions, a channel is formed between the wall portions. The channel may be covered or not with a cover, when a cover is applied thereto, it is preferable to make a gap of several μm from the substrate. The gap can be realized by adhering the cover to the substrate with using around the cut edge of the cover as overlap width, and with using a viscous resin such as PDMS, PMMA, or the like as a glue. In adhesion with only around the cut edge, when a buffer solution is introduced, the hydrophobic regions repel water, which forms a channel.

On the other hand, when the channel is formed by hydrophilic processing, a hydrophilic channel is formed on a hydrophobic substrate or a surface of a substrate which is made hydrophobic by silazane processing or the like. In this case as well, because a buffer solution goes into only the hydrophilic region, the hydrophilic region can be made to be a channel.

Moreover, the hydrophobic processing or the hydrophilic processing can be carried out by using a printing technique such as a stamp, ink jet printing, or the like. In a method by a stamp, a PDMS resin is used. With respect to a PDMS resin, silicone oil is polymerized to be a resin. However, it is in a state in which gaps among molecules are filled with silicone oil even after resinification. Therefore, when a PDMS resin is made in contact with a hydrophilic surface, for example, a glass surface, the contact portion is made strongly hydrophobic, which repels water. By utilizing this, due to a PDMS block in which concave portions are formed in a position corresponding to a channel portion being in contact with a hydrophilic substrate as a stamp, the channel by the hydrophobic processing described above can be easily manufactured.

In a method by ink jet printing, silicone oil of a type with a low viscosity is used as an ink for ink jet printing, and a hydrophilic resin thin film, for example, polyethylene, PET, cellulose acetate, cellulose thin film (cellophane), or the like is used as a printing paper. The same effect can be obtained by printing in a pattern such that silicone oil is adhered to channel walls.

Moreover, a filter which allows substances in sizes less than a specific size to pass through, and does not allow substances in sizes greater than or equal to a specific size to pass through may be formed in the channel by forming hydrophobic patches or hydrophilic patches in predetermined shapes by hydrophobic processing and hydrophilic processing.

For example, when a filter is structured from hydrophobic patches, due to patches being linearly disposed repeatedly at constant intervals, a broken line form filter pattern can be obtained. An interval between the hydrophobic patches is made larger than a size of substances for which an attempt to pass through is made, and is made smaller than a size of substances for which an attempt to pass through is not made. For example, when an attempt is made to remove substances greater than or equal to 100 μm, an interval between the hydrophobic patches is set to be narrower than 100 μm, for example, to 50 μm.

The filter can be realized by integrally forming the hydrophobic region pattern for forming a channel and the aforementioned pattern of the hydrophobic patches formed in a broken line form. As a forming method, a method by photolithography and a SAM film formation described above, a method by a stamp, and a method by ink jet, or the like can be appropriately used.

Note that, when a filter is structured in a channel, a filter plane may be formed to be perpendicular to a flow direction, or a filter plane may be formed to be parallel to a flow direction. When a filter plane is formed to be parallel to a flow direction, as compared with a case in which a filter plane is formed to be perpendicular to a flow direction, there is the advantage that it is hard for substances to clog, and a broad area of the filter can be taken. In this case, provided that the width of the channel portion is made to be broader to some extent, for example, 1000 μm, and 50 μm×50 μm square hydrophobic patches are formed in a direction of a flow in the channel so as to have a gap of 50 μm each other, the channel can be divided into two in the flow direction. When a liquid including substances to be separated is introduced from one side of the divided channels, a filtrate from which substances greater than 50 μm included in the liquid have been removed flows out to the other channel. In accordance therewith, substances can be condensed at one side of the channels.

Due to the separation region 295 being structured as described above, separation on the chip can be efficiently and certainly carried out.

### Twelfth Embodiment

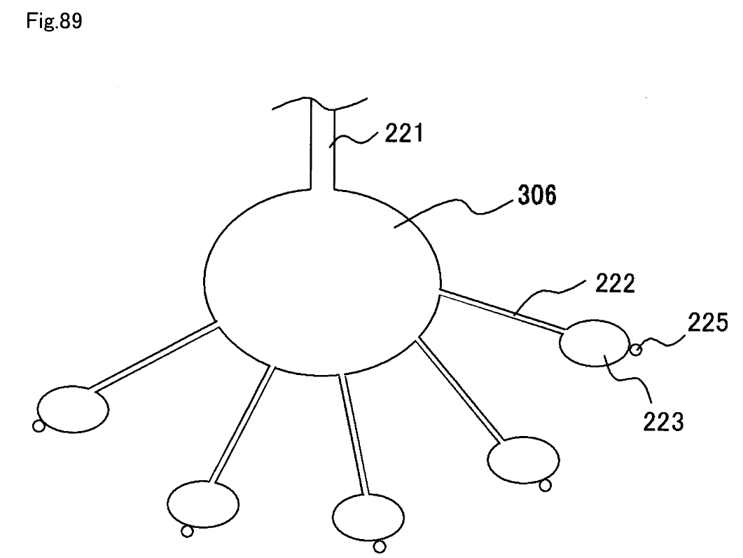

In the above embodiment, it may be structured such that a plurality of the dispensing channels 222 diverge from one region on the channel. FIG. 89 is a diagram showing a channel structure of a chip relating to the present embodiment. In the chip of FIG. 89, a plurality of the dispensing channels 222 diverge from a reservoir 306 provided on the main channel 221 at downstream of the separation region 218. A plurality of channels having the detection reservoirs 223 are provided at downstream of the respective dispensing channels 222, and a sample introduction channel which crosses the channels and which is aimed at introducing a sample into the separation region is provided.

Provided that such a structure is used, the sample can be introduced into the dispensing channels 222 after the component concentration in a sample are homogenized in the reservoir 306. Therefore, it is possible to carry out precise detection reaction in the detection reservoirs 223.

Note that, in FIG. 89, the structure in which five dispensing channels 222 diverge from the reservoir 306 is shown. However, a number of the dispensing channels 222 can be arbitrarily selected in accordance with a detecting item or a measuring item. Further, the case of the structure in which the detection unit 214 is provided as an analysis unit, and the detection reservoirs 223 are provided at downstream of the dispensing channels 222 has been described above as an example. However, in a case of a chip having the measurement unit 233 as an analysis unit as well, radial dispensing channels can be formed in the same way by providing the sorting units 235 at downstream of the dispensing channels 222.

### Thirteenth Embodiment

In the chip relating to the above embodiment, the dispensing channels for a sample from the main channel 221 to the reservoirs (the detection reservoirs 223 or the sorting units 235) structuring the analysis unit may be structured as follows. Hereinafter, a case of the chip having the detection unit 214 will be described as an example. However, the same structure can be applied to the chip having the measurement unit 233 as well.

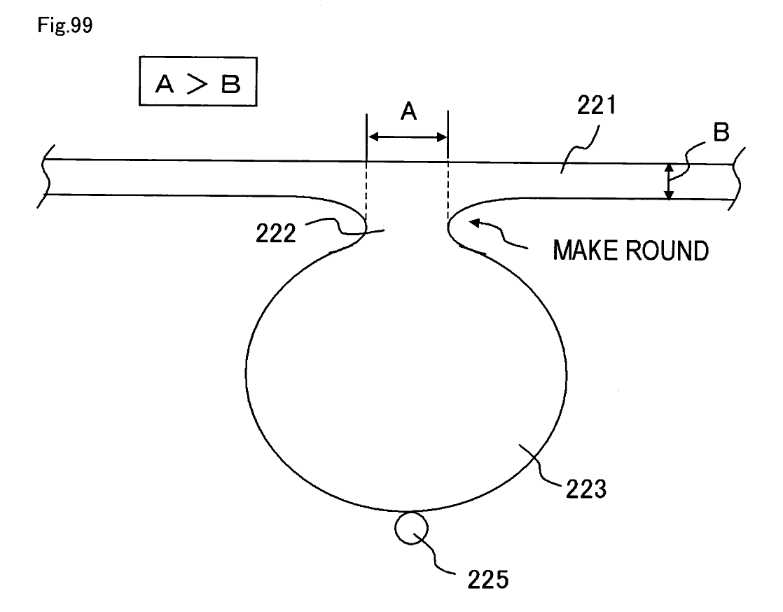

FIG. 99 is a diagram showing the structure of the detection unit 214. In this detection unit 214, it is formed in a shape such that the dispensing channel 222 is enlarged toward the main channel 221 and the detection reservoir 223. In this way, due to the dispensing channel 222 being made to have a curvature, it is possible to smoothly dispense a sample from the main channel 221 to the detection reservoir 223 without generating bubbles. Further, in FIG. 99, opening width A of the main channel 221 at the diverging point to the detection reservoir 223 is made broader than width B of the main channel 221. In accordance therewith, it is possible to more efficiently dispense a sample to the detection reservoir 223.

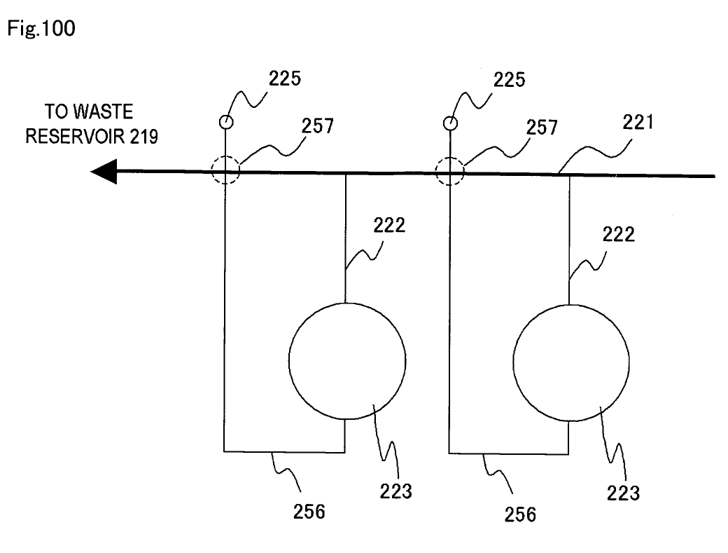

FIG. 100 is a diagram showing another structure of the detection unit 214. In this detection unit 214, the trigger channel 256 is communicated with the detection reservoir 223. The trigger channel 256 is communicated with the main channel 221 at downstream of the dispensing channel 222 via the liquid switch 257. Provided that such a structure is used, liquid is filled in the order corresponding to the detection reservoir 223 provided at the upstream side, and after one detection reservoir 223 is filled with the liquid, the following detection reservoir 223 is filled up. Therefore, a specific quantity of liquid can be efficiently dispensed into the detection reservoirs 223. Note that, in FIG. 100, the case in which there are two detection reservoirs 223 has been described as an example. However, a number of the detection reservoirs 223 can be arbitrarily selected.

### Fourteenth Embodiment

In the embodiment shown above, the structure of the sample introduction unit 212 may be made as follows. Hereinafter, a structure in which the sample introduction unit 212 is communicated with the main channel 221 will be described as an example. However, the same structure can be applied to the case as well in which the sample introduction unit 212 is communicated with other channels.

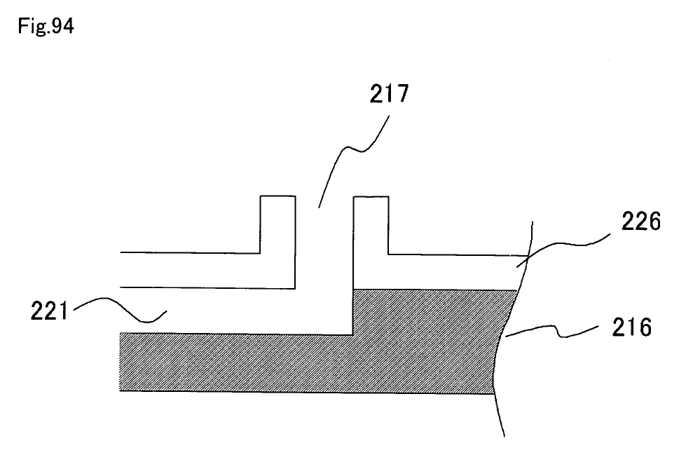

FIG. 94 is a cross-sectional view showing a structure of the sample introduction unit 212 of the present embodiment. In the sample introduction unit 212 of FIG. 94, it is structured such that the top face of the inlet 217 is higher than the top face of the main channel 221. By the structure being made such that the top face of the inlet 217 is higher than the top face of the main channel 221, or the top face of the reaction reservoir 280 and other reservoirs, a water level of a sample in the inlet 217 can be maintained to be higher than a water level in the main channel 221 or the like. Therefore, it is possible to apply an appropriate pressure to the sample introduced in the inlet 217. Therefore, the sample can be certainly moved to the main channel 221, and moreover, the sample can be certainly moved to downstream side in the main channel 221.

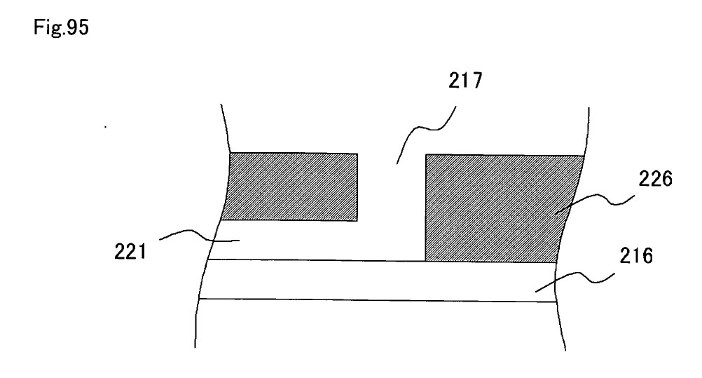

FIG. 95 is a cross-sectional view showing another example of the sample introduction unit 212 which is structured such that the top face of the inlet 217 is higher than the top face of the main channel 221. As shown in FIG. 95, in the case as well in which a gap between the substrate 216 and the cover 226 serves as the main channel 221, for example, due to a hole through which the cover 226 is made to penetrate being the inlet 217, a water level of a sample in the inlet 217 can be maintained to be higher than a water level in the main channel 221 or the like.

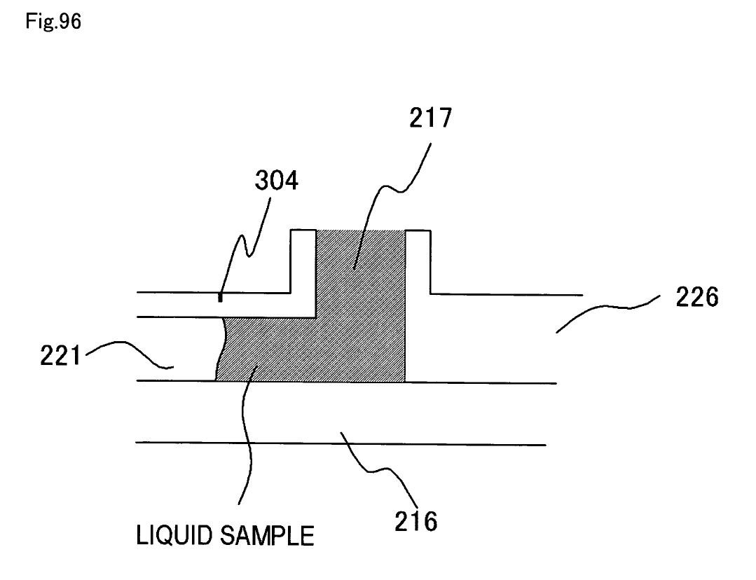

FIG. 96 is a cross-sectional view showing an example of another structure of the sample introduction unit 212. FIG. 96 has a structure in which, in the same way as in FIG. 95, the main channel 221 is formed in a gap between the substrate 216 and the cover 226. However, convex portions serving as the side walls of the inlet 217 are provided at the cover 226. In accordance therewith, a water level in the inlet 217 can be more certainly maintained to be higher than a water level in the main channel 221 or the like.

Further, in FIG. 96, a scale 304 is provided at a predetermined position on the main channel 221. It is possible to certainly introduce a specific quantity of sample from the inlet 217 into the chip by the cover 226 being structured from a transparent material, and by providing the scale 304.

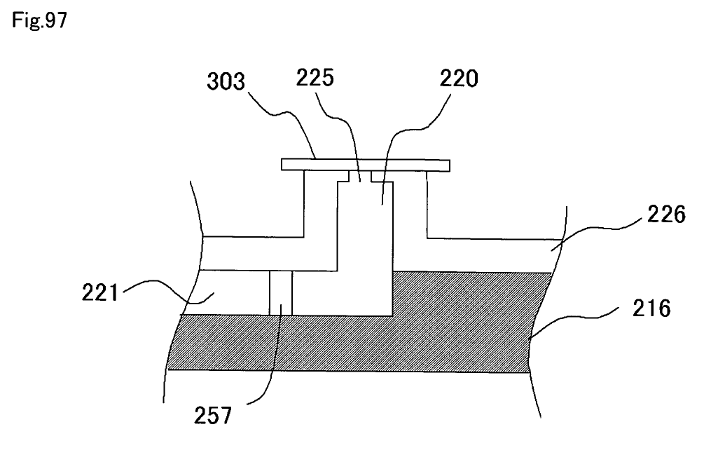

Note that the reservoirs other than the sample introduction unit 212 may be structured such that a water level higher than that of the main channel 221 is maintained. For example, in the structure of FIG. 101 relating to the first embodiment, the buffer inlet 220 may be structured so as to be shown in the cross-sectional view of FIG. 97. In FIG. 97 as well, a part of the cover 226 is projected such that the top face of the buffer inlet 220 is made higher than the main channel 221. Further, the top face of the buffer inlet 220 is sealed with a sealing unit 303. In this structure, by peeling off the sealing unit 303 at a predetermined timing, the air hole 225 is exposed, and a movement of the buffer in the buffer inlet 220 is started. Therefore, it is possible to certainly make the buffer flow into the main channel 221 at a desired timing. Further, as shown in FIG. 97, it may be structured such that the liquid switch 257 for making a buffer introduced in the buffer inlet flow into the main channel 221 at a desired timing is further provided.

### Fifteenth Embodiment

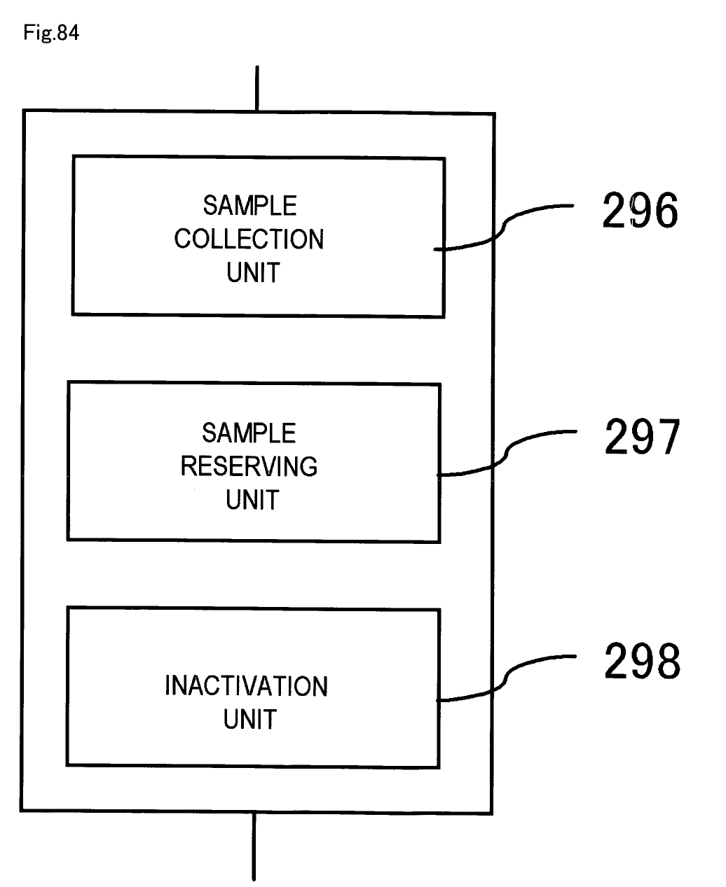

In the embodiments shown above, the structure of the sample introduction unit 212 may be made as follows. FIG. 84 is a functional block diagram showing the structure of the sample introduction unit 212 more in detail. In FIG. 84, the sample introduction unit 212 has a sample collection unit 296, a sample reservoir unit 297, and an inactivation unit 298.

The sample collection unit 296 has a function of collecting a sample to be introduced in the chip. As such a structure, for example, a structure in which puncture needles are provided at the side faces of the chip can be quoted.

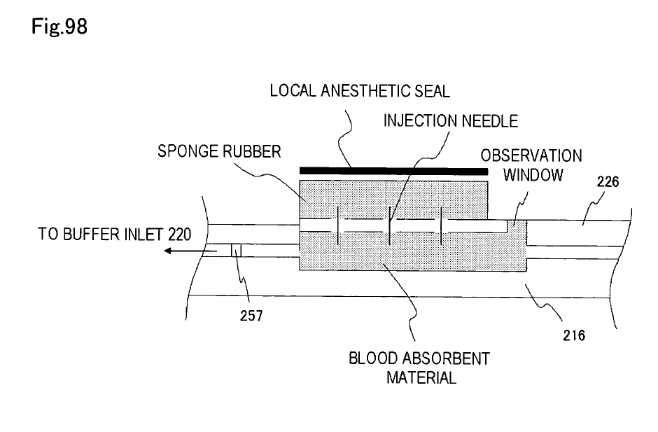

FIG. 98 is a cross-sectional view showing one example of the structure of the sample collection unit 296 for collecting blood. The sample collection unit 296 of FIG. 98 has a structure in which several minute injection needles are fixed onto the substrate 216. The injection needles may be made of stainless steel of 27 G (gauge) or less and about 30 G, an outside diameter of about 0.2 mm, and an inside diameter of about 0.1 mm.

The lumens of the injection needles are communicated with a blood absorbent material. As a blood absorbent material, for example, a silica gel powder layer, a minute glass wool layer, or the like can be used. Further, a blood coagulation inhibitor (not illustrated) is coated onto the surface of the blood absorbent material. As a blood coagulation inhibitor, for example, a slight quantity of heparin sodium or EDTA, or the like can be used. Covering can be carried out by dipping the blood absorbent material in a liquid including a blood coagulation inhibitor, and by drying it.

Further, the blood absorbent material is communicated with the main channel 221, and an observation window is provided at a part of the main channel 221. By providing the observation window, it can be easily judged whether or not the blood absorbent material is filled with blood. The blood absorbed in the blood absorbent material is washed out by an extracting buffer introduced in the buffer inlet 220. In this way, blood is introduced into the main channel 221.

Further, the peripheries of the injection needles are covered with a sponge rubber. A local anesthetic seal including a local anesthetic is fixed to the surface of the sponge rubber. The local anesthetic seal may be, for example, hydrogel including lidocaine. Further, an intensity of the local anesthetic seal is made to be an extent that the local anesthetic seal can be easily penetrated through by the injection needles.

The sample collection unit 296 of FIG. 98 is used along the procedure of the following (i) to (vi). In accordance therewith, blood is collected and introduced into the main channel 221.

(i) The seal 227 of the chip is peeled off, and the puncture unit is exposed.

(ii) The puncture unit is weakly pinched for about two minutes. In accordance therewith, the skin surfaces of fingers are anesthetized.

(iii) The sponge is strongly pinched to an extent that the sponge is squashed flat. In accordance therewith, the injection needles stick into the skins.

(iv) The pinching pressure is released. Then, blood is introduced into the blood absorbent material by a capillary effect.

(v) It is confirmed by observing a change in a color from the observation window whether or not the blood absorbent material is filled with blood. When the blood absorbent material is filled with blood, the fingers pinching it are released.

(vi) An extracting buffer is introduced into the buffer inlet 220, and the blood is extracted into the main channel 221. Or, as shown in FIG. 98, it may be structured such that a liquid switch is provided on the route through which the blood absorbent material and the buffer inlet 220 are communicated with one another, and the liquid switch is opened when blood is filled up.

In accordance with the structure of FIG. 98, because blood is collected while the fingers are pinching the sponge, it is possible to ease a pain at the time of collecting blood. Further, because of a structure in which blood to be collected cannot be seen, it is possible to ease a psychological burden on collection of blood.

To be back to FIG. 84, the sample reservoir unit 297 has a function that collected samples are gone into and are reserved. For example, the sample reservoir unit 297 may be the inlet 217 or the like in the above embodiments.

Further, the inactivation unit 298 is a site having a function of inactivating samples remaining in the sample reservoir unit 297 or the like. For example, it may be a structure having a reservoir in which an antiseptic solution is reserved, and a channel into which the antiseptic solution in the reservoir is introduced into the inlet 217 in a predetermined timing.

Provided that such a structure is used, a series of procedures in which, for example, blood is collected, and predetermined components in the blood are separated, and detection and measurement thereof are carried out, can be continuously executed by using one chip. Furthermore, because sterilization of the chip after use can be carried out by the structural elements in the chip, the chip can be simply sterilized, and can be discarded in safe hands.

### Sixteenth Embodiment

In the chip relating to the above embodiments, separation and analysis of components in a sample can be carried out as follows. In the present embodiment, substances to be detected in a sample are immunologically detected or quantified by an immunological detection method of separating condensed beads. In a chip using this mechanism, substances to be detected are detected or quantified by condensation of beads.

As a method of quantifying substances to be detected by utilizing condensation of beads, there is a latex-beads condensation method. In this method, an antigen with respect to an antibody to be detected or an antibody with respect to an antigen to be detected is coated in advance onto the surfaces of minute beads, which are formed from latex or the like, and whose diameters are from several μm to several ten μm. When a bead liquid in which the beads are suspended in a buffer and a sample are mixed with one another, for example, an antigen on the surfaces of the beads and an antibody in the sample are coupled with one another. At this time, because the antibody has a plurality of coupled portions (epitopes), the beads condense by coupling with one another over the antigen, and are deposited.

When a chip having the measurement unit 233 as an analysis unit is used, this condensed state can be optically measured as a scattering intensity by the measurement unit 233 (FIG. 7 and the like). Further, when a chip having the detection unit 214 as an analysis unit is used, an analysis of substances to be detected in a sample is carried out by sensing that the beads are deposited and turbidity disappears, by the detection unit 214 (FIG. 1 and the like). A concentration of substances to be detected can be measured by, for example, a dilution rate of a sample causing condensation. Further, because the higher the concentration of substances to be detected is, the faster the beads condense, the concentration of substances to be detected can be measured by measuring a time change in turbidity or a speed of precipitation.

In the chip of the present embodiment, substances to be detected are detected by utilizing the fact that the beads make an aggregate, and when the diameter thereof is made large, a traveling speed in a separation region of the channel (separation channel) is varied. In this method, a bead liquid mixed with a sample liquid is made to flow into the separation channel, which are described above in, for example, the eighth to eleventh embodiments, in which the pillars or the like are disposed. Concretely, the pillars in the separation channel are formed in patch forms described above in the ninth embodiment. At this time, the condensed bead block is designed so as to be unable to go into the inside of the pillar patch, and so as to move among the patches.

In the separation channel, the condensed bead block moves faster than uncondensed beads. Therefore, it can be judged whether or not condensation of beads is brought about by judging whether or not the beads reach a given distance in a predetermined time by using a judgment window 502. In accordance therewith, substances to be detected in a sample can be detected. Further, the bead base materials such as latex or the like is colored in advance so as to be visible, accordingly, it is possible to more clearly judge.

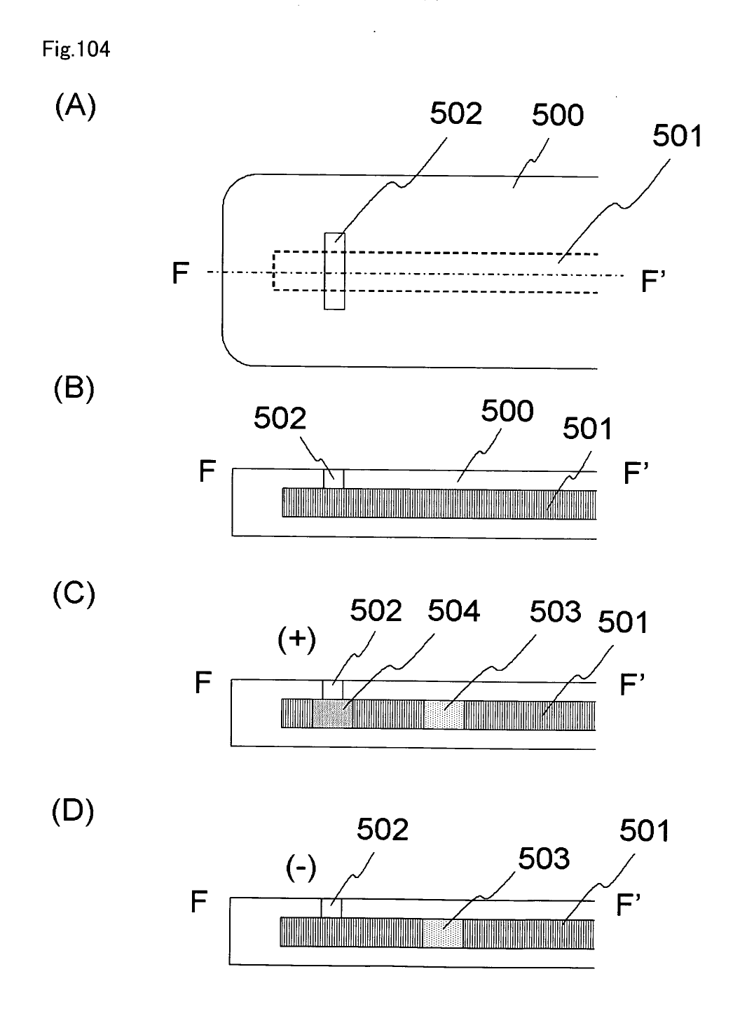

FIG. 104(A) is a plan view schematically showing a structure of the chip relating to the present embodiment. Further, FIG. 104(B) to FIG. 104(D) are cross-sectional views taken along F-F′ of FIG. 104(A). As shown in FIG. 104(A) and FIG. 104(B), a separation channel 501 is provided as the separation unit 213 inside the substrate 500 of the chip relating to the present embodiment, and a judgment window 502 is provided as the detection unit 214 at downstream thereof. The separation channel 501 is, for example, a part of the main channel of the chip described in the above embodiments, and the concrete structure thereof is, for example, the channel in which the pillars are disposed in patch forms which have been described above in the ninth embodiment.

In FIG. 104(A) and FIG. 104(B), when a mixture of beads and a sample flows from the right side in the drawing, in a case in which there are substances to be detected in the sample, because a condensed bead block is generated, the beads are not trapped in the pillar patches, and immediately move in the separation channel 501, and a condensed bead block 504 reaches the judgment window 502 portion after a given time. Further, when colored bead base materials are used, it can be known that the beads have reached by visually recognizing, through the judgment window 502, the fact that a predetermined region in the channel is colored in a color coming from the bead base materials due to generation of the condensed bead block 504 (FIG. 104(C)) after a predetermined time has passed.

On the other hand, when substances to be detected are not included in the sample, the beads move in a state of uncondensed beads 503 without being condensed. As a result, after a predetermined time has passed, a region directly beneath the judgment window 502 in the separation channel 501 is not colored.

Accordingly, it is judged whether or not the inside of the separation channel 501 in the vicinity of the judgment window 502 is colored after a given time after the beads mixed with the sample have been introduced into the separation channel 501, and when it is colored, it can be judged that the substances to be detected are included in the sample (positive (+): FIG. 104(C)), and when it is not colored, it can be judged that the substances to be detected are not included in the sample (negative (−): FIG. 104(D)).

Moreover, by providing a plurality of judgment windows 502 along the separation channel 501, or by providing the transparent cover 226 (FIG. 3) on the entire surface of the top face of the separation channel 501, and by providing a scale along the separation channel 501, it is possible to qualify the concentration of substances to be detected in a sample. Because, when the concentration of substances to be detected in a sample is high, because a bead block of the condensed beads 504 rapidly grows, and the diameter thereof is made larger, the bead block reaches the end portion at the downstream side of the separation channel 501 faster.

For example, in the chip shown in FIG. 104(A) and FIG. 104(B), when a plurality of the judgment windows 502 are provided along a direction of extending the channel on the separation channel 501, and the states of coloring those judgment windows 502 are judged after a given time, coloring up to the judgment window 502 close to the left end in the drawing of the separation channel 501 means that the concentration of substances to be detected in a sample is high, and coloring only the judgment window 502 distant from the left end means that the concentration of substances to be detected is low. Therefore, provided that the positions of the judgment windows 502 and the concentrations of substances to be detected in a sample are corresponded to one another, a concentration of substances to be detected in a sample can be measured by sensing up to which judgment window 502 has been colored. Further, because there is a bead block of the condensed beads 504 which has most grown at the front end position of the colored portion, it is possible to measure a concentration of substances to be detected in a sample by reading which position the front end position of a colored portion reaches after a given time, by utilizing a scale. This is because that a size of the most grown bead block as well reflects a concentration of substances to be detected in a sample.

Note that, in the above description, the example of using the separation channel 501 in which the larger bead block moves faster has been shown. In contrast thereto, even in a case of using a separation channel in which uncondensed smaller beads move faster as well, it is possible to separate and detect substances to be detected. In that case, in the separation channel, obstacles such as, for example, the pillars described above in the ninth embodiment are regularly disposed so as to be separated by about several times as long as a diameter of a bead. Particles in smaller sizes flowing in the separation channel can move faster so as to thread the gaps among the obstacles. However, the larger the particle size is, the more the frequency of bumping against the obstacles is increased, and as a result, the particles must move slowly. In a case of using such a separation channel, because a condensed block of larger beads remains at more front side, when a concentration of substances to be detected is measured by providing a plurality of the judgment windows 502, it is interpreted that a concentration of substances to be detected is higher in a case in which a judgment window at a side nearer from a sample introduction path (not illustrated) at the upstream side of the separation channel (in the left side in FIG. 104(A)) is colored, and when it is measured by utilizing a scale, it is possible to measure a concentration of substances to be detected by reading a position at the last trailing edge of the beads at which there is a maximum condensed block.

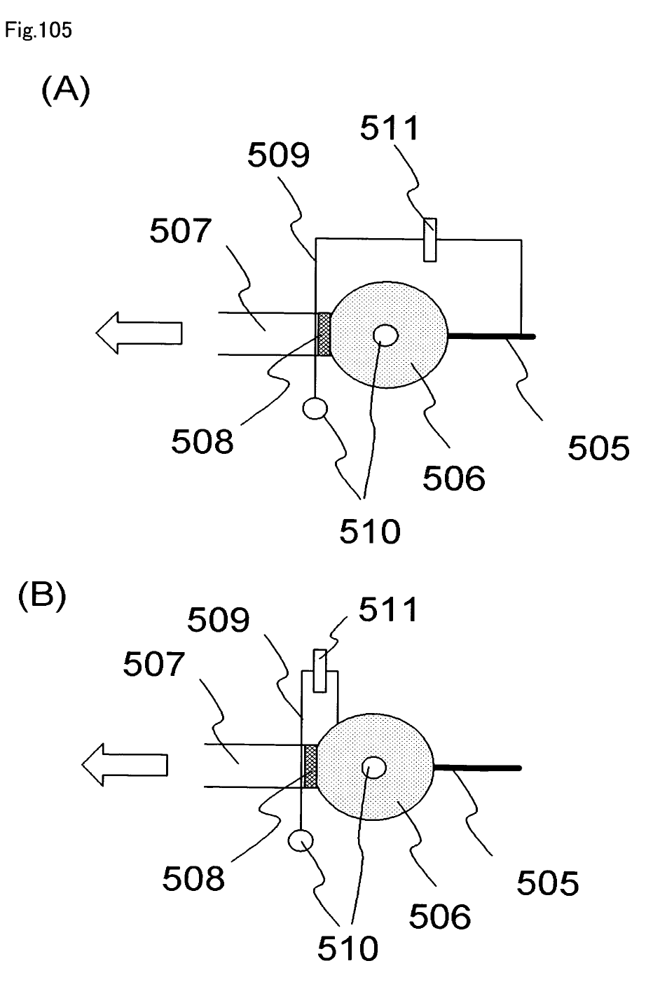

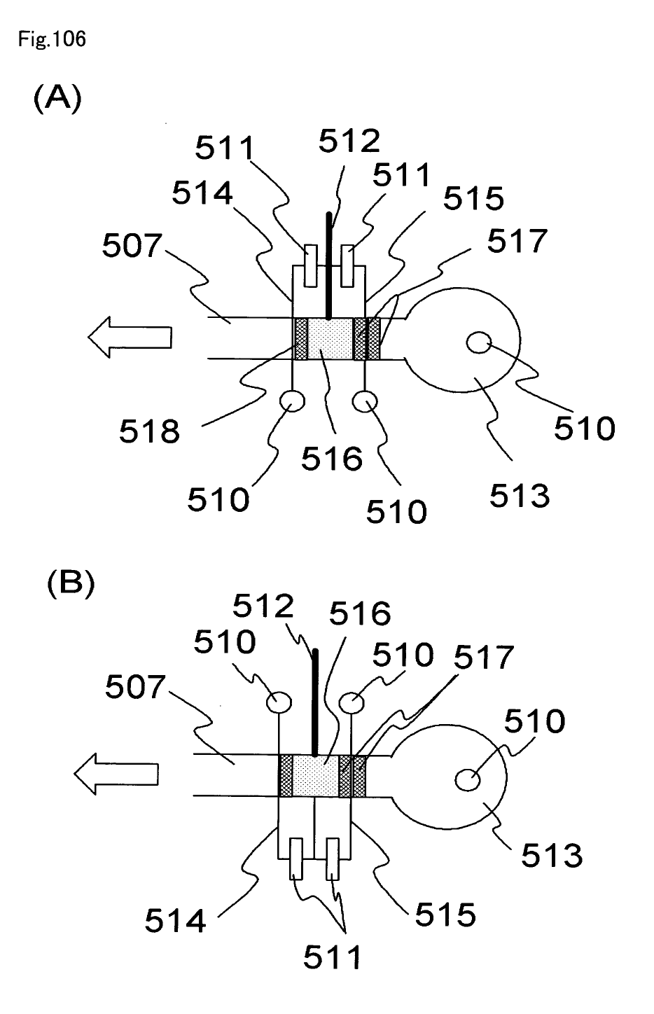

Next, a structure of an introduction mechanism in which a sample liquid and a bead liquid are mixed up and it is introduced into the separation channel 501 in the separation unit 213 (FIG. 1 and the like) will be described. FIG. 105(A), FIG. 105(B), FIG. 106(A), and FIG. 106(B) are plan views showing examples in which the introduction mechanism for a sample liquid and a bead liquid is realized by utilizing a liquid switch. FIG. 105(A) and FIG. 105(B) are used for chip having, for example, a structure in which a bead liquid mixed with a sample is not necessarily distributed in pulse form, and a front end position of a flow of colored beads is read. Because there is a bead block which has most grown at the front end of colored portion, it is possible to quantify substances to be detected even focusing on a front end position thereof.

The introduction mechanism shown in FIG. 105(A) is composed of a sample introduction path 505, a bead reservoir 506, a separation channel 507, and a liquid switch. The liquid switch is structured from a trigger channel 509, a delay channel 511, a damming portion 508, and air holes 510. The sample introduction path 505 may be structured, for example, so as to be communicated with the inlet 217 (FIG. 2 and the like) in the above embodiments. Further, the sample introduction path 505 may be structured so as to be communicated with the pretreatment unit 266 (FIG. 24 and the like), and such that a sample after pretreatment is moved to the sample introduction path 505. The bead reservoir 506 is communicated with the sample introduction path 505, and is connected to the separation channel 507 via the damming portion 508. Further, in the chip of the present embodiment, the basic structure and operation of the liquid switch are as described above in the third embodiment.

First, a suspension of minute beads (bead liquid) to which coating of antigen for detection or the like has been applied is retained in the bead reservoir 506. The inside of the bead reservoir 506 is communicated with the separation channel 507. However, because the damming portion 508 formed by applying hydrophobic surface processing thereto is provided therebetween, it is in a state in which it does not flow downstream further from the damming portion 508 (in the left side in the drawing).

When a sample liquid is introduced in the sample introduction path 505, the sample liquid flows into the bead reservoir 506 to be mixed with the bead liquid, and additionally, and diverges to the trigger channel 509 in front of the bead reservoir 506. The delay channel 511 is provided to the trigger channel 509 communicated with the separation channel 507 downstream of the damming portion 508, and in a suitable timing the bead liquid and the sample liquid are sufficiently mixed up in the bead reservoir 506, the sample liquid is introduced into the damming portion 508 portion to open the damming portion 508. As a result, the bead liquid mixed with the sample flows out to the separation channel 507.

In FIG. 105(A), the trigger channel 509 diverges from the sample introduction path 505 before going into the bead reservoir 506. However, as in FIG. 105(B), the trigger channel 509 can be made to diverge from the bead reservoir 506. In that case, due to the base point of the trigger channel 509 positioned at the uppermost end of the bead reservoir 506, it can be structured such that the trigger channel 509 is not filled up till the sample is sufficiently introduced in the bead reservoir 506. Therefore, the dependability in operations can be further improved.

Further, in FIG. 105(A) and FIG. 105(B), because the bead liquid is not distributed in pulse form, and a position at the front end portion of colored beads is merely observed, there may be a case in which it is difficult to precisely read the position when a quantity of the bead block at the front end portion is not sufficient. In the introduction mechanism shown in FIG. 106(A), this is improved by making a bead liquid be distributed in pulse form along a direction of extending the separation channel 507.

The introduction mechanism in FIG. 106(A) is composed of a sample introduction path 512, a buffer reservoir 513, the separation channel 507, and a bead reservoir 516, and additionally, a buffer reservoir trigger channel 515, a bead reservoir trigger channel 514, buffer reservoir damming portions 517, and a bead reservoir damming portion 518, air holes 510, and delay channels 511 which structure a liquid switch. First, a buffer liquid and a bead liquid are respectively filled in the buffer reservoir 513 and the bead reservoir 516.

The respective interiors of the buffer reservoir 513 and the bead reservoir 516 are communicated with the separation channel 507. However, because there are respectively the buffer reservoir damming portions 517 and the bead reservoir damming portion 518, the liquids are retained so as not to go forward in the separation channel 507. In particular, the bead reservoir 516 keeps a distribution in pulse form along a direction of extending the separation channel 507 by being sandwiched by the buffer reservoir damming portions 517 and the bead reservoir damming portion 518. The buffer reservoir damming portions 517 are provided at two areas in order to prevent the counterflow from the bead reservoir 516 to the buffer reservoir trigger channel 515. However, when the buffer reservoir trigger channel 515 is filled up, the damming effect disappears in the same way as in a case in which there is one damming portion.

When a sample liquid is introduced into the sample introduction unit 512, the sample liquid flows into the bead reservoir 516, and is mixed with the bead liquid there. On the other hand, the sample liquid diverges into two trigger channels of the buffer reservoir trigger channel 515 and the bead reservoir trigger channel 514 before flowing into the bead reservoir 516. The delay channels 511 are provided to the respective trigger channels, and the buffer reservoir damming portions 517 and the bead reservoir damming portion 518 are opened at a timing that the bead liquid and the sample liquid are sufficiently mixed up in the bead reservoir 516. As a result, the bead liquid distributed in pulse form moves in the separation channel 507 so as to be drifted by the buffer solution.

Note that, in FIG. 106(A), the trigger channel diverges before the sample liquid reaches the bead reservoir 516. However, in the same way as in the case of FIG. 105(B), it is possible for the trigger channel to diverge after the sample liquid reaches the bead reservoir 516. As in FIG. 106(B), in accordance with the structure in which the trigger channel is made to diverge after the sample liquid reaches the bead reservoir 516, the certainty of operations can be further improved.

In the chip of the present embodiment, because beads which condense so as to be specifically adsorbed to predetermined components (substances to be detected) in a sample are provided in the separation unit 213, it is possible to more certainly separate the predetermined components in a sample, and to analyze the separated components in the detection unit 214 or the measurement unit 233.

The present invention has been described above based on the embodiments. These embodiments are just illustrations, and it can be understood by those skilled in the art that various modifications are possible, and such modifications are within a range of the present invention.

For example, the cases in which the shapes of the detection reservoir 223 and the sorting unit 235 which are provided in the chip are mainly cylindrical have been shown as the examples. However, it suffices for those to be shaped such that an analysis (detection or measurement) of the contents is carried out, and the shapes can be appropriately selected regardless of a cylindrical shape. For example, the shapes of the detection reservoir 223 and the sorting unit 235 can be made to be rectangular columns such as a square pole or the like. Further, the detection reservoir 223 and the sorting unit 235 may be not necessarily a diverticulum shape, and for example, as described above with reference to FIG. 14, the detection reservoir 223 and the sorting unit 235 may be a channel shape.

Further, in the above description, with respect to the other reservoirs other than the detection reservoir 223 and the sorting unit 235, for example, the inlet 217, the waste reservoir 219, the buffer inlet 220, the reservoir 224, or the like which are provided in the chip shown in FIG. 2 as well, it suffices for those to ensure sufficient volumes for retaining liquid to be introduced or recovered into the respective reservoirs, those may be made to be shapes other than a cylindrical shape. The shapes of the reservoirs provided in the chip may be, for example, rectangular columns such as a square pole or the like, or a predetermined planar shaped channel form. Further, a shape of the waste reservoir may be, for example, a zigzag type channel form in a plan view, or a columnar form in which convex-concave is formed inside. In accordance therewith, because a surface area of the waste reservoir can be increased, it can be structured such that a capillary effect is further improved, and it is possible more certainly recover waste liquid.

Further, in the chip having the measurement unit 233, it may be a form in which components in a sample sorted in the sorting unit 235 are extracted to be provided for measurement by an external device. Concretely, the respective components sorted on the chip may be introduced into an ESI (electrospray ionization) device by an electroosmotic flow or the like. At this time, it may be structured such that a clock channel communicated with the respective dispensing channels 222 on the chip is provided, and the sorted components are sequentially introduced into the ESI device. In accordance therewith, mass spectrometry with respect to the sorted respective components can be efficiently carried out.

Further, when the sorted components in the sample are provided for measurement by an external device, capillaries of a capillary spectrographic analysis device may be provided at the front ends of the respective dispensing channels 222. Provided that the capillaries are made to projected from the front end of the chip, the projected capillaries are inserted into the spectrographic analysis device in place of capillary cells, which enables measurement.

Further, the case in which a sample is introduced by a capillary effect, and is moved in the chip has been described above as an example. However, an external device such as a microsyringe pump or the like can be used.

Further, in the chip having the detection unit 214, it may be structured such that it is possible to quantify components in a sample by observing the detection unit 214 with naked eyes. Concretely, methods of the following (i) to (vi) can be used.

(i) Utilization of chemical substance sensitive gel (CSG)

(ii) Utilization of chemical substance sensitive fluid

(iii) Utilization of array of detection reservoirs for each component concentration

(iv) Utilization of glossy layer

(v) Utilization of total reflection on the surface of detection reservoir

(vi) Utilization of interference fringe

In the above-described (i), CSG means a gel whose volume is swelled or contracted dependently on a concentration of substances to be detected. When this is used, provided that the detection reservoir 223 is made to be a channel narrowing toward the downstream side, and colored CSG beads are introduced in the detection reservoir 223, the sizes of the CSG beads change in accordance with a concentration of components to be detected. According as the CSG beads are swelled, the CSG beads cannot go forward to the downstream side of the detection reservoir 223, and are dammed up at the upstream side. Therefore, provided that a scale is provided in advance on the cover 226 by finding the relationship between a component concentration and a CSG position, it is possible to quantify a component concentration with eyes based on a stopping position of the CSG beads in the detection reservoir 223.

In the above-described (ii), the chemical substance sensitive fluid means a fluid whose viscosity varies in accordance with a concentration of substances to be detected. As such a fluid, for example, a polymer solution or the like can be used. When this is used, the detection reservoir 223 is formed so as to be a long and thin channel form, and a chemical substance sensitive fluid and visible beads are filled in advance into the detection reservoir 223. When the viscosity of the fluid varies in accordance with a component concentration in the liquid dispensed in the detection reservoir 223, the traveling speed of the beads varies. Therefore, it is possible to quantify a component concentration by observing a position of the beads with eyes after a given period of time.

In a case of the above-described (iii), it is structured such that one object to be detected is dispensed into a plurality of the detection reservoirs 223, and the component concentrations dispensed into these detection reservoirs 223 are made different at a constant rate. Then, detection reactions in the respective detection reservoirs 223 are made to be coloring reactions or the like which can be visually recognized. In accordance therewith, depending on coloring being brought about up to detection reservoir 223 of what component concentration, it is possible to convert the result into a component concentration.

In a case of the above-described (iv), a glossy layer such as a silver paper or the like is provided on the bottom face of the substrate 216 under the detection reservoirs 223. When the detection reservoirs 223 are observed from above at a given accuracy, in accordance with a refractive index of a liquid in the detection reservoirs 223, in some cases, the glossy layer can be observed to be seen brightly, and the glossy layer cannot be observed to be seen and can be observed to be seen darkly. By using this, alteration in the refractive index in a liquid according to components in a sample can be visually sensed. For example, in the case of the above-described (i), even if the beads are not colored, a stopping position of the beads can be easily measured visually.

In a case of the above-described (v), a layer made of a low refractive index material is formed on the surface of the detection reservoir 223. When a liquid goes into such detection reservoir 223, in some cases, total reflection is caused at the interface between the surface of the detection reservoir 223 and the liquid in accordance with a refractive index of the liquid. When total reflection is caused, the detection reservoir 223 is seen brightly. Therefore, a refractive index of the liquid is estimated by using the existence or absence of generation of total reflection, and this can be converted into a component concentration.

In a case of the above-described (vi), a form of the detection reservoir 223 is made to be a channel form whose height or width is about several times as long as that of a visible light. Then, it is structured such that the width of the channel narrows toward the downstream side. When a transparent material is used as the substrate 216, because a position at which an interference fringe is generated fluctuates in accordance with a refractive index of a liquid in the detection reservoir 223, a refractive index of the liquid is estimated based on a position of the interference fringe, and this can be converted into a component concentration.

1. A chip comprising:
a substrate;
a sample introduction unit provided on said substrate;
a channel which is communicated with said sample introduction unit;
a separation unit which includes a part of said channel, and
separates components in a liquid sample introduced in said sample introduction unit;
a pretreatment unit which is provided at upstream of said separation unit, and which applies predetermined pretreatment to said liquid sample introduced in said sample introduction unit; and
an analysis unit which analyzes said components separated in said separation unit,
wherein said pretreatment unit includes a pretreatment reservoir, and a switch which is provided at downstream of said pretreatment reservoir, and which controls to supply said liquid sample from said pretreatment unit to said separation unit, and
said switch has a damming portion which dams up liquid in said pretreatment reservoir, and a trigger channel which is communicated with said channel at said damming portion or downstream side of said damming portion, and which introduces said liquid to said damming portion.

2. The chip according to claim 2,
wherein said liquid sample includes insoluble components, and
said pretreatment reservoir has solubilizing substance solubilizing said insoluble components.

3. The chip according to claim 1 or 2,
wherein processing in said pretreatment unit is lowering viscosity of said liquid sample.

4. The chip according to claim 1 or 2,
wherein processing in said pretreatment unit is mixing said liquid sample and a surface active agent.

5. The chip according to any one of claims 1 to 4, comprising a mixing unit which is communicated with said separation unit and said analysis unit, and which homogenizes a concentration of said components in a liquid including said components separated in said separation unit.

6. The chip according to any one of claims 1 to 5,
wherein said mixing unit carries out processing which homogenizes a concentration of said components in a liquid including said components separated in said separation unit; and
said analysis unit analyzes said components in said liquid including said components homogenized in said mixing unit.

7. The chip according to claim 5 or 6,
wherein said mixing unit has a structure in which one region of said channel and other regions are communicated with one another via micro channels.

8. The chip according to claim 5 or 6,
wherein said mixing unit is composed of a counter-channel to said sample and a confluent portion.

9. The chip according to claim 5 or 6,
wherein said mixing unit includes a switch which is provided at said channel, and which controls to supply said liquid sample from said mixing unit to said analysis unit, and
said switch has a damming portion which dams up liquid in said channel, and a trigger channel which is communicated with said channel at said damming portion or an area of downstream side of said damming portion, and which introduces said liquid to said damming portion.

10. The chip according to any one of claims 5 to 9,
wherein said mixing unit has a movement control unit which controls a timing in which said liquid sample moves to said analysis unit, and said movement control unit is configured to introduce said liquid sample to said analysis unit after retaining said liquid sample for a predetermined time.

11. The chip according to claim 10,
wherein said movement control unit includes a switch which controls to supply said liquid sample from said mixing unit to said analysis unit, and
said switch has a damming portion which dams up liquid in said channel, and a trigger channel which is communicated with said channel at said damming portion or an area of downstream side of said damming portion, and which introduces said liquid to said damming portion.

12. The chip according to claim 11,
wherein said trigger channel includes a time-lag channel which delays a timing in which said liquid sample moves to said analysis unit by retaining said liquid sample.

13. The chip according to claim 11,
wherein a time-lag reservoir which delays a timing in which said liquid sample moves to said analysis unit by retaining said liquid sample is provided at said trigger channel.

14. The chip according to any one of claims 1 to 13, comprising a reaction unit which makes said components separated in said separation unit cause a predetermined reaction.

15. A chip comprising:
a substrate;
a sample introduction unit provided on said substrate;
a channel which is communicated with said sample introduction unit;
a separation unit which includes a part of said channel, and which separates components in a liquid sample introduced in said sample introduction unit;
a reaction unit which makes said components separated at said separation unit cause a predetermined reaction; and
an analysis unit which analyzes said components separated in said separation unit.

16. The chip according to claim 14 or 15,
wherein said reaction unit includes a reaction reservoir and a switch which is provided at downstream of said reaction reservoir, and
said switch has a damming portion which dams up liquid in said reaction reservoir, and a trigger channel which is communicated with said channel at said damming portion or an area of downstream side of said damming portion, and which introduces said liquid to said damming portion.

17. The chip according to claim 16, comprising a reacting substance affecting said components in said liquid sample, in said reaction reservoir.

18. The chip according to any one of claims 1 to 17, comprising a seal which covers a surface of said substrate.

19. The chip according to claim 18,
wherein an inert gas is filled in a space formed by said substrate and said seal.

20. The chip according to claim 18,
wherein a pressure is reduced in said space formed by said substrate and said seal.

21. The chip according to any one of claims 1 to 20,
wherein said surface of said substrate is made of a hydrophilic resin.

22. The chip according to any one of claims 1 to 21,
wherein said separation unit includes a switch which moves said liquid sample introduced in said sample introduction unit to said channel at a predetermined timing.

23. The chip according to any one of claims 1 to 22,
wherein said separation unit has a plurality of columnar bodies provided in said channel.

24. The chip according to any one of claims 1 to 22,
wherein said separation unit has a plurality of concave portions provided in said channel.

25. The chip according to any one of claims 1 to 22,
wherein surfaces of said channel which structure said separation unit has a plurality of first regions arranged so as to be separated each other, and a second region occupying the surface of said separation unit other than said first regions, and
between said first regions and said second region, one is a hydrophobic region, and the other one is a hydrophilic region.

26. The chip according to any one of claims 1 to 22,
wherein said separation unit has sample adsorbing particles which develop said liquid sample in accordance with a specific property.

27. The chip according to any one of claims 1 to 22,
wherein a bank unit is provided on the bottom face of said channel structuring said separation unit along a traveling direction of said channel so as to divide said channel, and a height of said bank unit is lower than a depth of said channel.

28. The chip according to any one of claims 1 to 22, comprising
a cover which covers said separation unit,
wherein on a plane at said substrate side among the planes of said cover, a bank unit is provided along the traveling direction of said channel so as to divide said channel, and
a height of said bank unit is lower than a depth of said channel.

29. The chip according to claim 28,
wherein said bank unit is a resin film formed on said plane at said substrate side of said cover.

30. The chip according to any one of claims 1 to 22,
wherein said separation unit includes a first channel forming a part of said channel, a second channel through which a liquid including specific components separated from said liquid sample passing through said channel passes, and a separation channel which makes said first channel and said second channel be communicated with one another, and through which only specific components are made to pass.

31. The chip according to any one of claims 1 to 30,
wherein said analysis unit has a plurality of reservoirs into which said components are sorted.

32. The chip according to claim 31, comprising air holes at said reservoirs or in the vicinity of said reservoirs of said channel communicated with said reservoirs.

33. The chip according to claim 32,
wherein a surface at a periphery of said air holes is made hydrophobic.

34. The chip according to any one of claims 1 to 33,
wherein said analysis unit has a detection unit which detects said components.

35. The chip according to claim 34, further comprising a covering member which covers said detection unit, wherein said covering member and a micro lens are integrally formed.

36. The chip according to any one of claims 1 to 35, comprising a waste reservoir communicated with said channel downstream of said analysis unit, wherein said liquid in said channel is configured to move toward a downstream side of said channel accompanying a movement of said liquid to said waste reservoir.

37. The chip according to claim 36,
wherein a liquid retaining portion is provided at said waste reservoir.

38. The chip according to claim 36 or 37, comprising air holes in said waste reservoir or in the vicinity of said waste reservoir of said channel communicated with said waste reservoir.

39. The chip according to claim 38,
wherein said surface in said periphery of the air holes is made hydrophobic.

40. The chip according to any one of claims 31 to 39,
wherein said channel has a branched portion, and said branched portion is communicated with said plurality of reservoirs.

41. The chip according to any one of claims 1 to 40,
wherein said liquid sample is configured to move in said channel by a capillary phenomenon.

42. The chip according to any one of claims 1 to 41,
wherein said separation unit has particles aggregating by being specifically adsorbed to predetermined components in said liquid sample.

43. The chip according to claim 42,
wherein said separation unit includes a particle retaining reservoir retaining said particles, and a switch which controls movement of said particles from said particle retaining reservoir to said channel, and
said switch has a damming portion which dams up said particles in said particle retaining reservoir, and a trigger channel which is communicated with said channel at said damming portion or downstream thereof, and which introduces said particles to said damming portion.

44. The chip according to claim 42 or 43,
wherein said analysis unit has a channel for analysis which is communicated with said separation unit, and a window unit which is provided above said channel for analysis of said substrate, and through which a aggregated state of said particles is sensed.
